(19) United States
(12) Patent Application Publication
(10) Pub. No.: US 2006/0282244 A1
(43) Pub. Date: Dec. 14, 2006

(54) Method and system for modeling scenarios in clinical trials

(76) Inventors: Sham Chotai, San Francisco, CA (US); Jack Porter, Livermore, CA (US); David Kaplan, Encinitas, CA (US)

Correspondence Address: MAYER, BROWN, ROWE & MAW LLP, P.O. BOX 2828, CHICAGO, IL, 60690-2828, US

(21) Appl. No.: 11/288,813

(22) Filed: Nov. 29, 2005

Related U.S. Application Data
(60) Provisional application No. 60/631,851, filed on Nov. 30, 2004.

(51) Int. Cl. G06Q 50/00; G06G 7/48; G06Q 10/00

(52) U.S. Cl. 703/11; 705/2

(57) ABSTRACT

A computer-based method for modeling scenarios for clinical trials in a drug development process is disclosed. The method provides study data to a computer system where the study data represents data from one or more studies on patients performed during the clinical trials of the drug. The method displays on a display device of the computer system the study data for one or more studies and displays scenarios on the display device where the scenarios represent changes to be made to the one or more studies to model the effect of the changes on the clinical trials. The system allows changing one or more of the parameters for the one or more studies using the scenarios displayed to model the effect of the changes on the clinical trials. Then the effect of the changes on the clinical trials effectuated by changing the one or more parameters is displayed.

### CROSS-REFERENCE TO RELATED APPLICATION

This application claim priority from, and is a non-provisional application of, co-pending U.S. Provisional Patent Application Ser. No. 60/631,851, filed Nov. 30, 2004, hereby incorporated by reference herein.

### COPYRIGHT STATEMENT

A portion of the disclosure of this patent document contains material to which a claim of copyright protection is made. The copyright owner has no objection to the facsimile reproduction by anyone of the patent document or the patent disclosure, as it appears in the Patent and Trademark Office patent files or records, but reserves all other copyrights whatsoever.

### FIELD

The present invention generally relates to the field of computing, and more particularly, to a computer-based method for modeling scenarios for clinical trials of a drug during a drug development process.

### BACKGROUND

Data management techniques are widely available to help users make business decisions based on the data being managed. Typically those decisions are based on data that is received by one or more decision-makers, is considered, validated and then a business decision is made based on that data. In certain situations, there is so much data that it makes it difficult for one or more decision-makers to consider all the necessary data needed to make a decision. While computer-run software systems are used to manage these large amounts of data, many of these computer management systems have poor reporting and limited visualization tools to help a user make the right decision. One clear industry that suffers from limited data management systems is the field of clinical trials for drug development.

The cost associated with a new clinical trial for drug development is now surpassing over one billion dollars. For each new clinical trial, there may be dozens of studies, each enrolling dozens of patients, increasing by ten-fold the costs of clinical trials over the past five years. With increased competition and higher costs of Federal Drug Administration compliance, the importance of making a right decision for clinical trials is even more urgent. This is particularly true in view of the fact that 96% of all clinical trials fail, 93% of all the clinical trials are more than 50% over budget, 53% fail after spending more than 200 million dollars in development and 33% of the clinical trials fail in the last phase of the trials. With these exorbitant-sized numbers, it is important to have a data management system in place that aggregates the relevant data needed from all the clinical trials and is able to visualize, optimize, and otherwise assist the user in making smart business decisions throughout the clinical trial process. This data management system may also have applicability in other industrial areas outside of the drug development industry where the aggregation and interpretation of data is large, voluminous and crucial in the decision-making process.

### SUMMARY OF THE INVENTION

The present invention provides a computer-based method for modeling scenarios for clinical trials of a drug in a drug development process. In an alternative embodiment, this computer-based method may be used for modeling scenarios in non-drug development systems such as modeling scenarios in alternative natural resources industries (including, for example, oil and gas), the chemical industry and the food packaged goods industry. In an embodiment of the invention, a computer-based method for modeling scenarios for clinical trials of a drug in a drug development process is described. The method includes providing study data to a computer system where the study data represents data from one or more studies on patients performed during the clinical trials of the drug in the development process. The method continues by displaying on the display device of the computer system the study data for the one or more studies. Then the scenarios are displayed on the display device, where the scenarios represents change to be made to the one or more studies to model the effect of the changes made on the clinical trials. Then, one or more of the parameters are changed for the one or more studies using the scenarios displayed to model the effect of the changes on the clinical trials. Then the display device displays the effect of the changes on the clinical trials effectuated by changing the one or more parameters.

### BRIEF DESCRIPTION OF THE DRAWINGS

A more complex appreciation of the invention and many of the advantages thereof will be readily obtained as the same becomes better understood by references to the detailed description when considered in connection with the accompanying drawings, wherein:

FIG. 1 is a block diagram view of an embodiment of the system of the present invention;

FIG. 2 is a block diagram view of an embodiment of the computer system of the present invention;

FIG. 3 is a block diagram view of an embodiment of the architectural platform of the present invention;

FIG. 4 is a block diagram view of an embodiment of the architectural platform of the present invention;

FIG. 5 is a block diagram view of an embodiment of the architectural platform of the present invention;

FIG. 6 is a display screen view of an embodiment of a user interface in the system of the present invention;

FIG. 7 is a display screen view of an embodiment of a user interface in the system of the present invention;

FIG. 8 is a display screen view of an embodiment of a user interface in the system of the present invention;

FIG. 9 is a display screen view of an embodiment of a user interface in the system of the present invention;

FIG. 10 is a display screen view of an embodiment of a user interface in the system of the present invention;

FIG. 11 is a display screen view of an embodiment of a user interface in the system of the present invention;

FIG. 12 is a display screen view of an embodiment of a user interface in the system of the present invention;

FIG. 13 is a display screen view of an embodiment of a user interface in the system of the present invention;

FIG. 14 is a display screen view of an embodiment of a user interface in the system of the present invention;

FIG. 15 is a display screen view of an embodiment of a user interface in the system of the present invention;

FIG. 16 is a display screen view of an embodiment of a user interface in the system of the present invention;

FIG. 17 is a display screen view of an embodiment of a user interface in the system of the present invention;

FIG. 18 is a display screen view of an embodiment of a user interface in the system of the present invention;

FIG. 19 is a display screen view of an embodiment of a user interface in the system of the present invention;

FIG. 20 is a display screen view of an embodiment of a user interface in the system of the present invention;

FIG. 21 is a display screen view of an embodiment of a user interface in the system of the present invention;

FIG. 22 is a display screen view of an embodiment of a user interface in the system of the present invention;

FIG. 23 is a display screen view of an embodiment of a user interface in the system of the present invention;

FIG. 24 is a display screen view of an embodiment of a user interface in the system of the present invention;

FIG. 25 is a display screen view of an embodiment of a user interface in the system of the present invention;

FIG. 26 is a display screen view of an embodiment of a user interface in the system of the present invention;

FIG. 27 is a display screen view of an embodiment of a user interface in the system of the present invention;

FIG. 28 is a display screen view of an embodiment of a user interface in the system of the present invention;

FIG. 29 is a display screen view of an embodiment of a user interface in the system of the present invention;

FIG. 30 is a display screen view of an embodiment of a user interface in the system of the present invention; and

FIG. 31 is a display screen view of an embodiment of a user interface in the system of the present invention.

### DETAILED DESCRIPTION OF THE PREFERRED EMBODIMENT

I. Glossary of Terms

Study or studies means a clinical research program to help medical researchers and pharmaceutical companies develop new and improved therapies for human diseases.

Enrollment runway is a user interface visualizing data relating to enrollment of subjects in a clinical study.

Patients or subjects means individual human beings that volunteer to be a part of a drug development clinical trial.

Study data means all information related to a clinical trial study for drug development.

Scenarios means a parameter or set of parameters used to predict future events.

Model(ing) means changing parameters for scenarios to model the effect of the change.

Parameters means metrics for gauging performance including, for example, time, subject enrollment, risk, finances and resources.

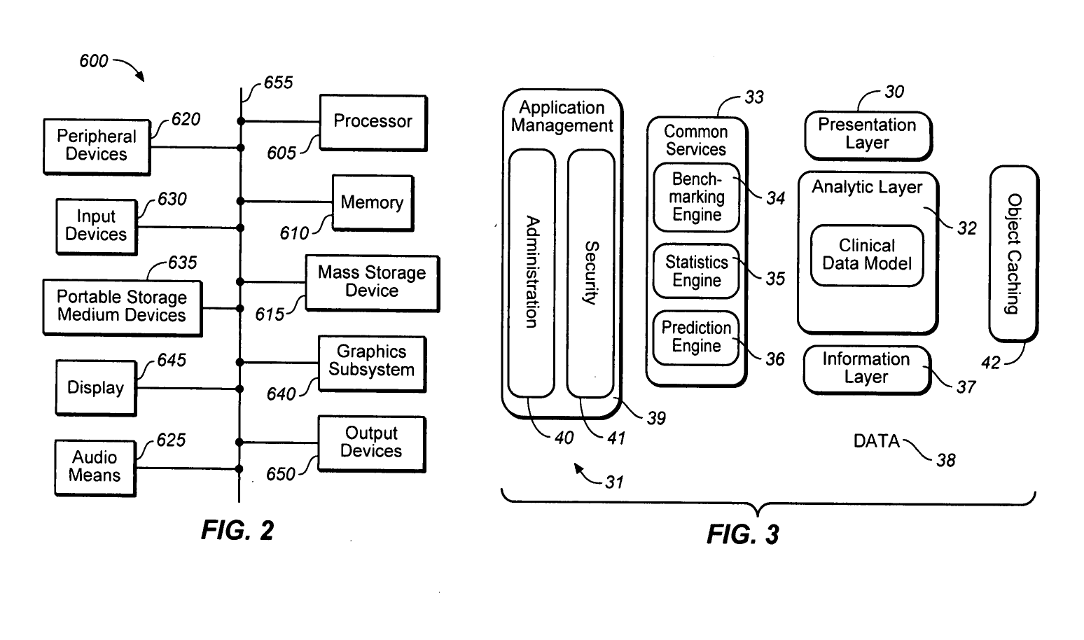

Computer-based means the use of a computer system such as the system of FIG. 2.

Architectural platform means an integrated set of structures of a system that comprises distinct elements and components, their specific function or purpose in the system, their externally visible properties, and the relationships among the elements and components that enable the fulfillment of the function of the system.

II. Overall System

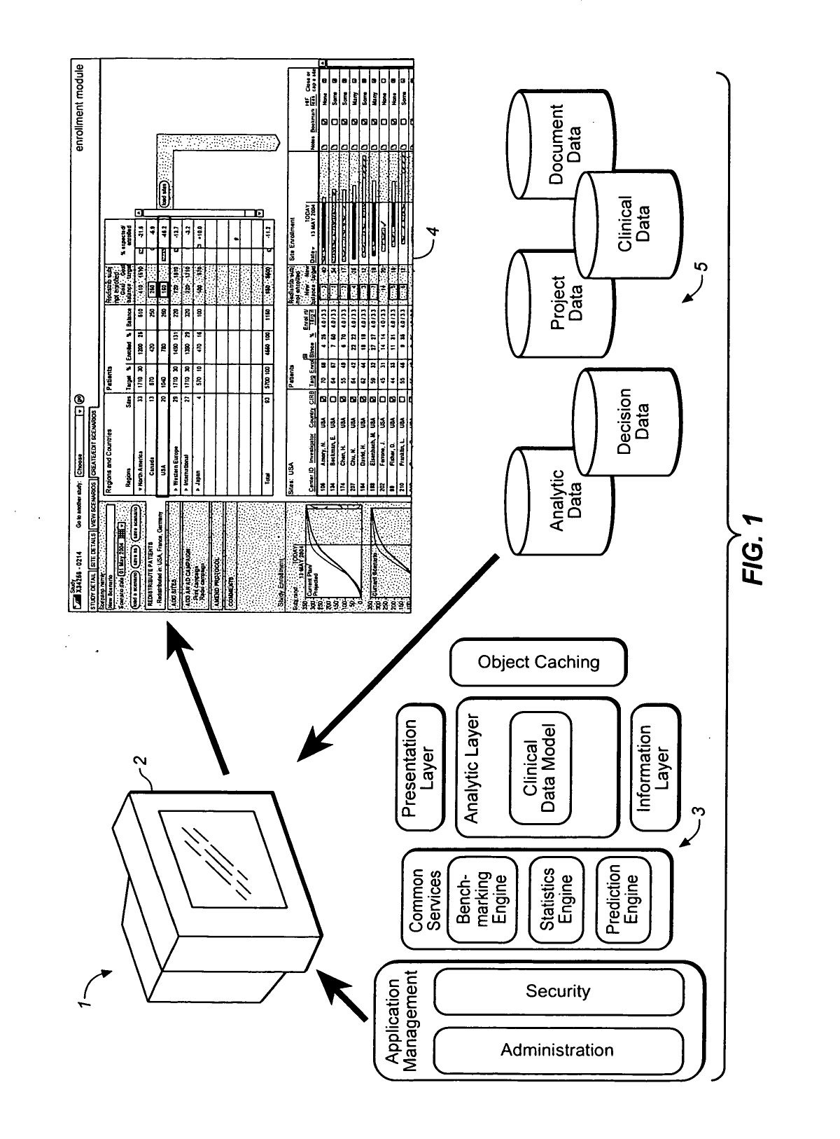

FIG. 1 is a block diagram view of an embodiment of the system of the present invention. In FIG. 1, the system 1, in this embodiment, is shown for an application of the present invention in the field of clinical trials for drug development. It is understood that the applicability of the system 1, in other embodiments, may apply to industries outside of drug development. Thus, while the invention herein will be described with reference to an embodiment of the drug development process, it is understood that the system 1 has wide applicability to managing data in fields other than the drug development field. Other examples of applicability of the system 1 to other industries includes data associated with the exploration of natural resources such as oil or gas (e.g., location of oil sites or gas sites for drilling and the data associated with staffing, budgets or other metrics for natural oil and gas recovery). In another embodiment, the present invention has applicability to the research and development of new chemicals. In this embodiment, multiple sites and subjects researching and developing new chemicals can be managed using the system 1. In fact, the system 1 has broad applicability where the management of many geographically different sites is needed. Additionally, when human resources must be managed, the system 1 has strong applicability. Also, when many metrics (budget, enrollment of subjects, time and even risk) are needed to be considered, an embodiment of system 1 may be applied. In a still further embodiment, the present invention may be applicable to the food packaging industry. In this industry, the many packaging sites, staffing needs, food aging parameters, all may be part of the system 1. Additionally, the industries of medical devices and biotechnology may also use, in alternative embodiments, the system 1 of the present invention in order to visualize, optimize, model and benchmark the decision-making process. Returning to FIG. 1, the system 1, in the clinical trials embodiment, is shown containing a number of components including a display device 2, an architectural platform 3, a user interface 4 and data 5. The system 1 of FIG. 1 is used to visualize, benchmark, model and optimize the clinical trial process during drug development. To properly understand the manner in which the system 1 enhances the clinical trial process, a description of the clinical trial process and the relevant data needed will first be described. Thereafter, an explanation of the visualization, benchmarking, optimization and modeling that is performed for clinical trials as part of an embodiment of the present invention will then be explained.

The clinical trial process performs clinical trials on patients or subjects (human volunteers) at a number of different sites, typically hospitals, throughout the world. Key measures in the success of the clinical trials conducted to discover the drugs to cure diseases for these patients are measured by considering a number of parameters that are needed for a successful clinical trial, including (i) the right number of subjects enrolled; (ii) the amount of time for the study; (iii) the financial costs of the study; (iv) the resources available for the study; and (v) the risk. The risk is a relative measure of the likelihood of an unfavorable outcome for a given expenditure of time and resources. For enrollment of subjects in clinical trials, the risk is that the required number of subjects will not be recruited to complete a particular study. Each of these parameters effect the success of a clinical trial such that it needs to be considered. In the past, individuals among different sites would be responsible for particular parameters of specific sites of a clinical study. This created an inability to consider all the appropriate parameters from all sites in a study on a display screen. In addition, creating scenarios to test changing of parameters on the trial could not be done. With the current system 1, these parameters are reported using the user interface 4 to first visualize the trial status so that a user may make informed decisions. Next, the trial status may be benchmarked against industry standards that are stored and retrieved and compared in the architectural platform 3. Using the architectural platform 3, a user is able to model scenarios in the system 1 by changing the parameters to see the effect on the overall system 1 of those changes. Lastly, the system and user may even optimize the clinical trial and any of the measures therein by studying past behavior in the industry to predict future results. A more detailed description of the capabilities performed by the architectural platform are explained in detail below.

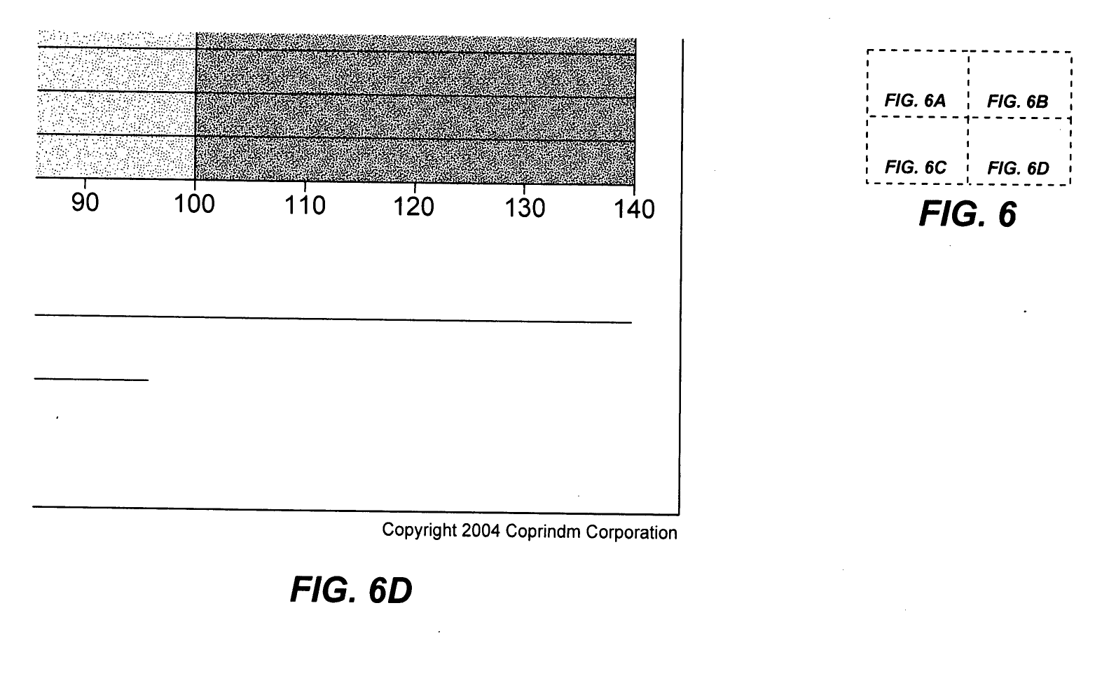

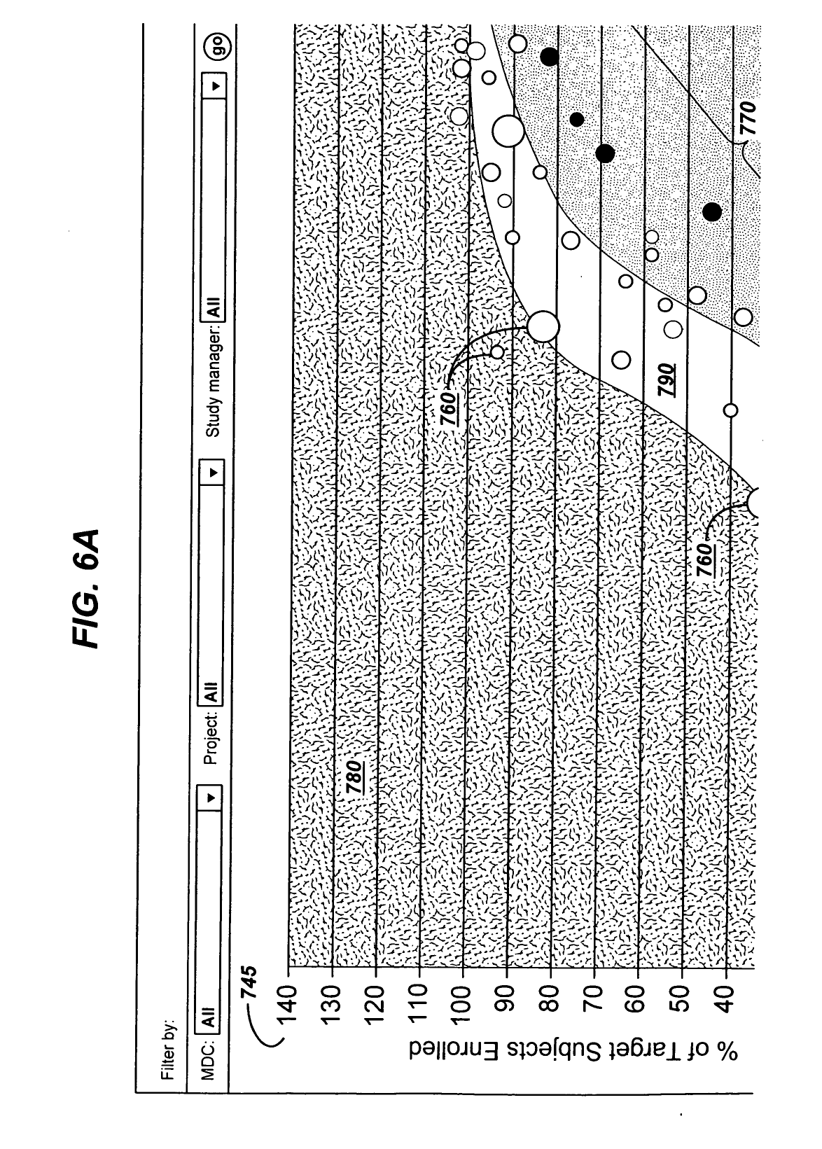

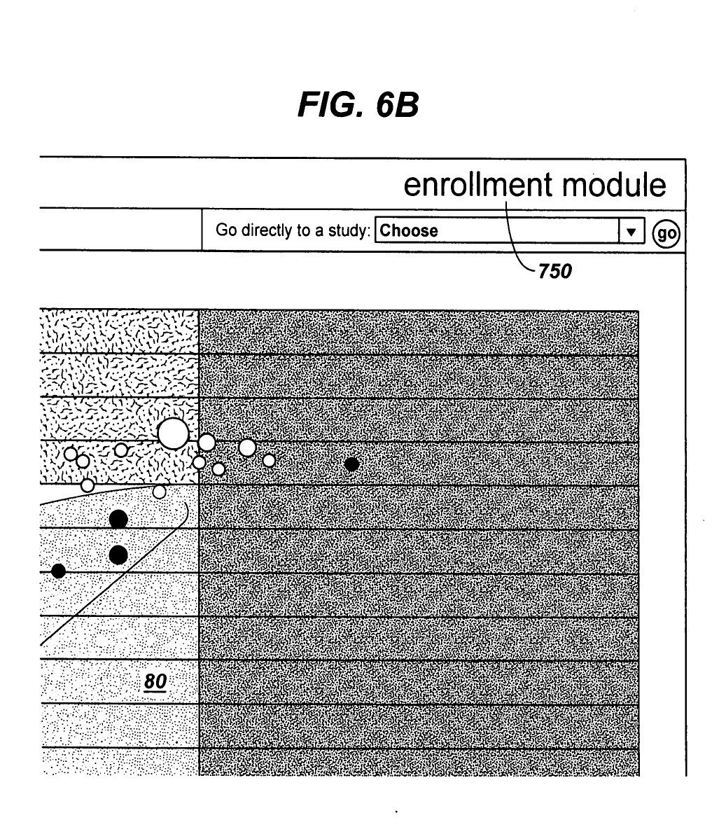

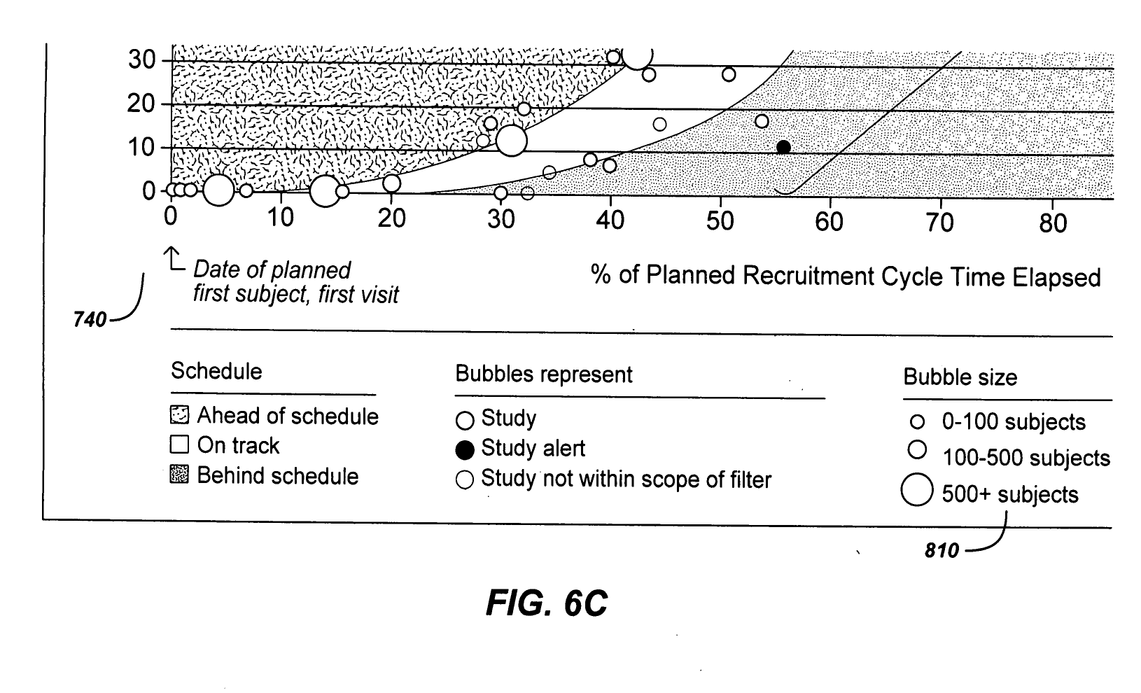

The display device 2 is, in one embodiment, a computer screen, however it may be any display device as described with regard to FIG. 2 below. For example, in other embodiments, the display device may be any LCD, TFT, television, projection screen, or other means of displaying information to a viewer. The user interface 4 is described in more detail with regard to FIGS. 6-31 below and provides a rich visualization that allows the system 1 to create a visual representation of key parameters in the clinical trial process. The user interface 4 accomplishes this by showing related data such as finances, risk, resources, subject enrollment and time, all placed into context of the clinical trial process. Visualization further allows the system 1 to track performance actively and receive alerts when there is a change in a parameter. The user interface 4 is prepared using common software programming applications such as Flash MX and PlumTree. The architectural platform 3, as will be described in more detail below, provides a flexible analytic layer, a data model compliant with industry standards, and a number of software engines. The engines, as described more fully below, include a benchmarking engine that tracks factors strongly correlated to successful clinical activities, a prediction engine that has trainable classifiers, a parallel statistical analysis that uses Bayesian model averaging and discreet analytics for portfolio performance, cycle time, transition rate and the like. Classification is a special case of general regression problems. Trainable classifiers are based on the notion that performance can be incrementally improved through experience and self-adjustment. It is typically a close-looped process in which a training set is repeatedly presented to a classifier; and after each cycle the overall performance of the classifier is assessed via an objective function. Bayesian model averaging is a statistical technique that allows one to take into account uncertainties of many different, often competing, models used to predict outcomes. Typically, probability density functions are used to account for biases in models to calculate a more meaningful mean. The information layer that is also part of the architectural platform 3 allows metadata administration and management, data harvesting for scheduled information retrieval, leverage of technology such as Information, web services support, native data access support, seamless access to unstructured data, data cleansing and transformation and data caching. Metadata is data about data. For a system, metadata allows the platform to dynamically manage the myriad of distinct data elements that come from multiple data sources and tie them to the data elements in the platform's data model. That is, metadata administration and management allows mapping of source data elements to the computational model on which the platform operates. Mapping is the location, data type, transformational computations, and storage requirements of data elements. The architectural platform 3 is capable of leveraging a number of technologies including IBM®, Websphere, BEAR weblogic, JBOSS, Oracle® and 9iAS. Other technologies leveraged include JAVA 2 Enterprise Edition and Standard web services such as SOAP, WSDL, XSLT, UDDI and WSSS. Middleware used in the architectural platform 3 include Informatica, IBM® Information Integrator, BIZ TALK and Spotfire. The Java® 2 Enterprise Edition includes JSV, JAAS and JMS. The data 5 of FIG. 1 contains any data related to the clinical trials that is to be visualized or used for the user interface 4. For example, all data related to a particular study used in the clinical trials would be made available and in the data 5. In one embodiment, this data includes the parameters with data related to the number of subjects enrolled, the budget and other finances of the clinical trials, the time planned for each site and study, and the risks and resources devoted to the study sites. Risk includes measurement of subject dropout (patients/subjects who have enrolled in the study, but have withdrawn) and screen failures (patients who do not qualify for the study). An abnormal number of dropouts can indicate an adverse reaction to treatment. Both measures also affect the recruitment targets of the study and the timeliness with which the study can be completed. Such particular study data is described in more detail below with regard to the clinical trials.

A. General Computer System

FIG. 2 is a block diagram of a computer system 600 used for performing an embodiment of the present invention. The computer system 600 is, in one embodiment, the system 1 of FIG. 1 of the present invention. The computer system 600 includes a processor 605 for executing program instructions stored in a memory 610. In some embodiments, processor 605 includes a single microprocessor, while in others, processor 605 includes a plurality of microprocessors to define a multi-processor system. The memory 610 stores instructions and data for execution by processor 605, including instructions and data for performing the methods described herein. Depending on the extent of software implementation in computer system 600, the memory 610 stores executable code when in operation. The memory 610 includes, for example, banks of read-only memory (ROM), dynamic random access memory (DRAM) as well as high-speed cache memory. The memory 610 may also be, in other embodiments, any volatile or non-volatile memory, SRAM, flash memory or other similar computer memory.

Still in FIG. 2, within computer system 600, an operating system comprises program instruction sequences that provide services for accessing, communicating with, and controlling auction server computer system 600. The operating system provides a software platform upon which application programs may execute, in a manner readily understood by those skilled in the art.

Further in FIG. 2, the computer system 600 incorporates any combination of additional devices. These include, but are not limited to, a mass storage device 615, one or more peripheral devices 620, an audio means 625, one or more input devices 630, one or more portable storage medium drives 635, a graphics subsystem 640, a display 645, and one or more output devices 650. The various components are connected via an appropriate bus 655 as known by those skilled in the art. In alternative embodiments, the components are connected through other communications media known in the art. In one example, processor 605 and memory 610 are connected via a local microprocessor bus; while mass storage device 615, peripheral devices 620, portable storage medium drives 635, and graphics subsystem 640 are connected via one or more input/output buses.

Continuing in FIG. 2, mass storage device 615 is implemented as fixed and/or removable medium, for example, as a magnetic, optical, or magneto-optical disk drive. The drive is preferably a non-volatile storage device for storing data and instructions for use by processor 605. In some embodiments, mass storage device 615 stores client and server information, code for carrying out methods in accordance with exemplary embodiments of the invention, and computer instructions for processor 605. In other embodiments, computer instructions for performing methods in accordance with exemplary embodiments of the invention also are stored in processor 605. The computer instructions are programmed in a suitable language such as Java, C, C++, or any other languages discussed herein.

In FIG. 2, the portable storage medium drive 635, in some embodiments, operates in conjunction with a portable non-volatile storage medium, such as a floppy disk, CD-ROM, memory stick or other computer-readable medium, to input and output data and code to and from the computer system 600. In some embodiments, methods performed in accordance with exemplary embodiments of the invention are implemented using computer instructions that are stored on such a portable medium and input to the computer system 600 via portable storage medium drive 635.

In FIG. 2, the peripheral devices 620 include any type of computer support device, such as an input/output (I/O) interface, to add functionality to computer system 600. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry.

In FIG. 2, the graphics subsystem 640 and the display 645 provide output alternatives of the system. The graphics subsystem 640 and display 645 include conventional circuitry for operating upon and outputting data to be displayed, where such circuitry preferably includes a graphics processor, a frame buffer, and display driving circuitry. The display 645 may include a cathode ray tube (CRT) display, a liquid crystal display (LCD), a thing film transistor (TFT), plasma screens, DSTN displays, MVA displays or other suitable devices. The display 645 preferably can display at least 256 colors. The graphics subsystem 640 receives textual and graphical information and processes the information for output to the display 645. The display would be used to display the user interfaces (FIGS. 6-30) in one embodiment. A video card in the computer system 600 also comprises a part of graphics subsystem 640 and also preferably supports at least 356 colors. For optimal results in viewing digital images, the user may use a video card and monitor that can display the True Color (24 bit color) setting. This setting enables the user to view digital images with photographic image quality.

In FIG. 2, audio means 625 preferably includes a sound card that receives audio signals from a peripheral microphone. In addition, audio means 625 may include a processor for processing sound. The signals can be processed by the processor in audio means 625 of computer system 600 and passed to other devices as, for example, streaming audio signals.

In some embodiments, programs for performing methods in accordance with exemplary embodiments of the invention are embodied as computer program products. These generally include a storage medium or medium having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card, smart card, memory sticks and other medium.

Stored on one or more of the computer readable medium, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable medium further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention.

B. Architectural Platform

1. Presentation Layer

FIG. 3 is a block diagram view of an embodiment of the system of the present invention. In FIG. 3, the detailed elements of architectural platform 3 shown in FIG. 1 are shown. A presentation layer 30 contains the visualization control for the user interface that allows a viewer to interact with the system 1. All the layers and engines shown in FIG. 2 are software modules that are written in standard software code, including JAVA, C++, C, Visual Basic, R/S and the like. The presentation layer 30 generates all of the user interfaces shown in FIGS. 6-31 below and may include Flash MX, Plumtree or WSCM/WSRP, Cognos, Business Objects, MicroStrategy, Hyperion, or Microsoft Excel. The platform supports SOAP (web service) requests and may therefore be a front end to the system.

2. Analytic Layer

The analytic layer 32 is again a software module that communicates with the common services layer 33 including the benchmarking engine 34, the statistics engine 35 and the prediction engine 36 to perform the functions for each engine. With the benchmarking engine 34, the analytic layer 32 is able to actively track the performance of a clinical trial against historical company and industry benchmarks. The statistics engine 35 interacts with the analytical layer 32 to determine the probability of success for the current course of action in the clinical trial by using predictions and sophisticated computational algorithms such as Bayesian, trainable classifiers and genetic algorithms. Genetic algorithms use software simulations to determine the best choice of performance drivers that are most likely to lead to the desired outcome. Genetic algorithms are evolutionary algorithms that use biologically-derived phenomena such as mutation, crossover, and natural selection to develop an optimal solution. The prediction engine 36 interacts with the analytic layer 32 to create scenarios to stimulate a change in the course of action in the clinical trial.

3. Information Layer

The information layer 37 is a software module that allows the analytic layer to access the data 38 that is used by the other layers. The information layer 37 is responsible for the following: (1) Mapping the source data elements in a client's operational/reporting database to the system's data model; (2) Retrieving data from source data stores, cleansing the retrieved information as necessary, and transforming the data to conform to the system's data model; (3) Storing and retrieving information in the system's data warehouse and operational data store. This includes data from scenario and analytic computations (from genetic algorithms and trainable classifiers); and (4) Manage and administer the platforms metadata.

4. Common Services Layer

The common services layer 33 provide the benchmarking engine 34, the statistics engine 35, and the prediction engine 36 as described above. Common services is the layer of the architecture that contains generic software elements that are accessible by all layers of the platform. In essence, the benchmarking engine is the set of software components that allows the analytic layer to compare a given study's performance against internal or industry norms. In generic terms, the benchmarking engine allows: (1) Modeling of what constitutes “norms” for a given context. For clinical studies, the breakdown is usually by therapeutic area (oncology, etc.) and study size (number of subjects or the duration of the study); and (2) a set of analytics that compares a given study against those norms to assess relative performance. The statistical engine is the set of software components that automates the execution of statistical algorithms and computations (such as Bayesian averaging) used to assess study performance and to extract trends in key performance indicators and measures. The prediction engine is the set of software components that automates the execution of predictive algorithms and computations (such as trainable classifiers) used to extrapolate the future values of key performance indicators and measures.

5. Application Manaaement Layer

The application management layer 39 is another software module that contains the administration 40 and the security 41 modules which are well-known modules that are used to protect and administer the system 1. The object caching 42 is a standard caching layer that allows storage of data on a temporary basis. An example of an off-the-shelf application management layer is HP OpenView. 6. Information Layer

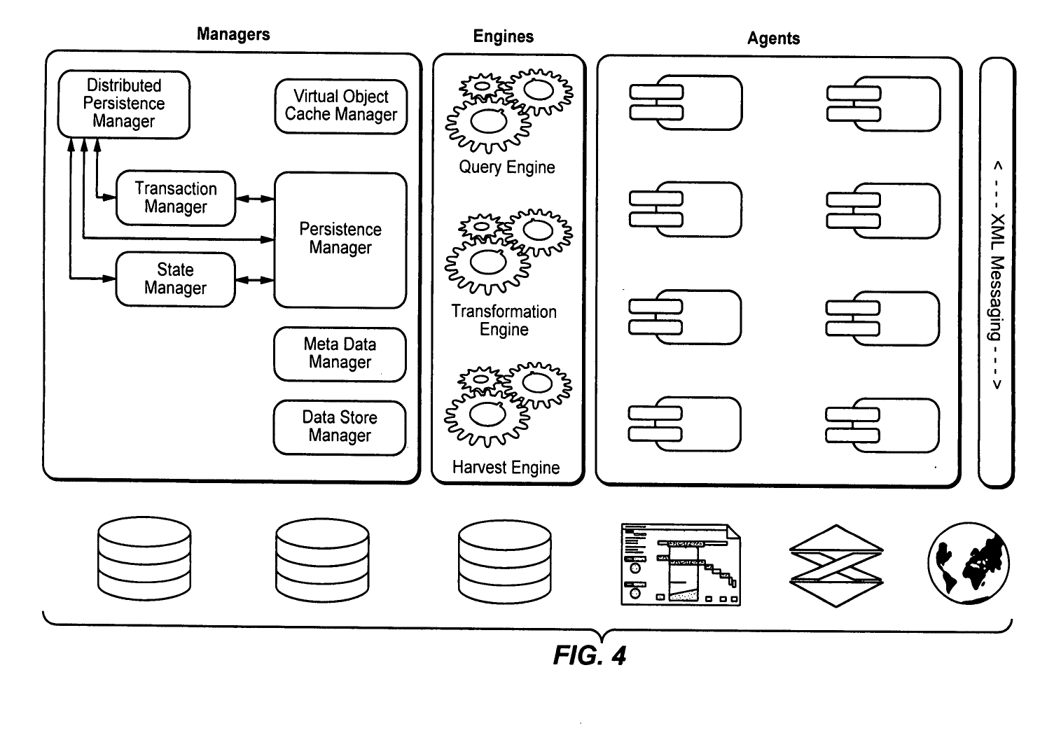

FIG. 4 is a block diagram view of an embodiment of the system of the present invention. In FIG. 4, the particular sub-modules contained within the information layer of FIG. 3 are shown. The information layer is governed by a set of managers (singleton objects) for persistence, meta data management, virtual object caching, data store management, transaction management, and system state management. These managers control every aspect of the layer's behavior in fulfillment of its contractual obligations to the system as a whole. Specifically, the managers leverage a set of software engines that are used in various combination to provide the functionality of the layer. These include a query engine to perform data access functions (such as retrieval and storage) against the platform's data store and source information stores; a transformation engine that wraps and leverages technologies such as Informatica's tools to perform extraction, transform, and load operations into the platforms data warehouse; and a data harvest engine to perform scheduled retrieval of information from source information stores and system initiated analytic computations (such as pattern matching, statistical analysis, etc.) on the platform's data store. The specific tasks associated with such engines, such as a query executed against a relational database, are performed by dedicated agents spawned and managed by the managers described above. Agents are task oriented objects that are pooled to linearly scale the platform to thousands of simultaneous users. Note that source information stores may be relational and non-relational. The information integration layer also provides an API through which other applications and software systems may access the layers functionality.

7. Common Services Layer

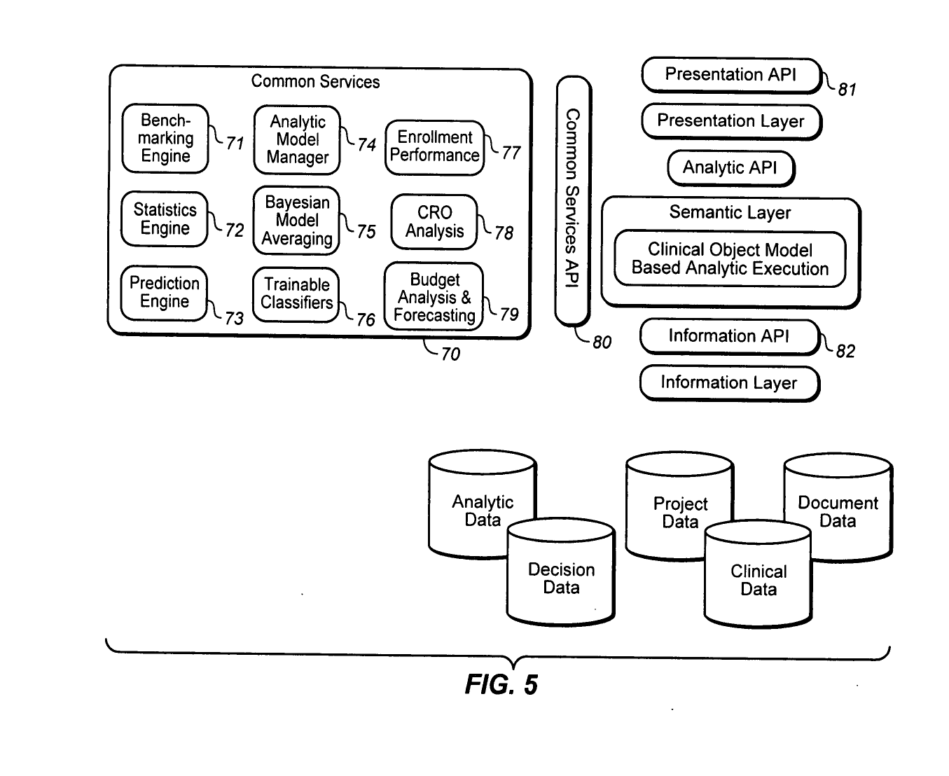

FIG. 5 is a block diagram view of an embodiment of the system of the present invention. In FIG. 5, the particular sub-modules contained within the common services layer 70 are shown. The benchmarking engine 71, the statistics engine 72 and the prediction engine 73 have been described above with reference to FIG. 2. In addition to these modules, there exists an analytic module manager 74, a Bayesian model averaging module 75, and a trainable classifiers module 76. As explained above, the trainable classifiers are the core set of software components and elements that provide the functionality for trainable classifiers. An enrollment performance module 77, a CRO analysis module 78 and a budget analysis and forecasting module 79 are also included within the common services. Analytic Model Manager gives users the ability to define and register “plans” used to control the flow of analytical computations against the platform's data store. Enrolment Performance is the set of pre-defined plans and software components used to assess the performance of enrolment strategies in clinical studies. CRO Analysis is the set of pre-defined plans and software components used to assess the performance of Clinical Research Organization (CROs) in clinical studies. Budget Analysis & Forecasting is the set of pre-defined plans and software components used to assess the impact on financial budgeting during the execution of clinical studies. The remaining portion of FIG. 5 is shown in FIG. 2 except that application program interfaces (API) are shown between the various layers including the common services API 80, the presentation API 81 and the information API 82. These are standard application program interfaces that are well known in the art.

In one embodiment of the system 1 for clinical trials, benchmarking allows the computer system to compare performance for critical parameters against past experience. The benchmarking is used to view performance of subject enrollment, studies, and study sites. The benchmarking further allow comparison of company performance by comparing the company's performance to establish company parameters. Benchmarking further allows to view industry performance by comparing a particular parameter of the clinical trial to accepted industry-wide parameters. Further, the benchmarking allows for comparison between actual performance by showing a current “snapshot” of actual performance In addition, the benchmarking shows plan performance by showing the current target and forecasted levels of performance. Lastly, the benchmarking allows for scoring performance by aggregation into an accepted scoring system. The performance of the clinical trial is actively tracked against historical company and industry benchmarks in order to provide a deep and broad understanding of the performance issues and their impact.

The probability of success for the current action in a clinical trial is predicted using sophisticated computational algorithm, such as Bayesian, trainable classifiers and genetic algorithms.

In clinical trials, clinical-specific computation or leverage to predict patient enrollment is performed. A user has the ability to modify the computations or input their own for their environment. The clinical computations allows modeling for the runway, discrete analytics, Cannonical transformations, dynamic scaling, time series analysis, Bayesian averaging, genetic algorithms, trainable classifiers and pattern matching. Like trainable classifiers, sophisticated pattern matching algorithms allow the platform to categorize a given study based on absolute values and trends observed in the data. The categorizations are known patterns developed through experience and a priori knowledge.

In a still further embodiment, a user has the ability to create scenarios to stimulate a change in the parameters of the trial. Predictive computations underlying the scenarios gives the user the ability to visualize the consequences of possible choices of action and to select the most appropriate course of action. The chosen scenario's performance is monitored and the architectural platform 3 continuously incorporates the best performing scenarios.

In clinical trials, optimization is performed through two different mechanisms, including the scenarios and automated scenario building. The scenarios enables executives to manipulate parameters that impact the budget, timeline and subject enrollment for a trial. Leverage will include adding additional study sites, redistributing subjects from under-performing sites, and introducing new advertising to improve regional recruitment. The scenario building allows users to develop scenarios to change the current milestones for the trial and the impacts on enrollment, financial data and budgets will be forecasted on other parameters. The automated scenario building are system-generated scenarios presented to improve cost and timeline for a clinical trial based on performance of past scenarios, expected outcomes and industry benchmarks.

III. System User Interfaces

A. Runway User Interface

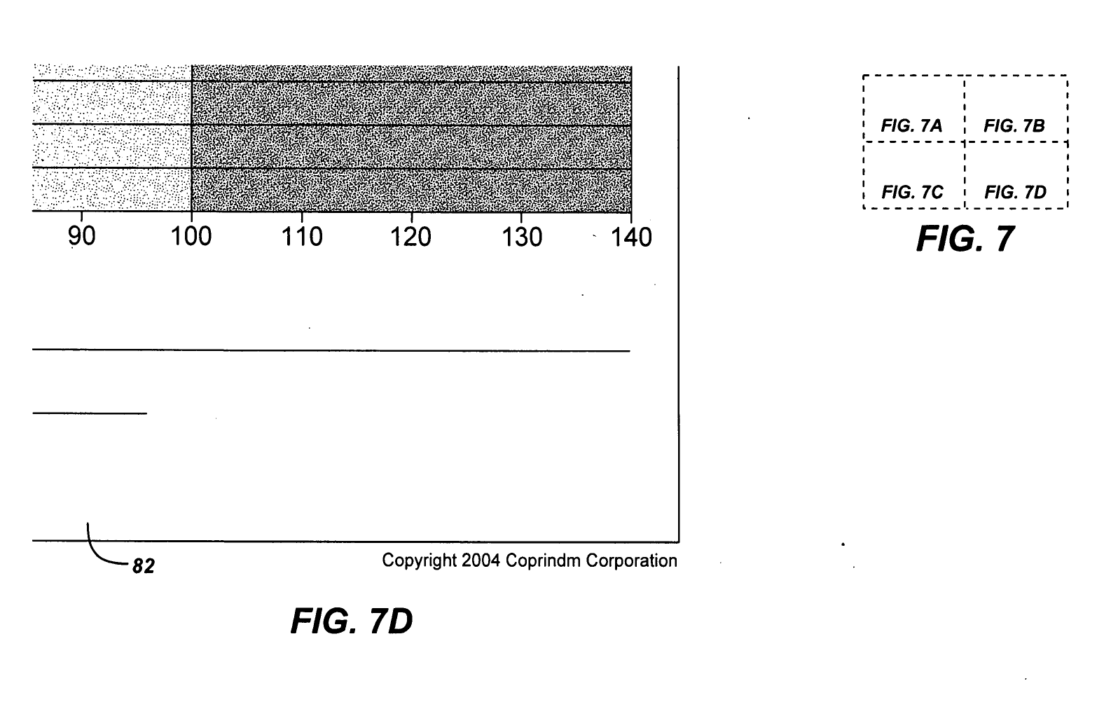

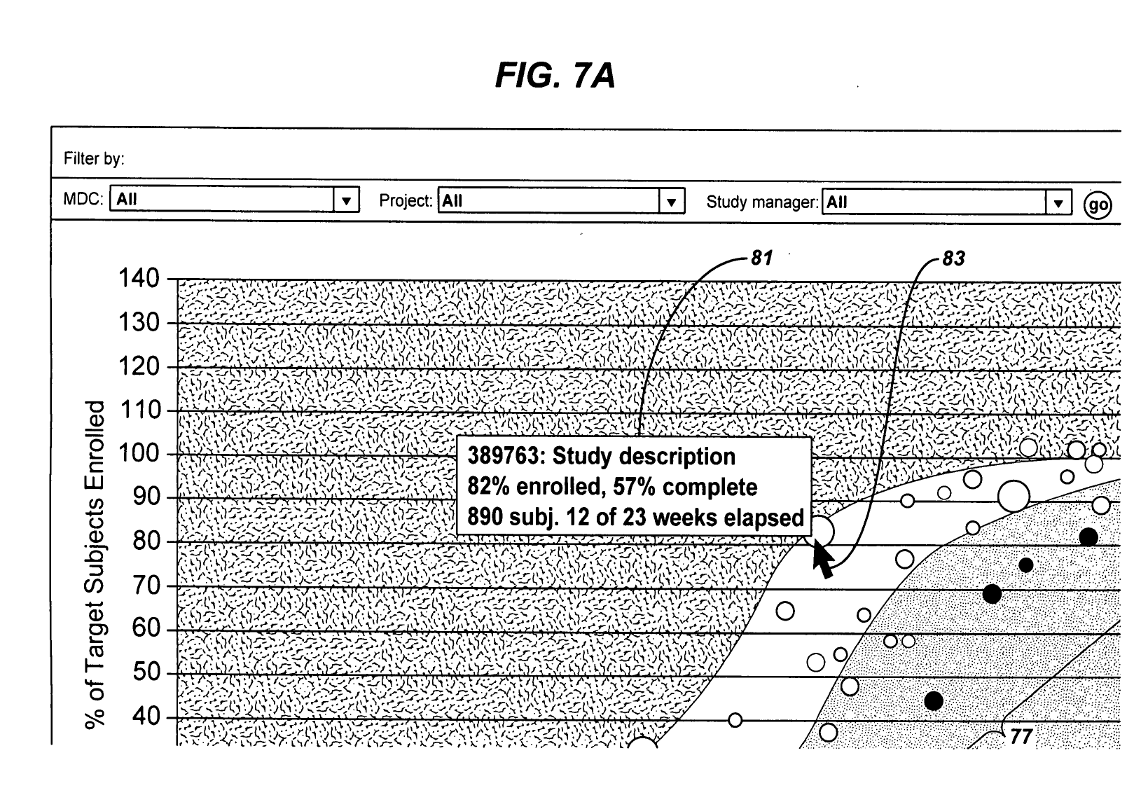

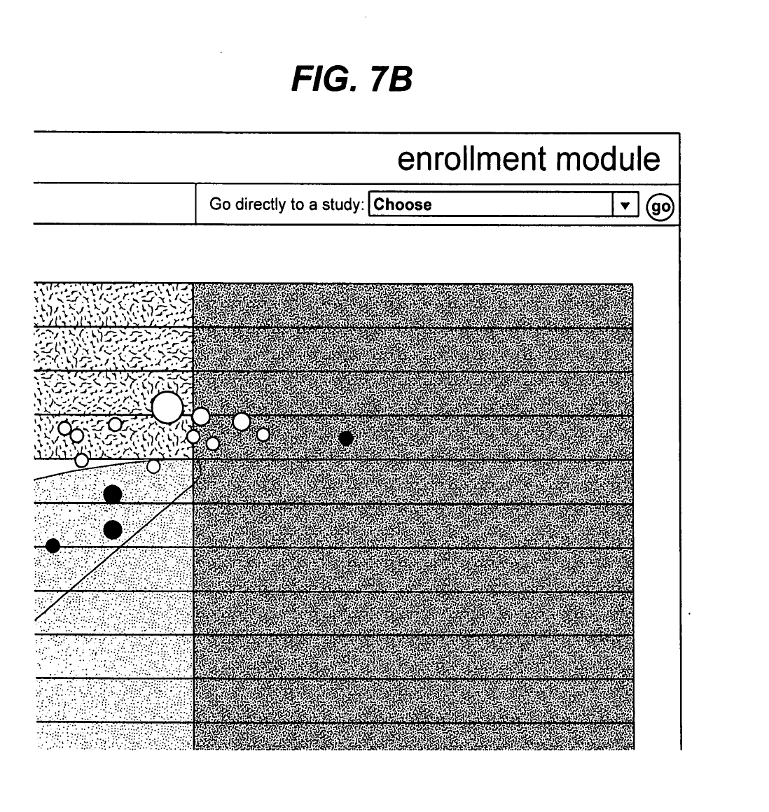

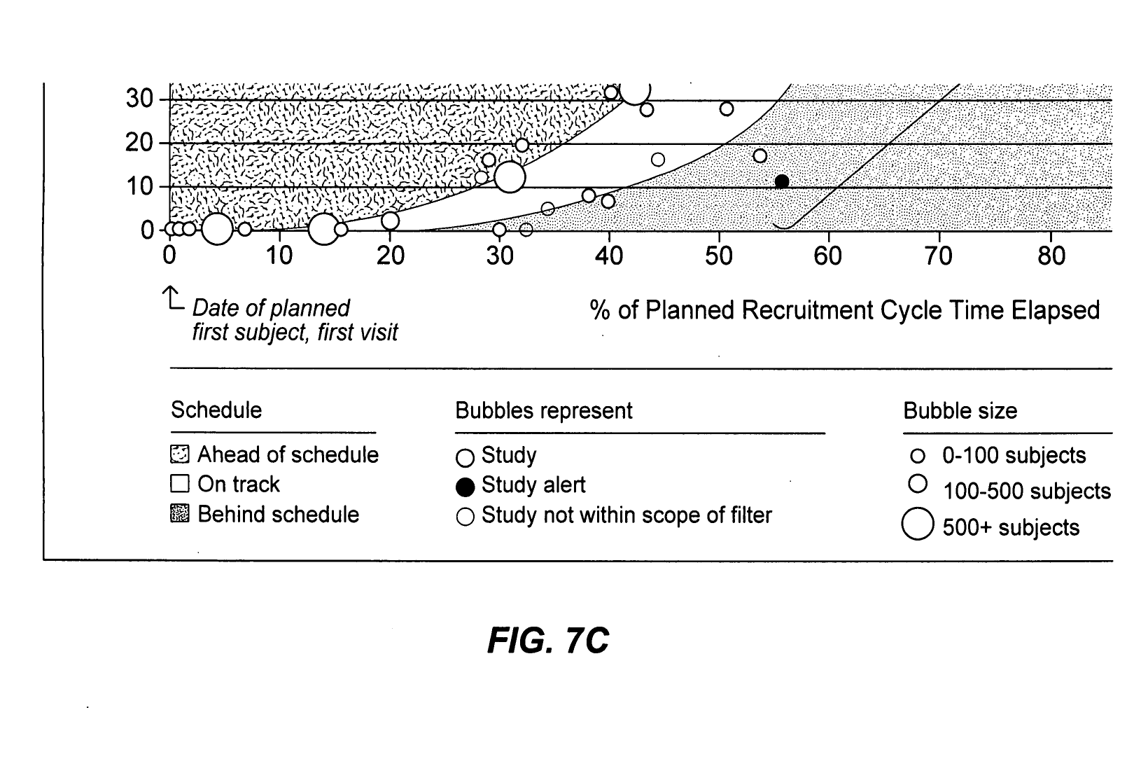

In clinical trials, user interfaces are used to visualize the studies and provide intuitive and coherent representations of the studies. In one embodiment, a viewer is able to view enrollment of subjects in the studies through an enrollment runway (FIGS. 6-7 below) and is able to view a study detail and a site detail that provides details for each particular study and each site (e.g. hospital), respectively. The user interface further provides for alerts that, in one embodiment, provide electronic messages when the actual performance of a clinical trial deviates from the planned performance. In a further embodiment, the user interface permits a user to enter a commentary on the current status of a clinical trial so that other users may benefit from the comments of alternative users. As will be more fully described below, the user interfaces further permit for collaboration using methodologies that allow for scenario modeling to be shared with other users. These scenario modeling examples may be stored for future retrieval.

The user interfaces and the architectural platform permit performance optimization by creating a visual representation of the clinical trial process. The user interfaces of the FIGs. below provide the visual representation of the clinical process. These user interfaces show related information such as the finances for clinical trial, the risks associated with a trial and other resources that are all placed in the context of the clinical trial process. Using the system 1 of FIG. 1, a viewer may track performance of the clinical trials actively and even receive alerts when there is a change in the trial parameters.

FIG. 6 is a display screen view of an embodiment of a user interface of the system of the present invention. In FIG. 6, an example of a display screen for an enrollment module 750 that displays the status of a number of studies 760 during a clinical trial. As described above, the studies 760 relate to particular clinical trial studies for the drug development. As shown in FIG. 6, the studies 760 are represented by the circles 760 along a runway curve 770. Each study 760, represented by the circles, have circle sizes that are representative of the size of the number of subjects enrolled in the study. Thus, in one embodiment, the larger the enrollment, the larger the circle size 760. Additionally, the different studies are placed along a graph 740 showing the percentage of target subjects enrolled along a Y axis 745 versus the percentage of planned recruitment cycle time elapsed along the X axis 755. Additionally, the runway curve 770 has different shading that shows when a study is ahead of schedule 780 or is on track 790 or behind schedule 800. By visually representing these different schedule parameters in the color designation as shown, a user is able to determine which studies 760 are in need of assistance. Additionally, the size of the circles 760 have multiple sizes as explained in the table 810. It is noted that different shapes (other than circles) and sizes may be used in alternative embodiments to show different parameters.

FIG. 7 is a display screen view of an embodiment of a user interface in the system of the present invention. In FIG. 7, the runway curve 77 of FIG. 6 is shown with a dialog box 81 that appears on the user interface 82 when a point arrow 83 is placed over the individual circle. The dialog box 81 describes the study number and provides percentage relating to enrollment to include the percentage enrolled, percentage completed, the number of subjects and the number of weeks elapsed. It is understood that additional embodiments could provide other study details in the dialog box 81.

B. Study Detail User Interface

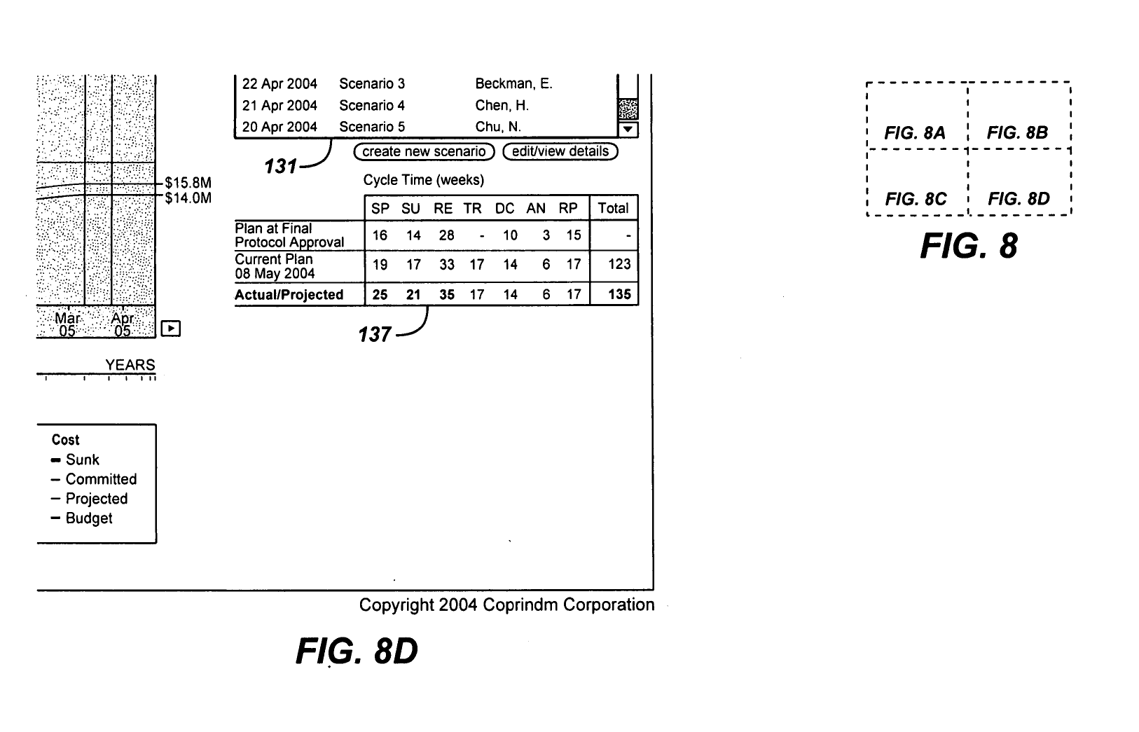

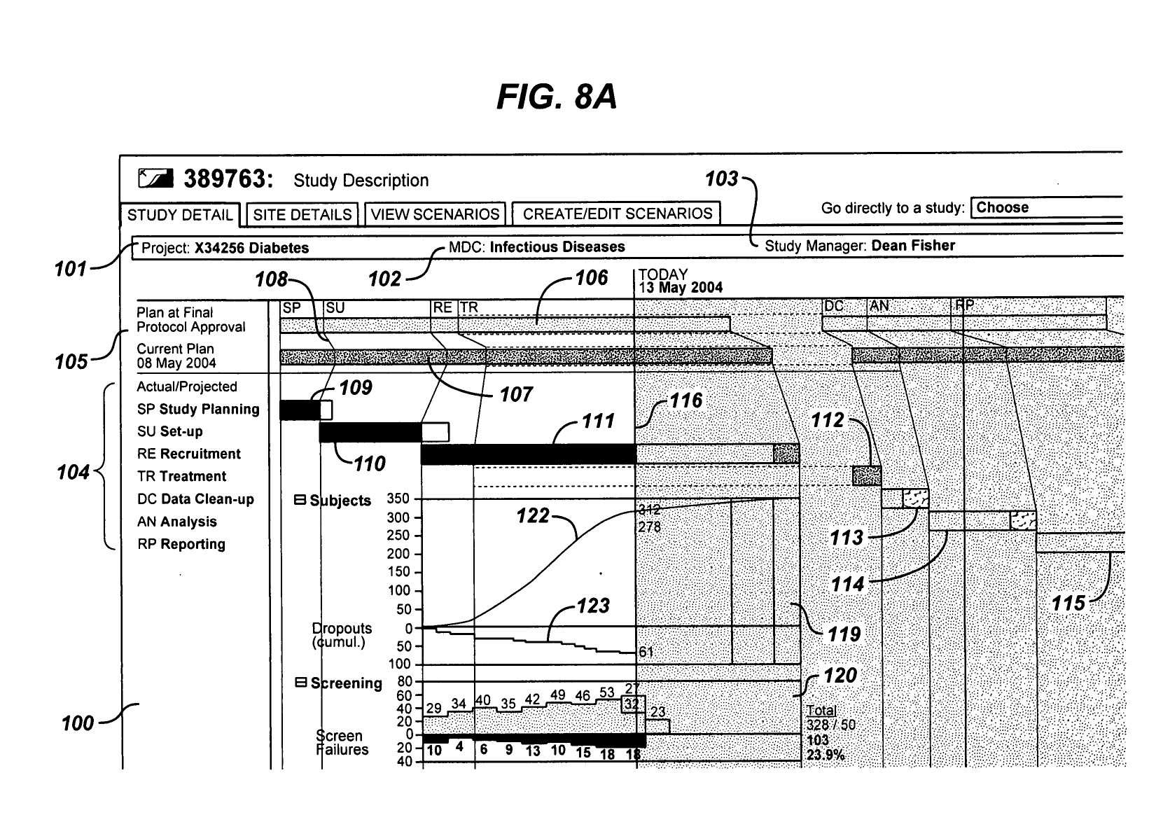

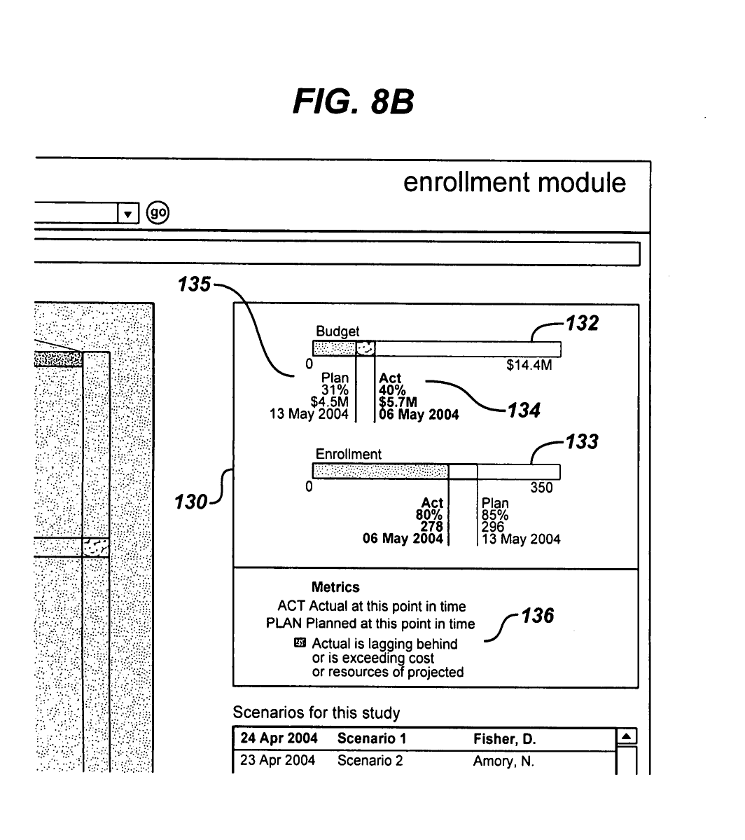

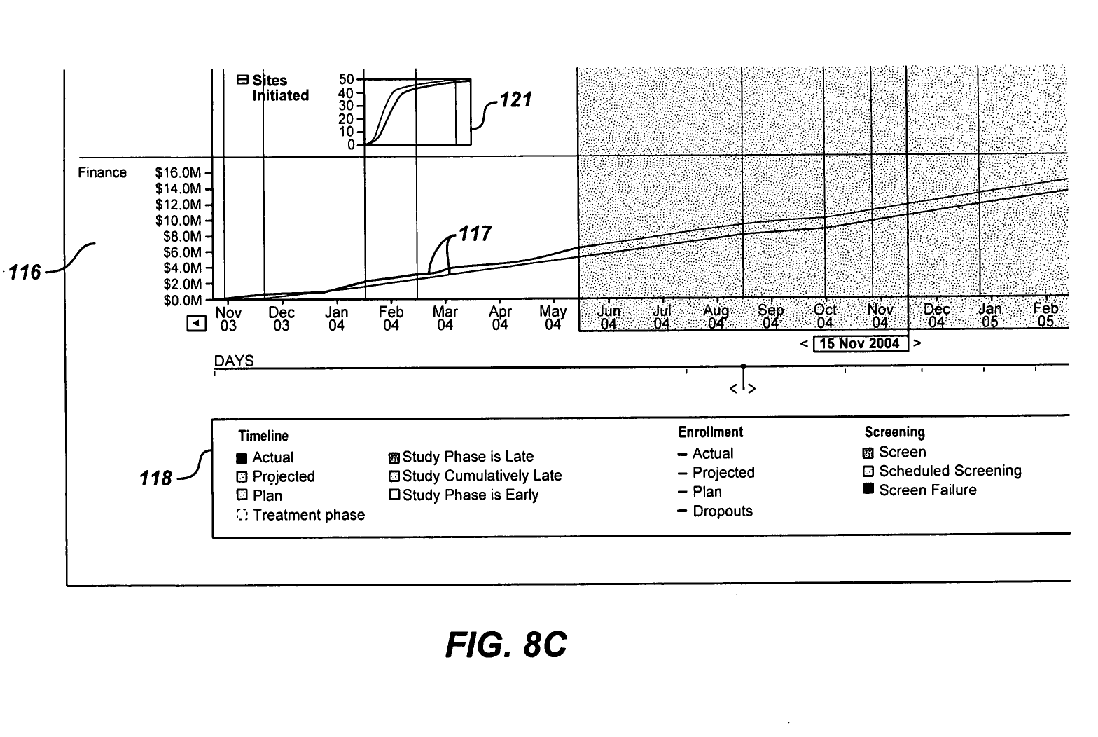

FIG. 8 is a display screen view of an embodiment of a user interface in the system of the present invention. In FIG. 8, the display screen 100 is a display screen for a clinical trial study. As explained above with regard to clinical trials, a study has an enrollment of patients/subjects at a number of sites that are part of the clinical trials used to test the drug being evaluated. In FIG. 8, the specific project is identified on the screen at 101, in this case an X34256 internal matter project for “diabetes.” There is also an MDC identifier that categorizes the particular study in the “infectious diseases” at 102. In addition, there is a study manager identified at 103 by the name of the manager in charge of the entire study. A legend for abbreviations 104 is located alongside the display screen 100 providing the legend for symbols used throughout the display screen. Also, a plan 105 is depicted using the legend 104 abbreviations that shows the pre-study plan approved for the particular study. As seen in the display screen 100, the plan 105 has a plan line 106 for the different legend 105 items. This includes study planning (SP), setup (SU), recruitment (RE), treatment (TR), data cleanup (DC), analysis (AN), and reporting (RP). Below the plan line 106 is the current plan 107 that shows, as of a certain date, the current plan that may be compared to the study and the plan line 106. The difference line 108 shows the difference between the plan line 106 and the current plan 107 to visually represent any delays or changes in the plan line 106. Furthermore, the two lines may be shown using different colors or texture in order to visually highlight any delays or changes in the actual versus the plan. Thus, the SP line is shown at 109, the SU line is shown at 110, the RE line is shown at 111, the TR line is shown at 112, the DC line is shown at 113, the AN line is shown at 114, and the RP line is shown at 115. A today line 116 shows the exact point in time when the report is being viewed. Also the color or texture of the user interface may be varied in the different lines (109-115) to show any deviations from the actual plan. Likewise, the color or texture may vary before and after the study line 116 to visually separate the time by past, present and future. It is noted that the X axis of the user interface shows the dates of the planned clinical trials while the Y axis shows the various plan and actual lines described above. In addition, a finance graph 116 is shown to highlight at various points in time the budget points along budget lines 117 during the time period of the study. A further legend 118 is shown that provides a legend of the colors or textures used in the graphs on the chart. Additional enrollment, screening and cost legends are shown in legend 118. Still within the study detail chart of 100, a subjects graph 119, a screening graph 120 and a sites initiated graph 121, all providing additional visual status of the clinical trial enrollment in those three areas. In the subjects graph 119, the number of patients/subjects that are enrolled in the study as shown by lines 122. Additionally, a dropout line 123 that graphs the dropout number of patients/subjects is shown. In addition to the display screen 100, there are sub-display screens 130 and 131 that provide additional information concerning this specific study. In sub-display screen 130, a budget line 132 and an enrollment line 133 summarize these two metrics for this particular study. Thus, by both the budget line 132 and enrollment line 133 a visual representation of being below and over budget is shown by color as well as specific metrics shown in area 134 and 135 that provide specific data to the plan versus actual of the budget and enrollment respectively. A legend 136 is further provided for this sub-screen 130. An additional scenario screen 131 provides scenarios that can be submitted to change this study as described more fully below with regard to the Scenario User Interface. Additionally, a cycle time graph 137 is shown that provides the number of weeks for each particular portion of the study shown in the legend 104.

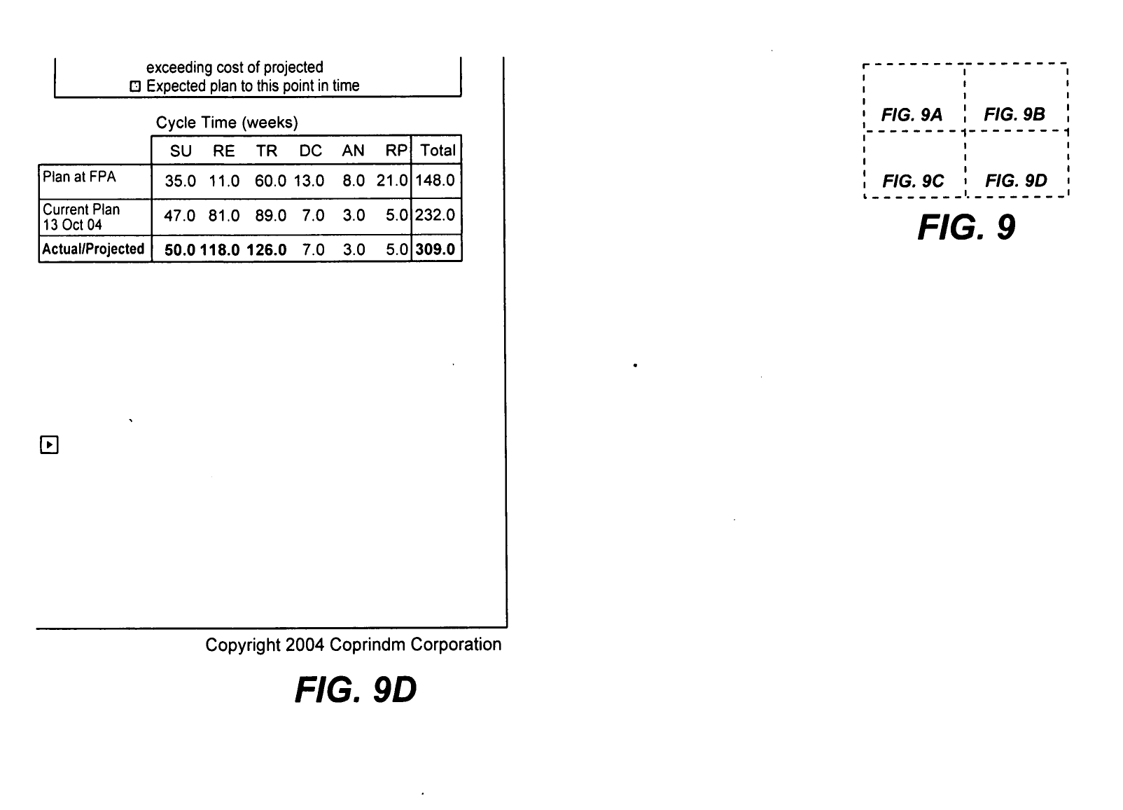

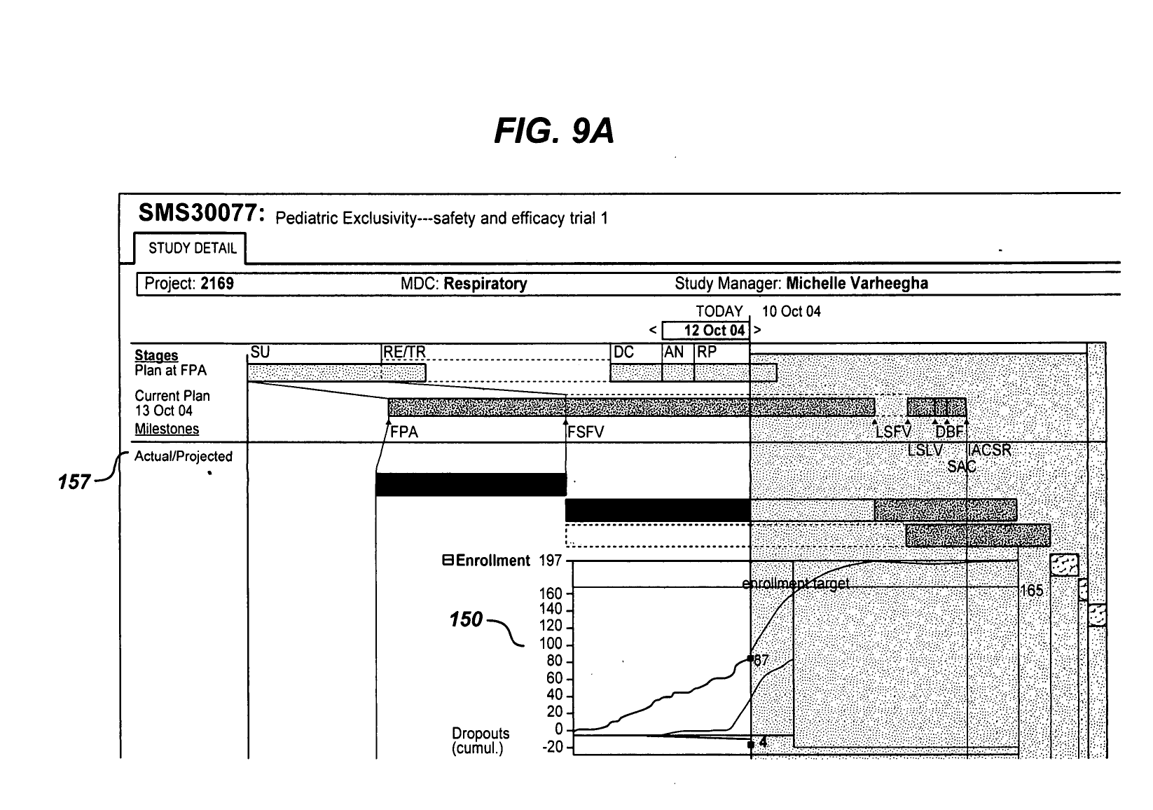

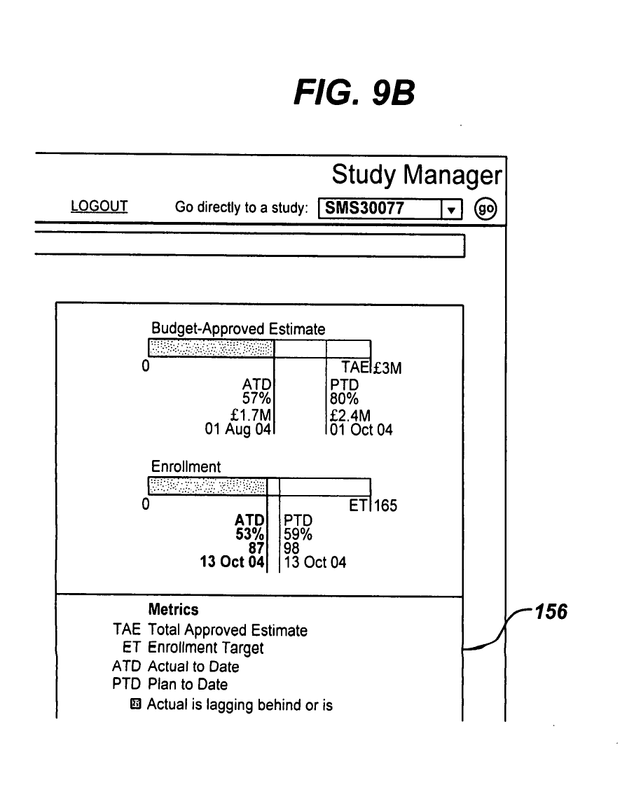

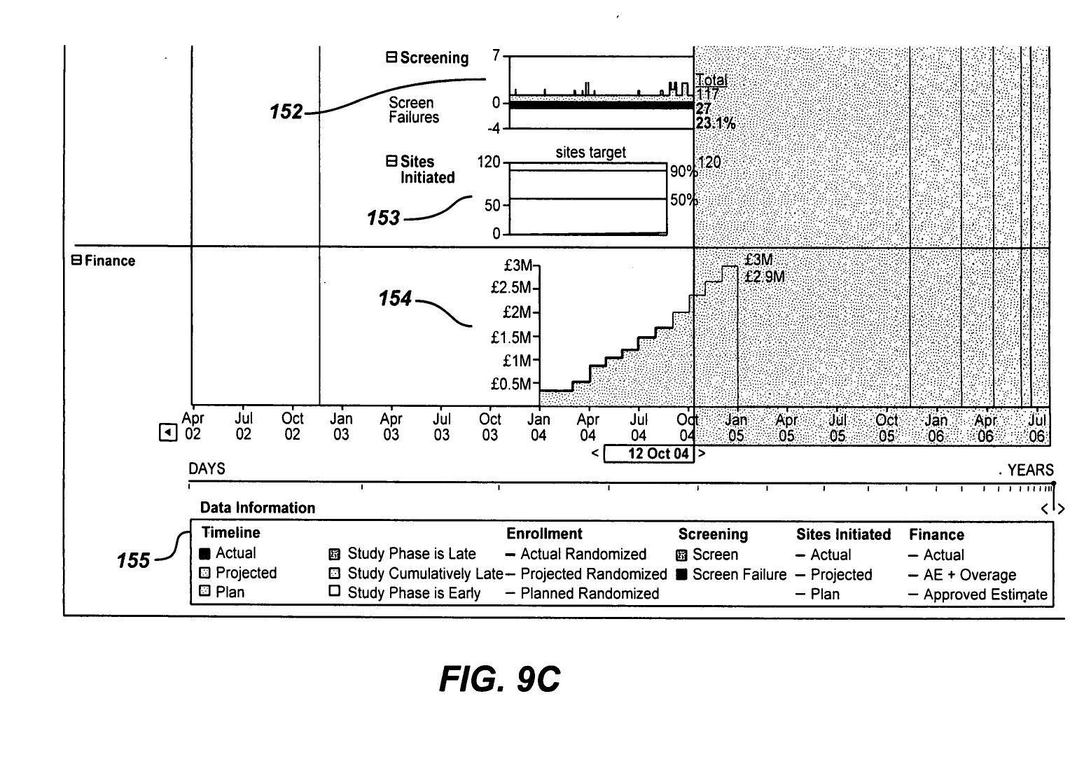

FIG. 9 is a display screen view of a further embodiment of the user interface in the system of the present invention. In FIG. 9, a similar screen to the study screen shown in FIG. 8 is shown with changes in this embodiment. In FIG. 9, the enrollment graph 150, screening graph 151 and sites initiated graph 152 have been modified in this embodiment from the graphs of FIG. 9. The graphs have been modified visually to represent similar data. Similarly, the finance graph 154 has used a ladder design rather than a graph design of FIG. 8. In addition, the legend of FIG. 8 104 has been removed with different legends in the boxes 155 and 156. The milestones 157 have also incorporated additional acronyms.

C. Site Detail User Interface

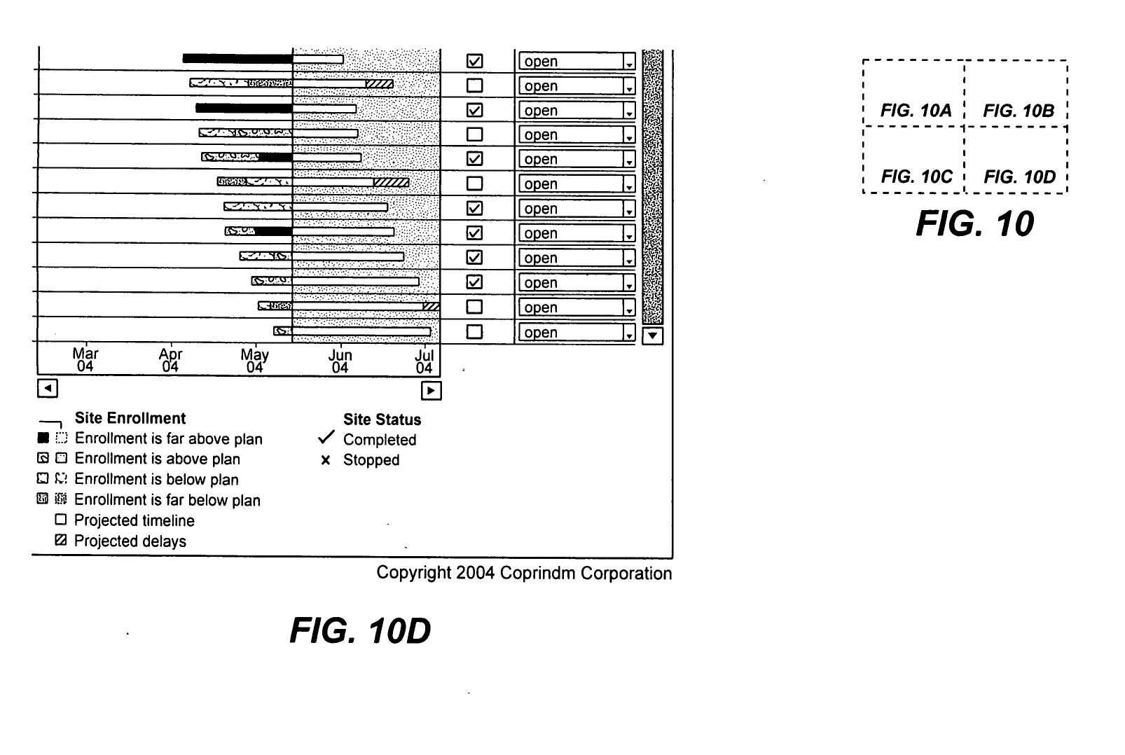

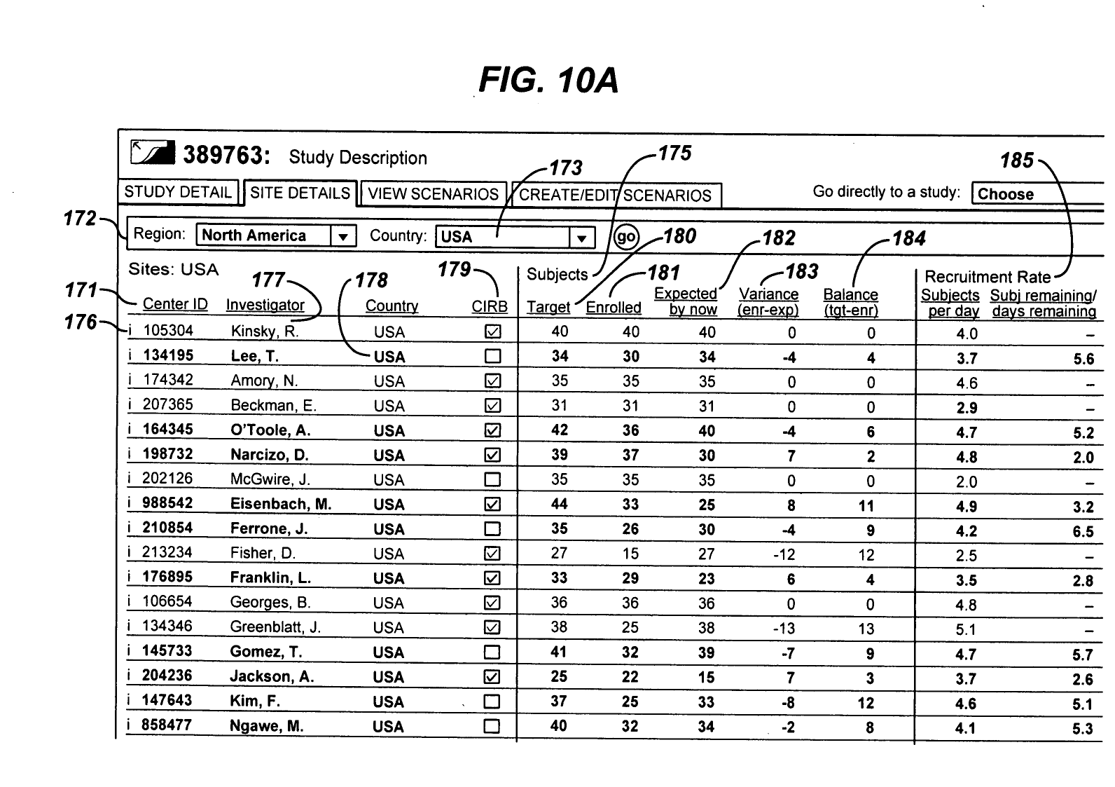

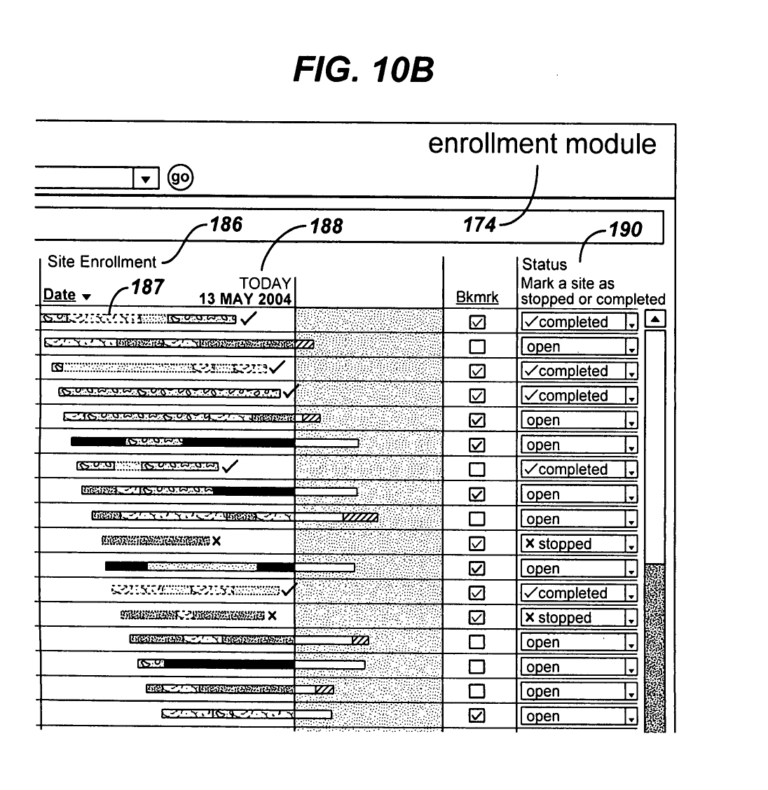

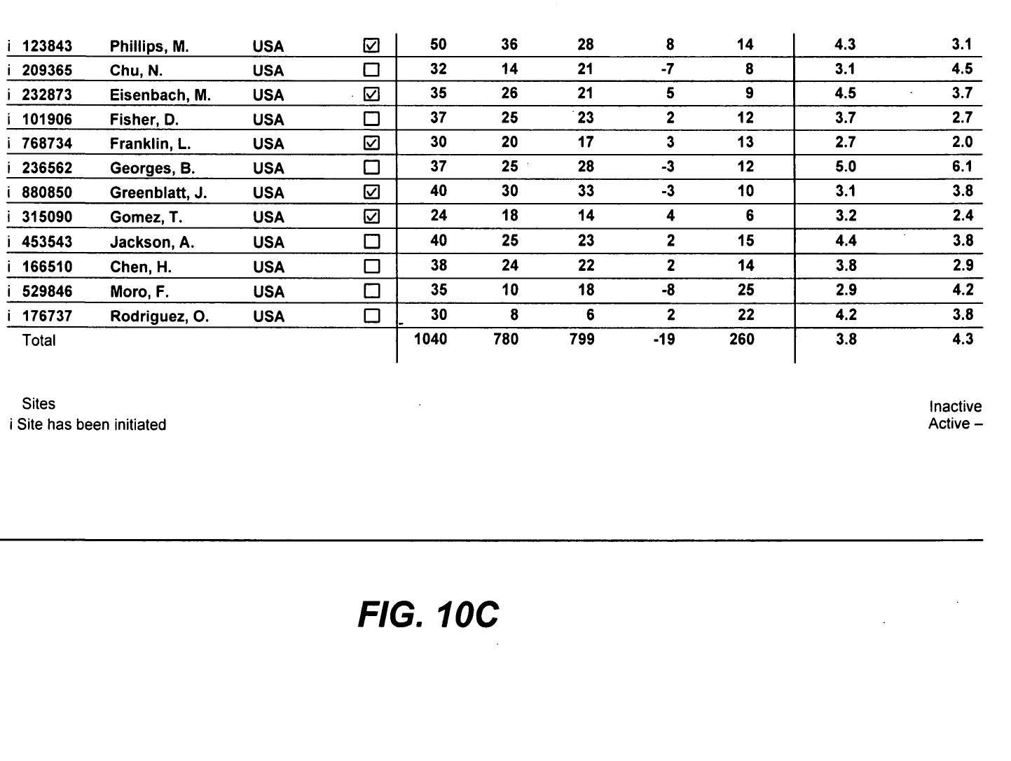

FIG. 10 is a display screen view of an embodiment of a user interface in the system of the present invention. In FIG. 10, a display screen 170 is depicted that provides specific details for a particular site (e.g. a hospital, health center, universities or the like) as identified under the center ID column 171. In FIG. 10, a specific region, identified at 172 for region North America and Country 173 USA, are shown with all the center IDs 171 listed. Again, this user interface is shown for a clinical trial of a drug, and in particular, this is a user interface for a monitoring enrollment 174 of the number of patients or subjects 175 that are enrolled in each particular site or center ID 171. Thus, in center ID 105304 176, an investigator 177 is listed (Kinsky, R.) a country USA 178 is shown, a CIRB column 179 (that provides additional detailed information) is shown, as well as information concerning all the patients or subjects in section 175. Thus, in this section 175 there is a list of numbers under target number of subjects to be enrolled 180, those actual number enrolled 181, the number expected to be enrolled by the current date 182, the variants of the difference between the expected and the enrolled 183, and the balance yet to be found 184. In addition, a section 185 provides a recruitment rate of subjects per day and subjects remaining in the days remaining. A visual representation of the data is shown under 186 providing a line 187 of the site enrollment up to today 188. A bookmark and status 190 are also provided that shows the status of the site. A bookmark allows study managers to identify sites of interest (for example, sites that are performing exceptionally well). Site status indicates the current state of a center recruiting and treating subjects, e.g., recruiting, completed, terminated, and the like.

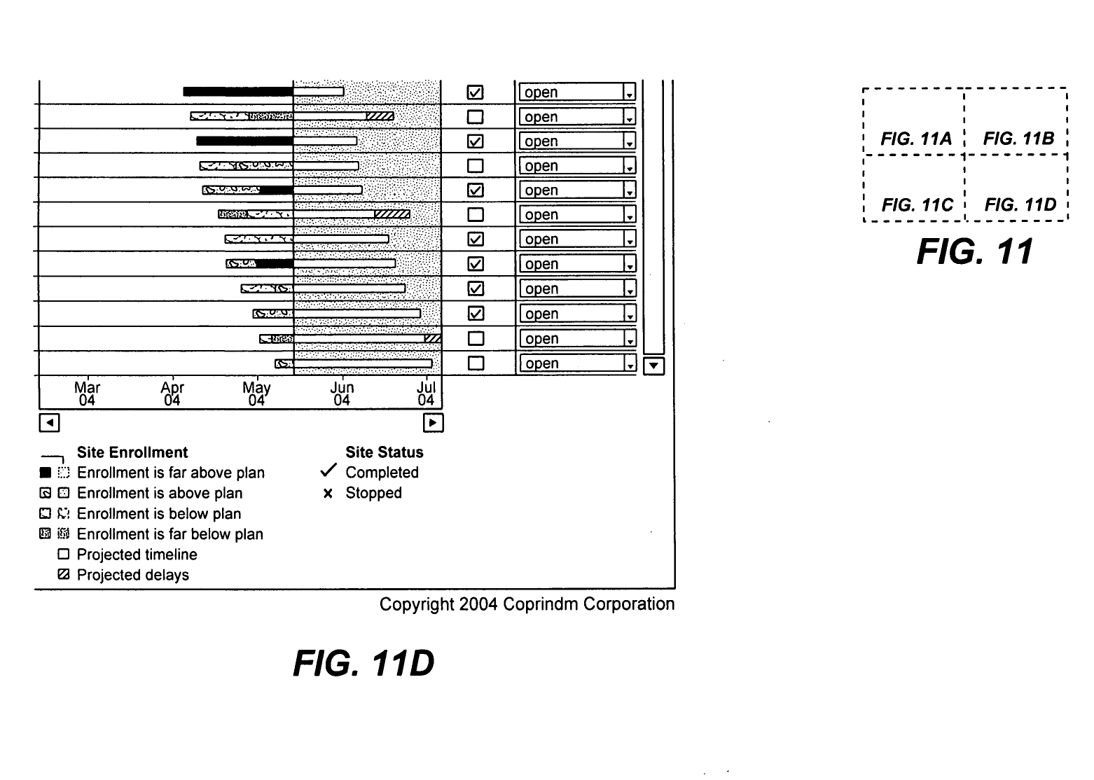

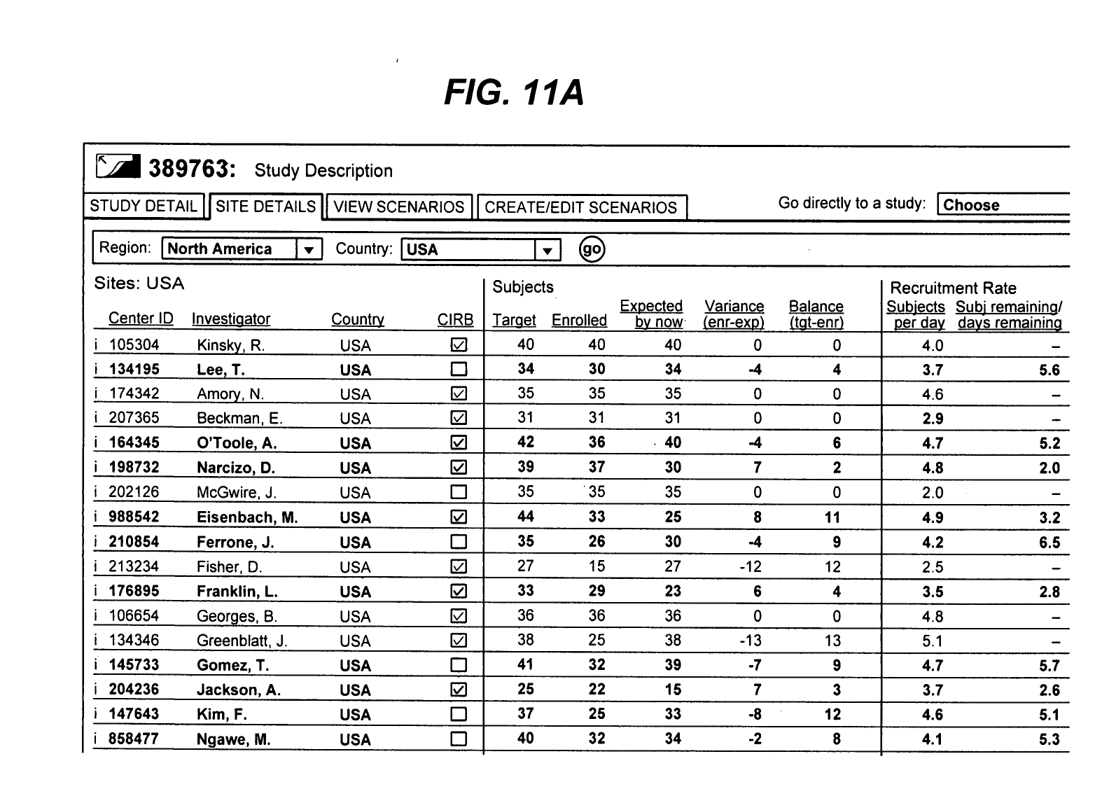

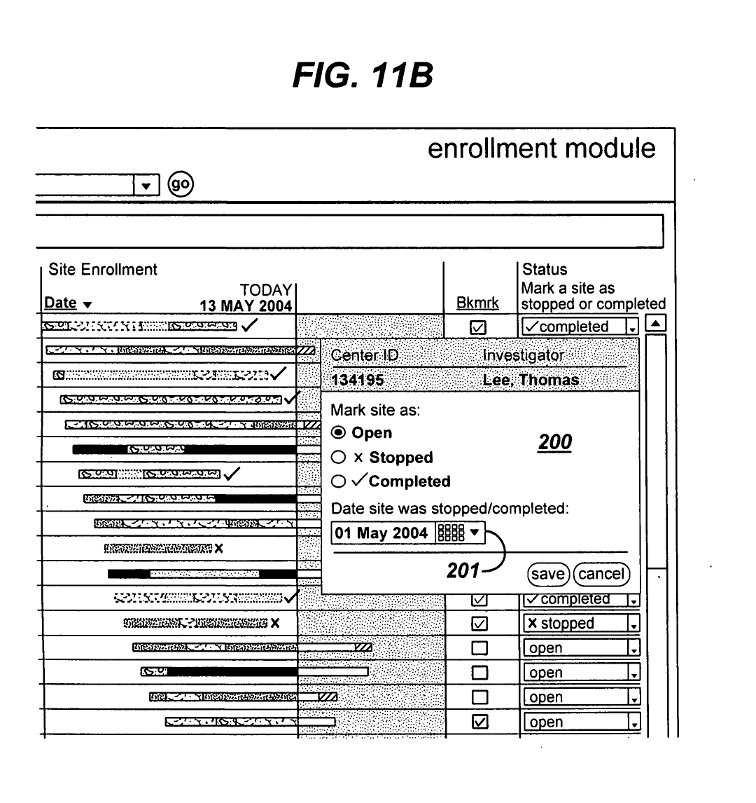

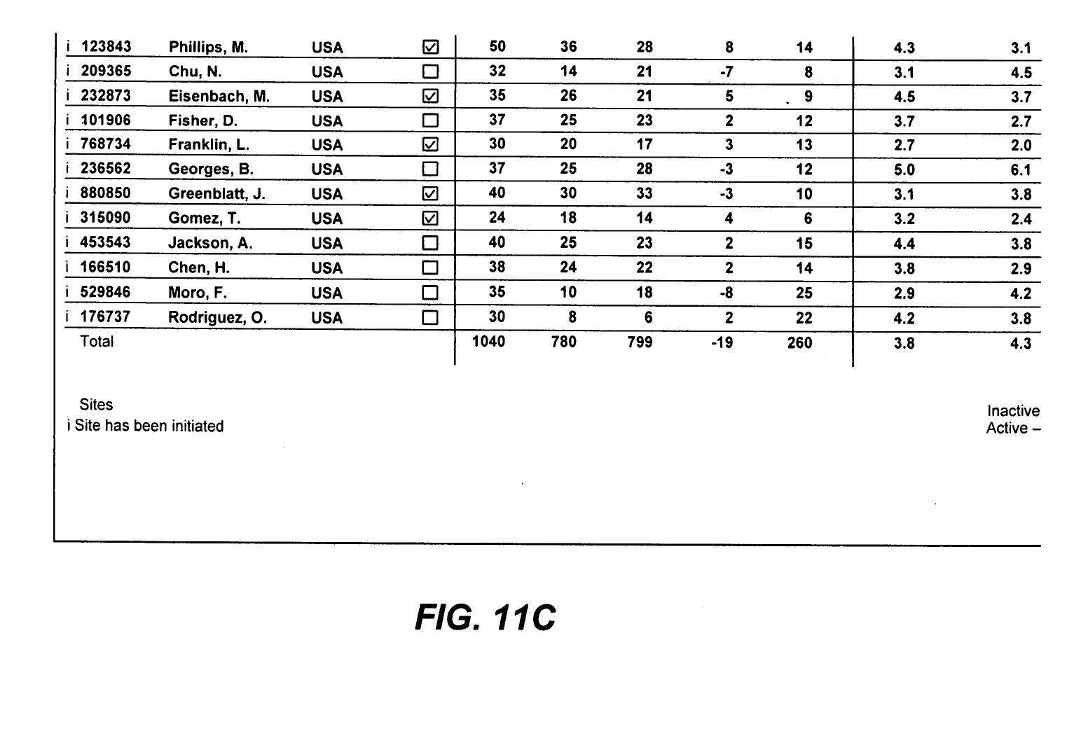

FIG. 11 is a display screen view of an embodiment of a user interface in the system of the present invention. In FIG. 11, the status box 200 is shown that is used to update the site details for a particular site, in this embodiment, the center ID 134195 with an investigator of Lee, Thomas. As shown in the status box 200, the site may be marked as open, stopped or completed. In addition, the date that the status was changed is shown at date box 201. It is also shown that the color of the particular site is changed to show those sites that have been completed or stopped, while the sites that are open are still shown with a different contrasting color.

D. Scenario User Interface

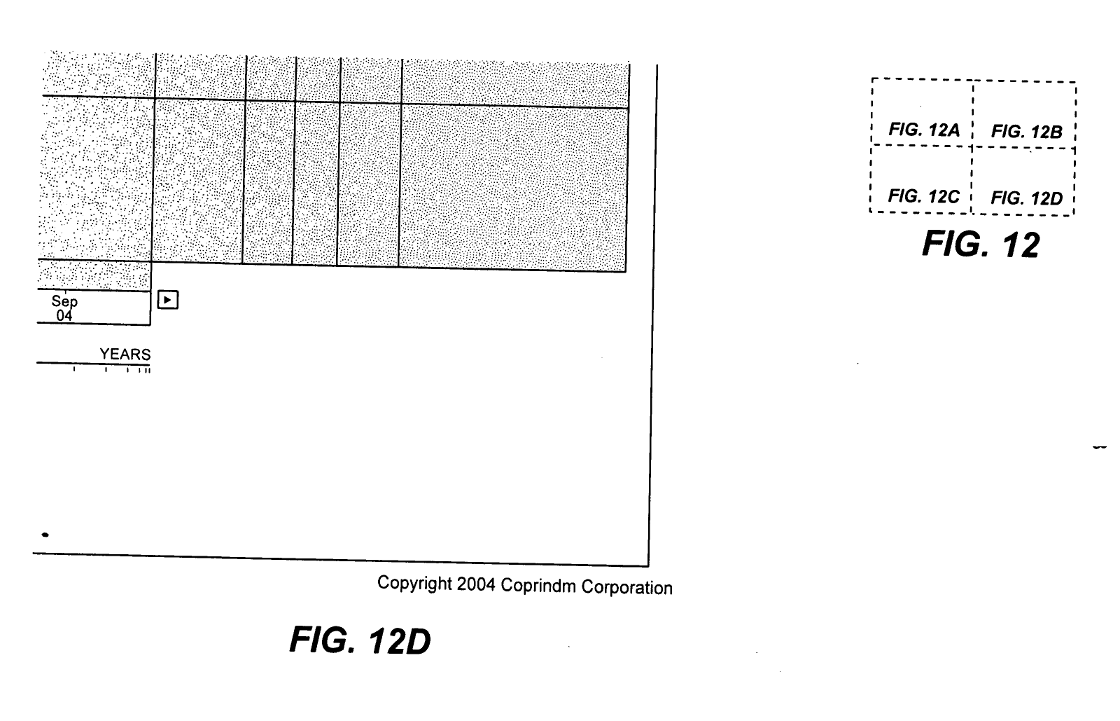

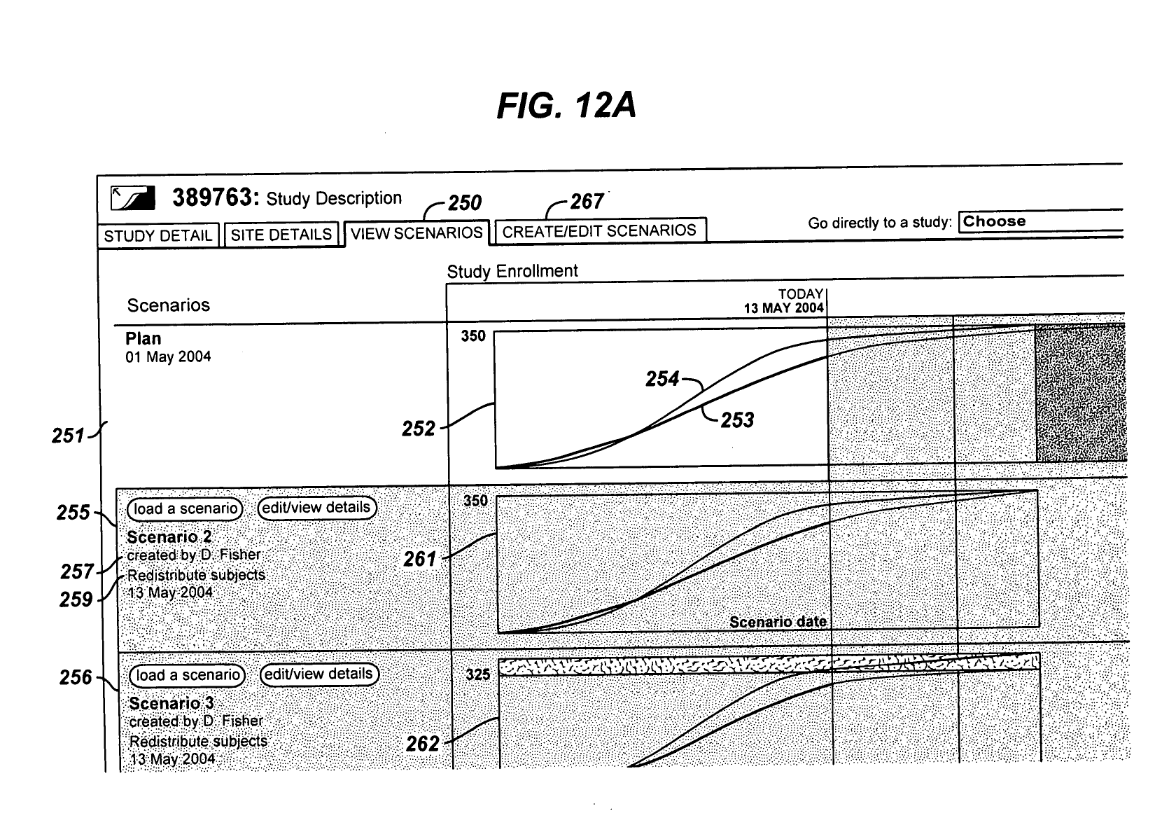

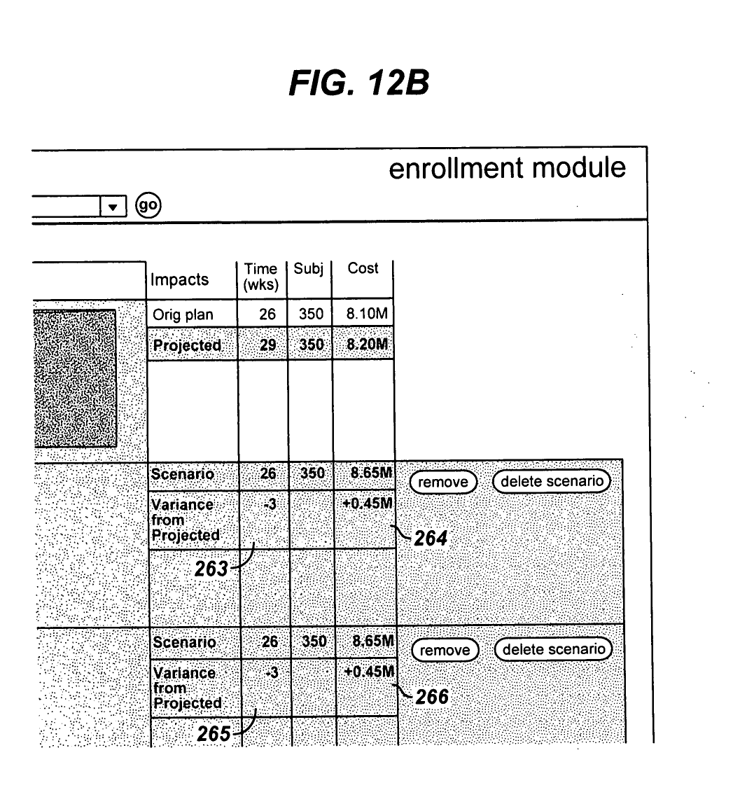

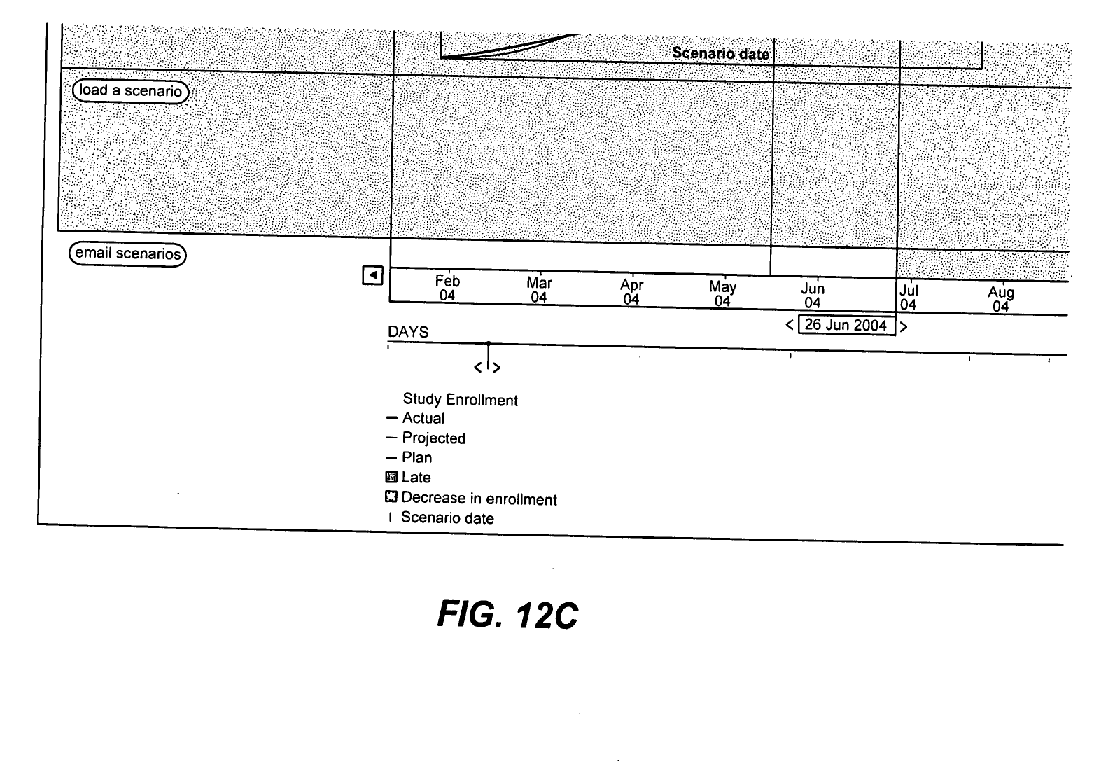

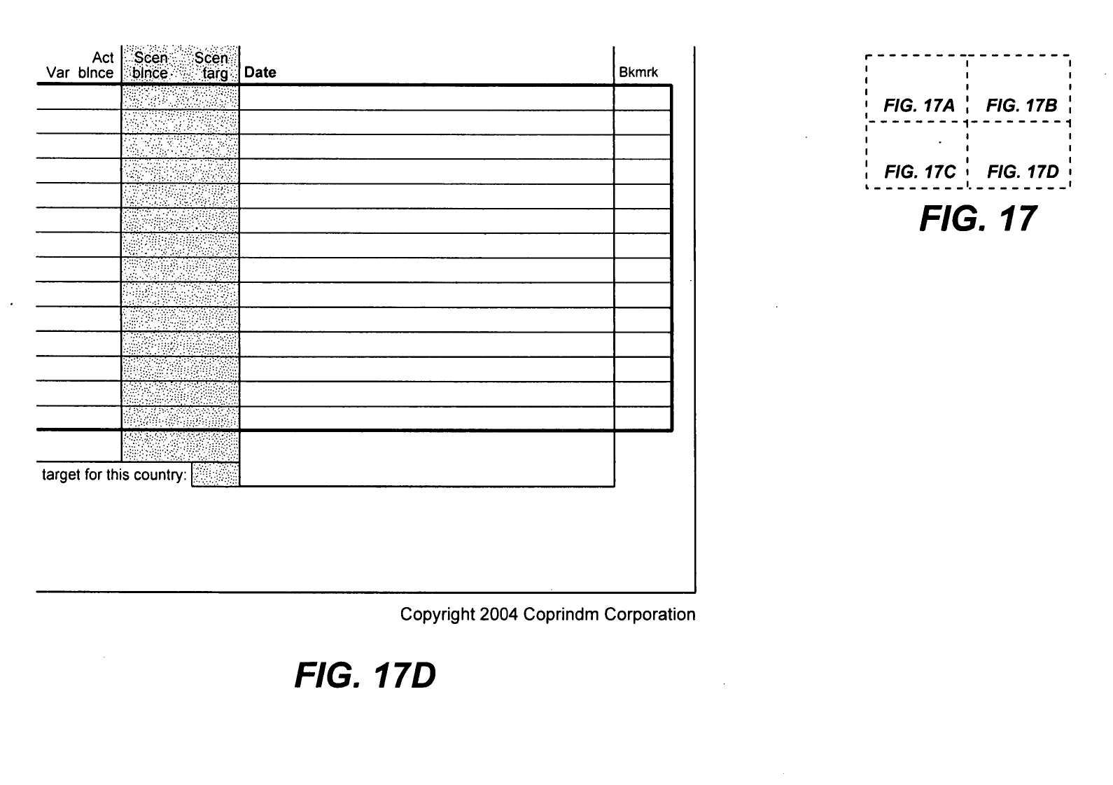

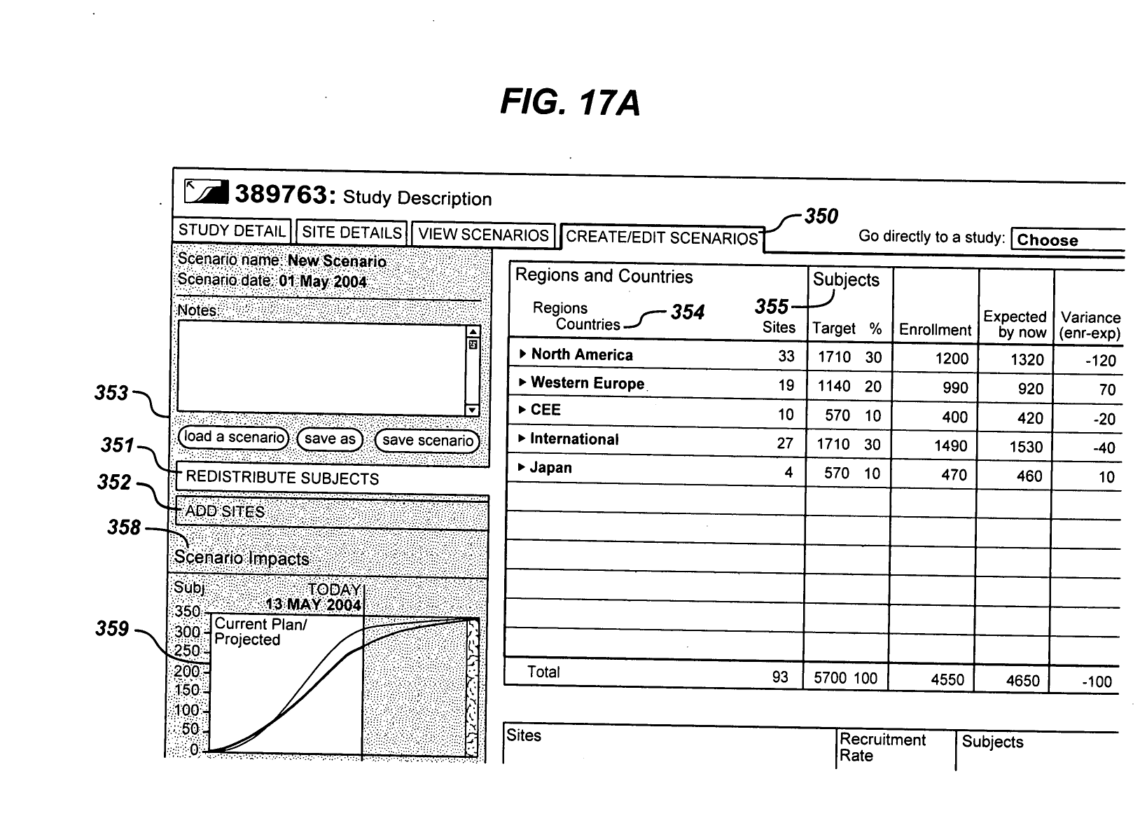

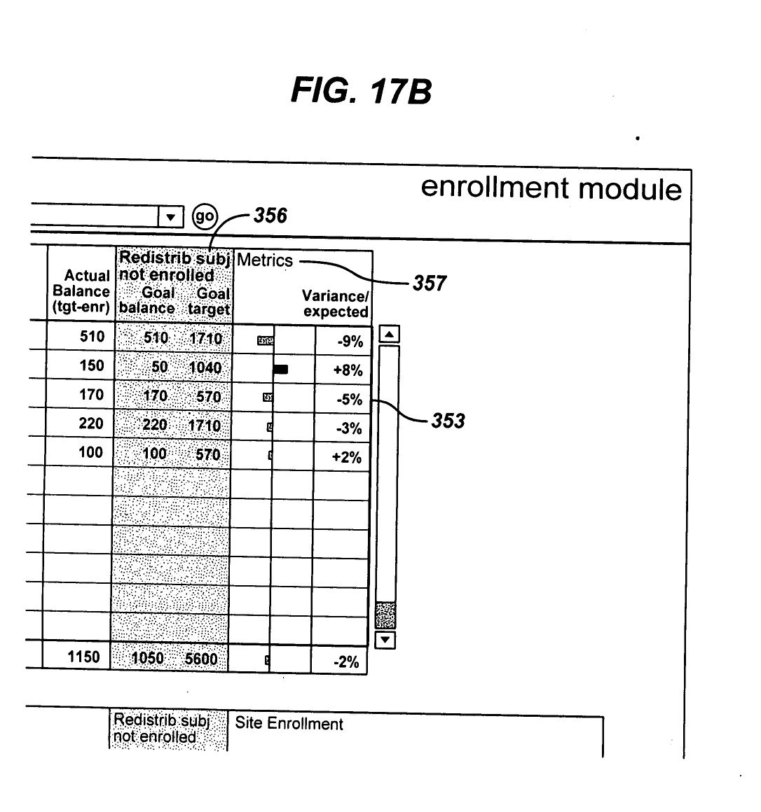

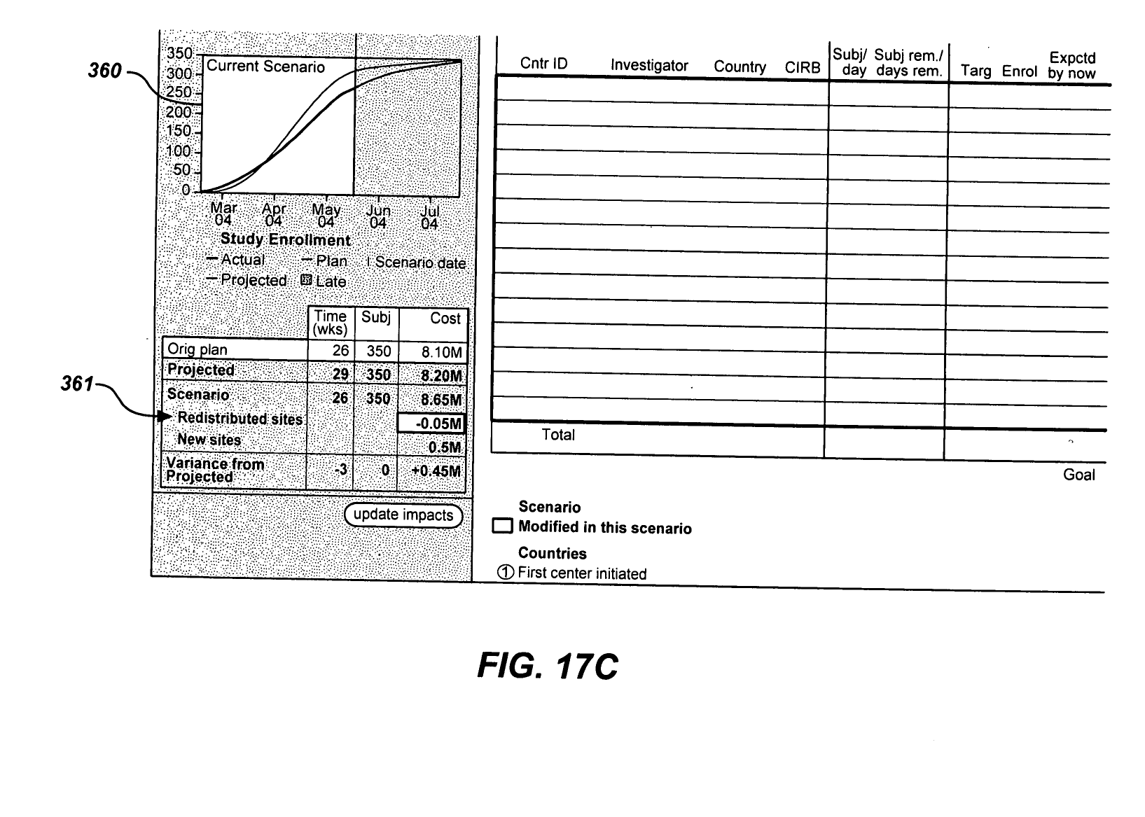

FIG. 12 is a block diagram view of an embodiment of the system of the present invention. In FIG. 12, the view scenario site details of the view scenarios tab 250 are shown. A first scenario section 251 shows the planned study enrollment in a graph 252. This planned study enrollment is the plan that was prepared for the enrollment prior to beginning the study. As shown in graph 252, of the 350 subjects that were to be enrolled, the planned line 253 is compared to an actual line 254. This plan graph 252 is then compared and shown against two scenarios, scenario 2 255 and scenario 3 256. With each scenario, a general description of who created this scenario is shown at lines 257 and 258 with the type of scenario change being shown in lines 259 and 260. The graphs 261 and 262 show the result of the scenarios on the enrollment module. The two graphs in scenario 2 of graph 261 show the difference of removing three subjects at 263 and its impact on the cost of +0.45 million at 264. In scenario 3 shown by a graph 262, a similar variance of −3 subjects at 265 are compared to the cost and budget at 266. As will be described below, to create and edit these scenarios, the create/edit scenario tab at 267 must be used and explained with regard to FIGS. 17-30 below.

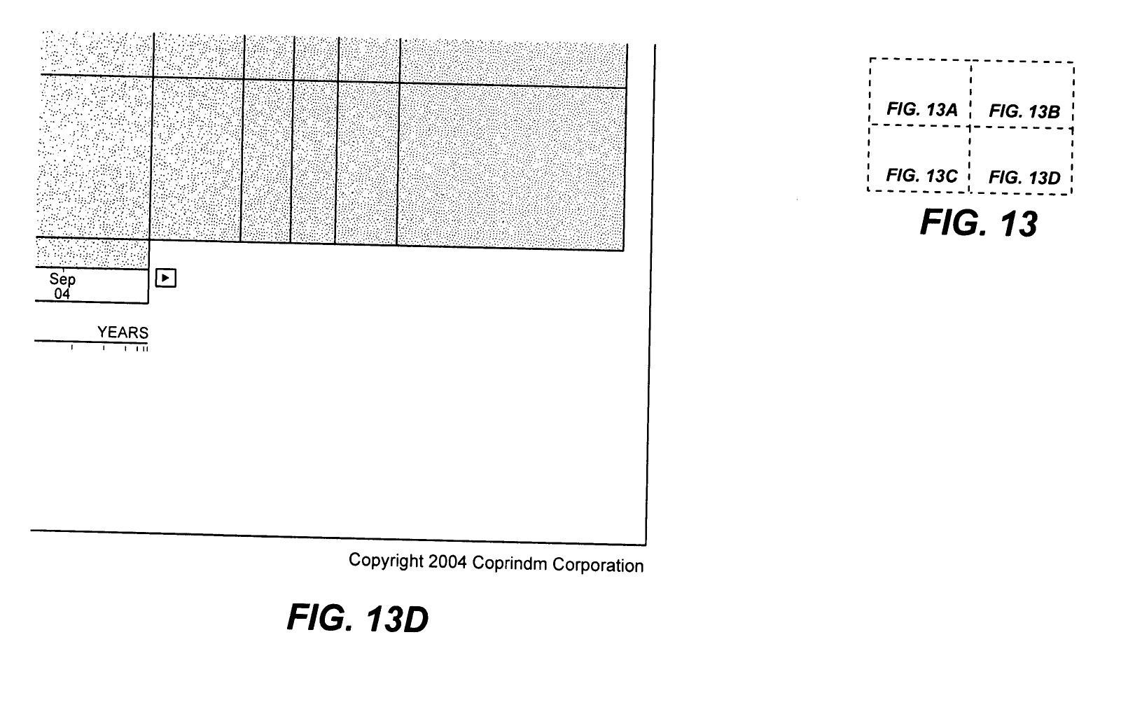

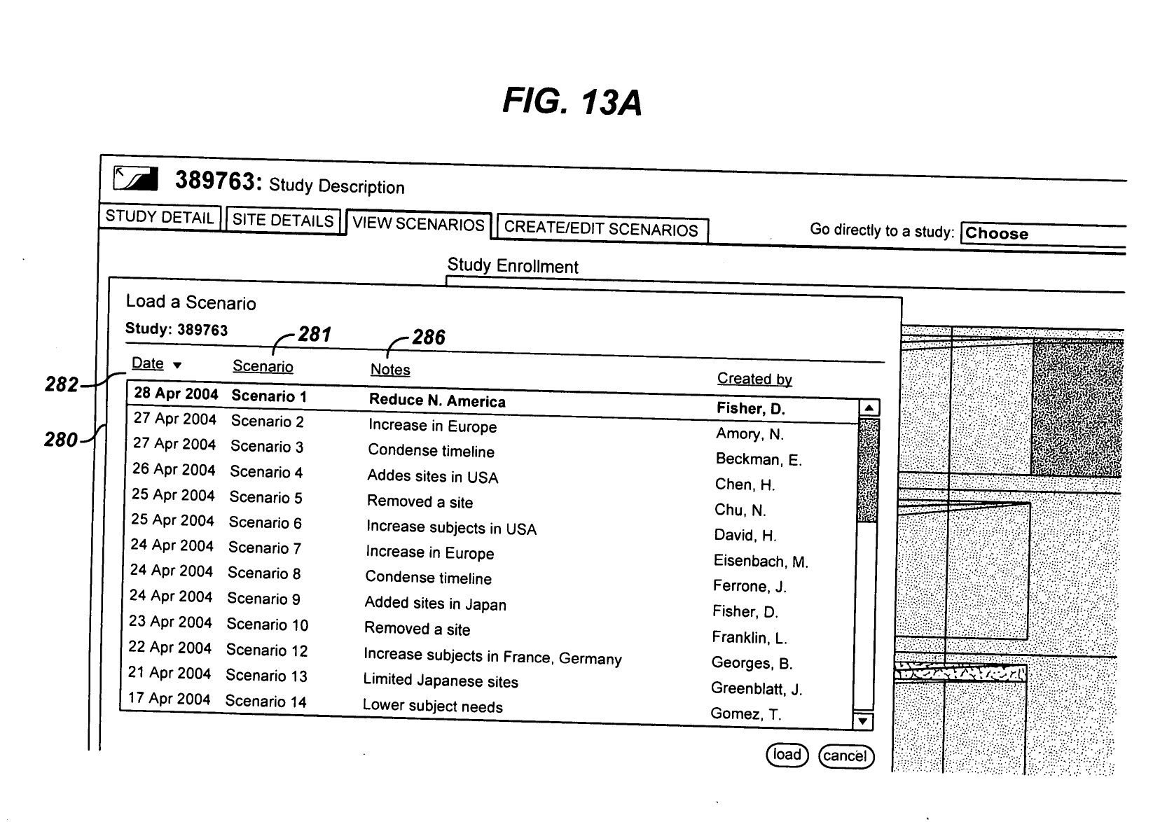

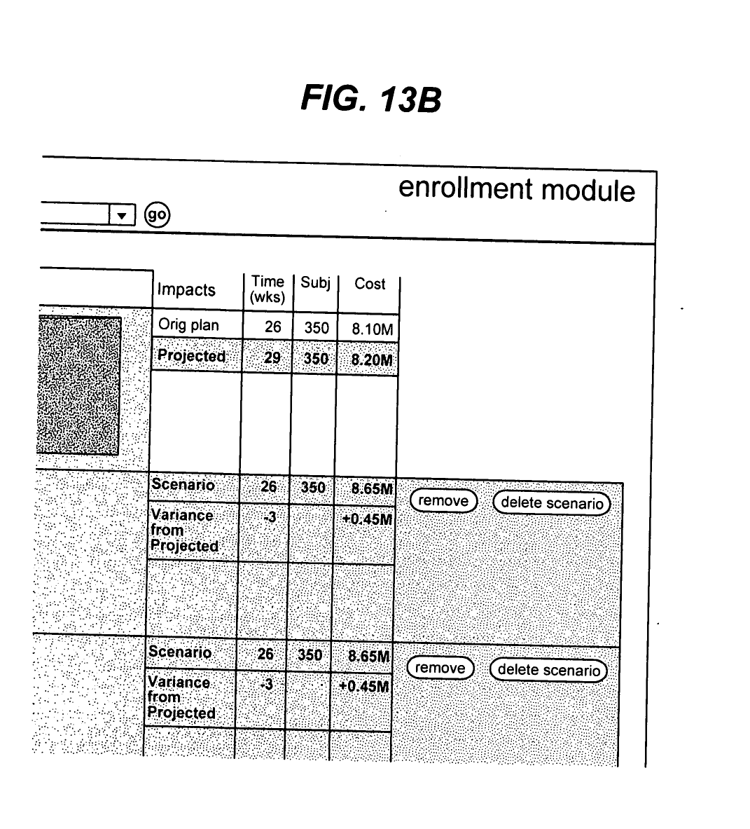

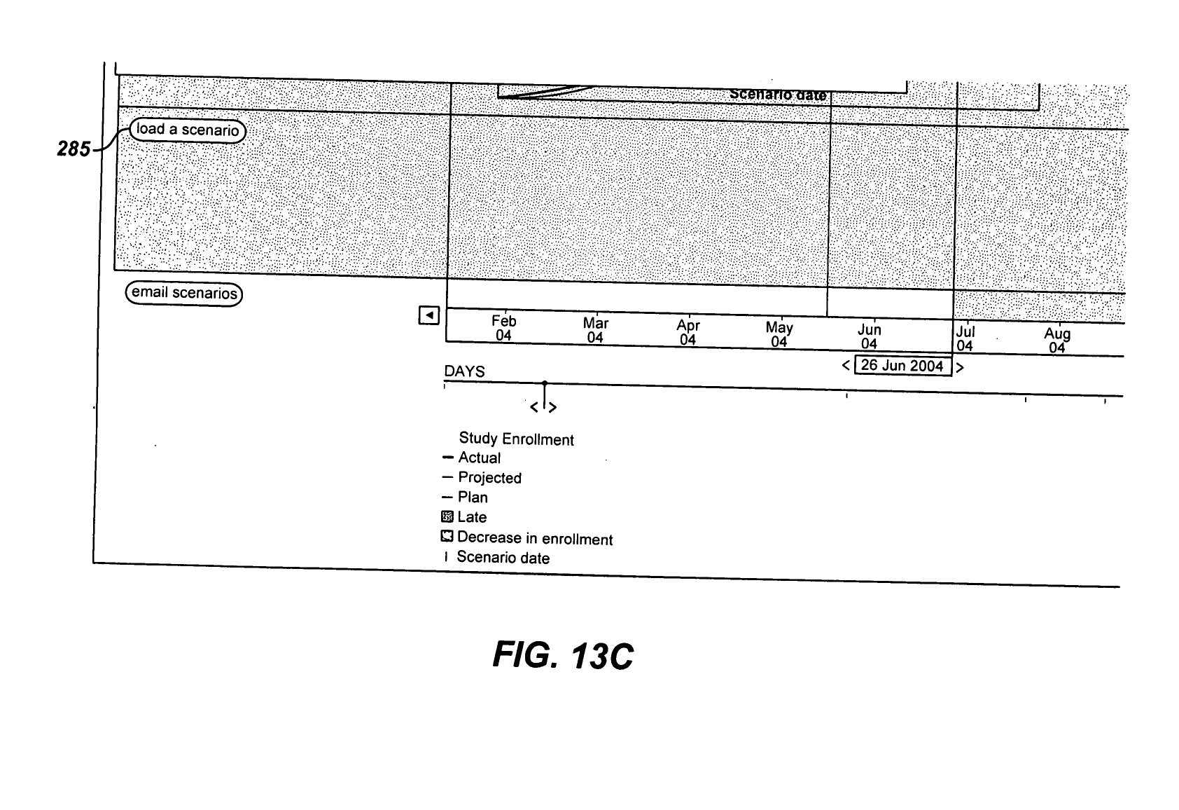

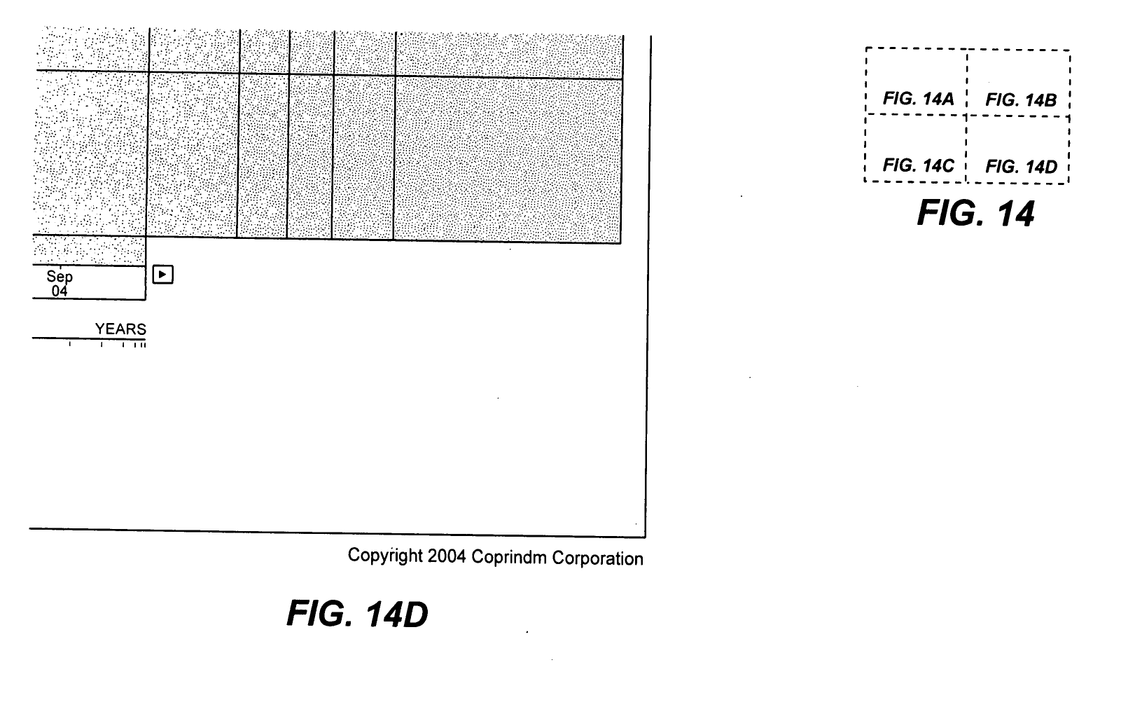

FIG. 13 is a display screen view of an embodiment of a user interface in the system of the present invention. In FIG. 13, a load scenario button 285 is pressed to show the load scenario box 280. In the load scenario box 280, the different scenarios listed under the scenario column 281 are shown with notes 286 concerning what type of changes were made in the scenario. Thus, for example, in scenario 282, dated Apr. 28, 2004, a scenario 1 to reduce North America enrollment has been created by Fisher, D. These scenarios may be inputted into the view scenario user interface to view the different changes on the original plan versus the projected plan.

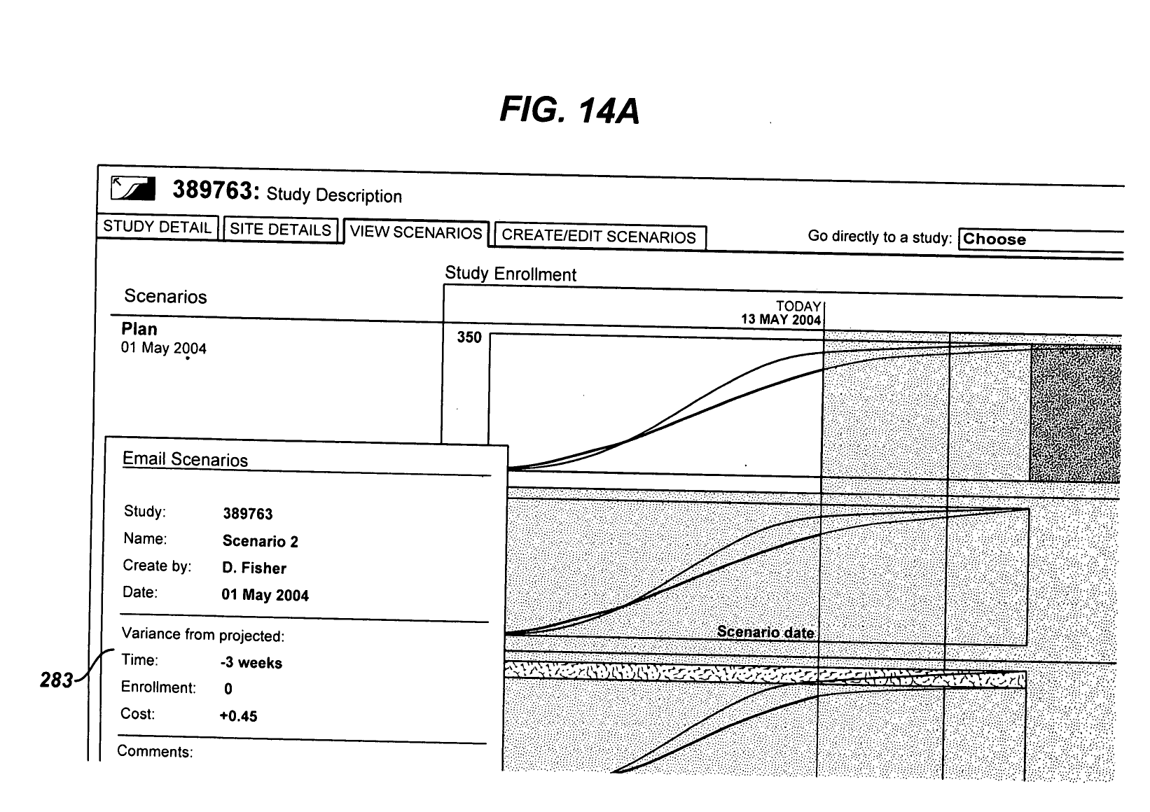

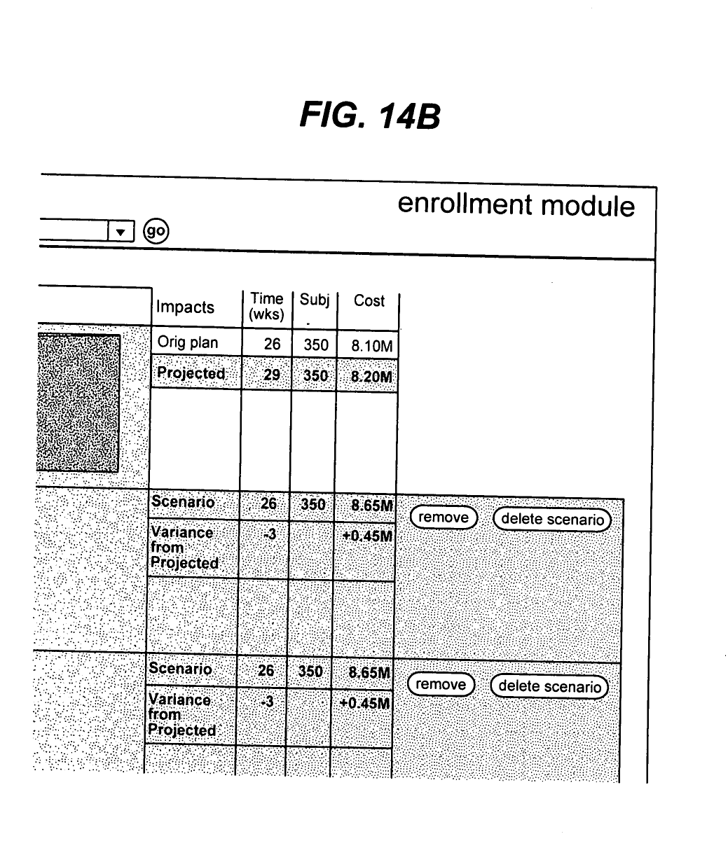

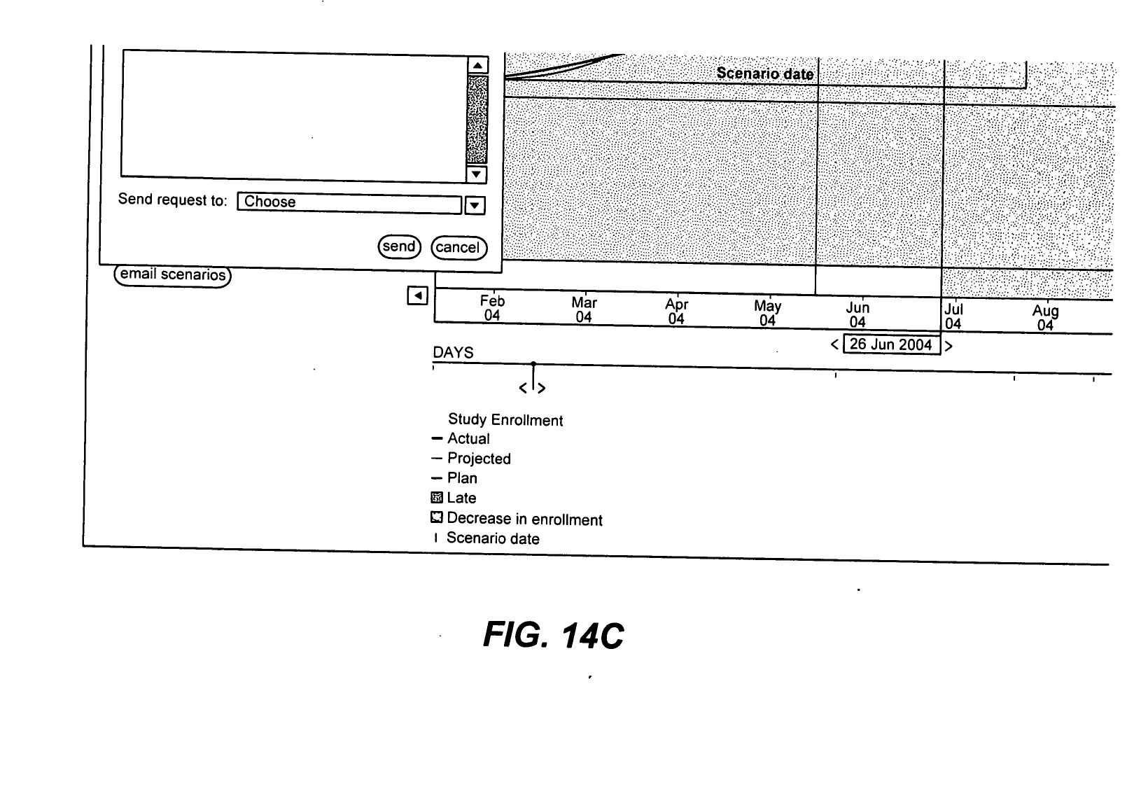

FIG. 14 is a display screen view of an embodiment of a user interface in the system of the present invention. In FIG. 14, a email scenario 283 box is shown that permits a user to email a particular scenario chosen as shown in the box 283 with comments.

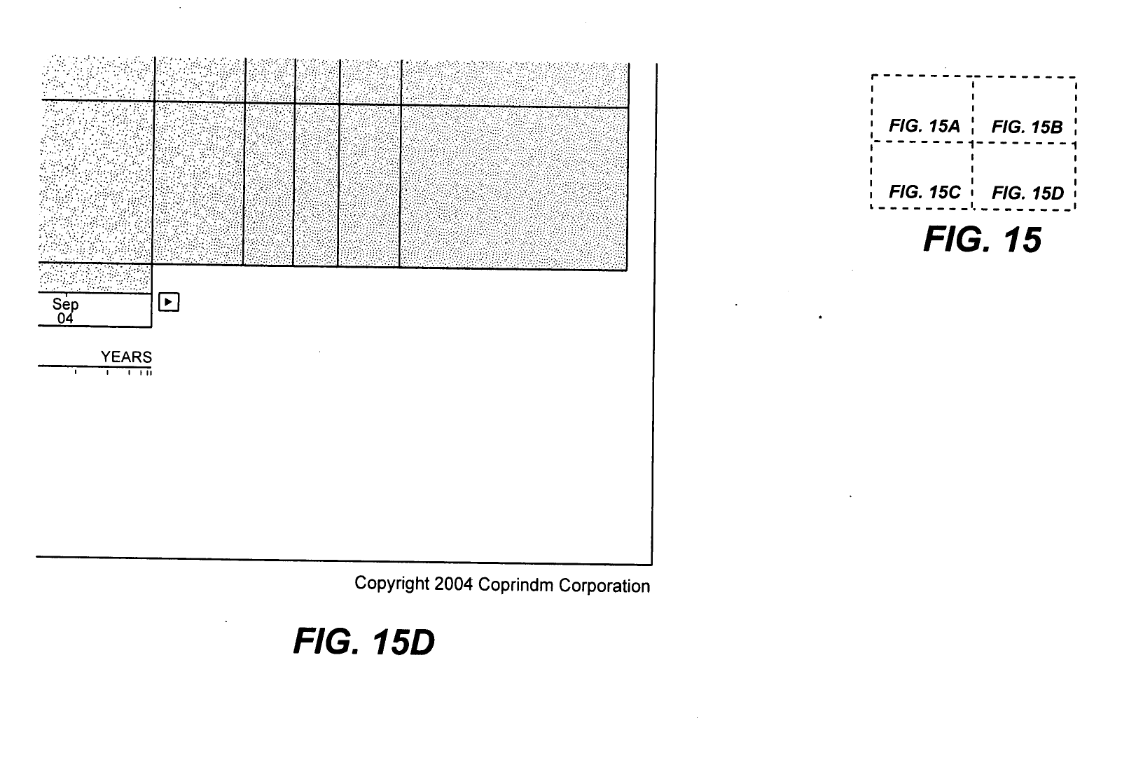

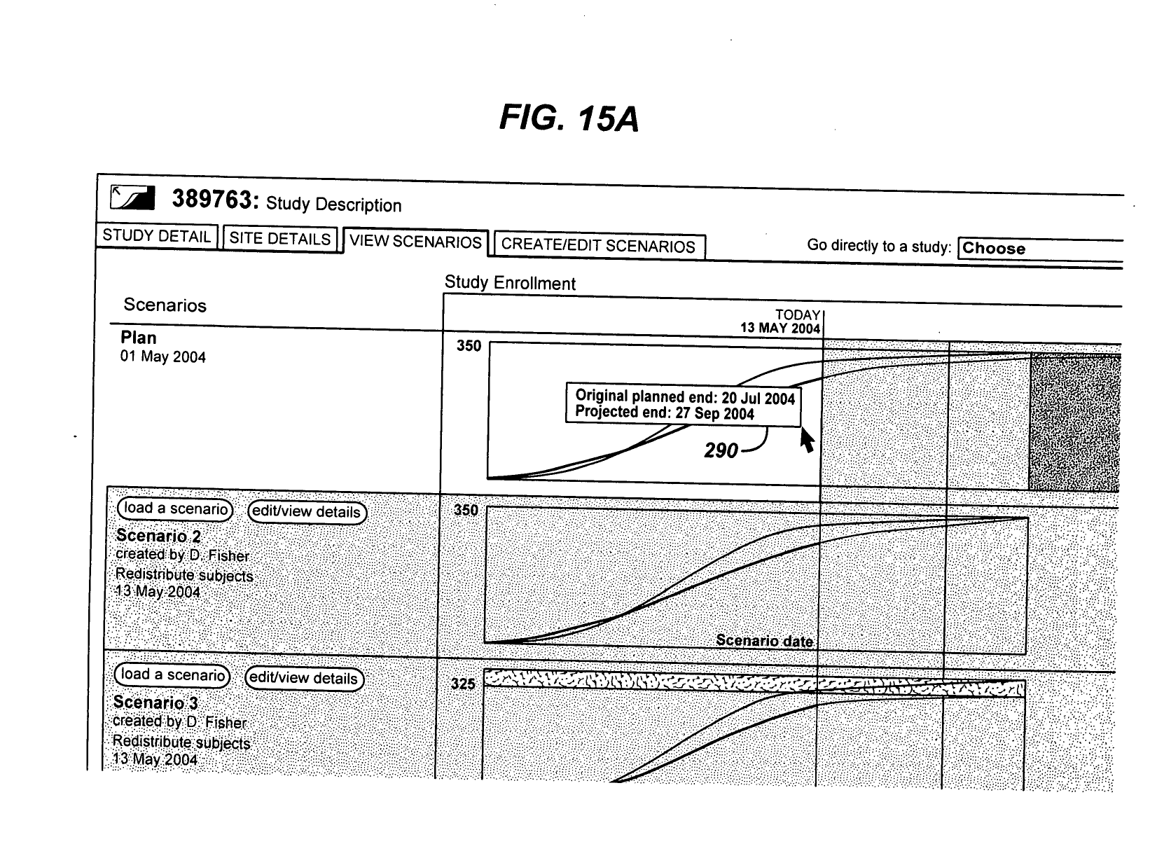

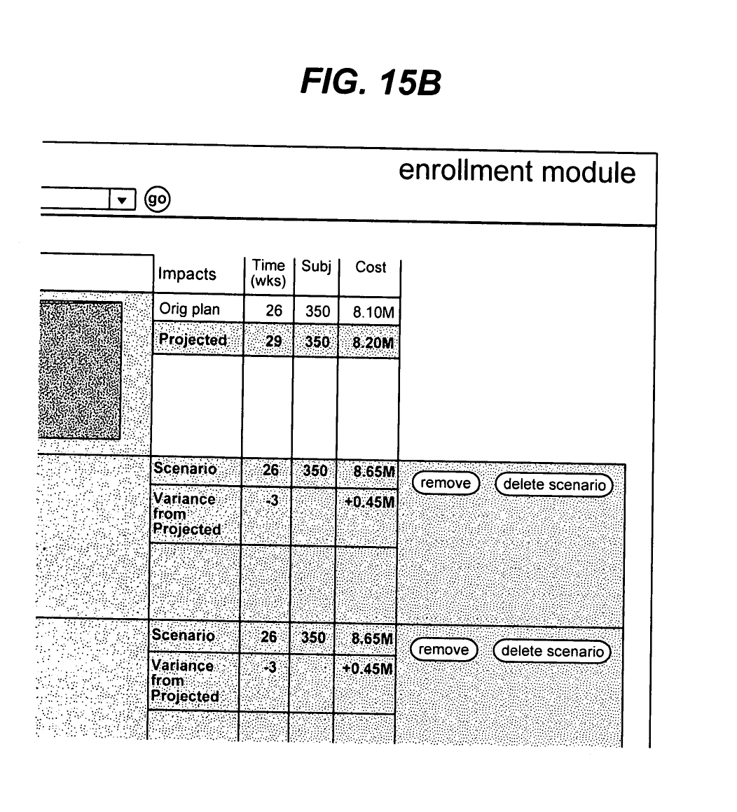

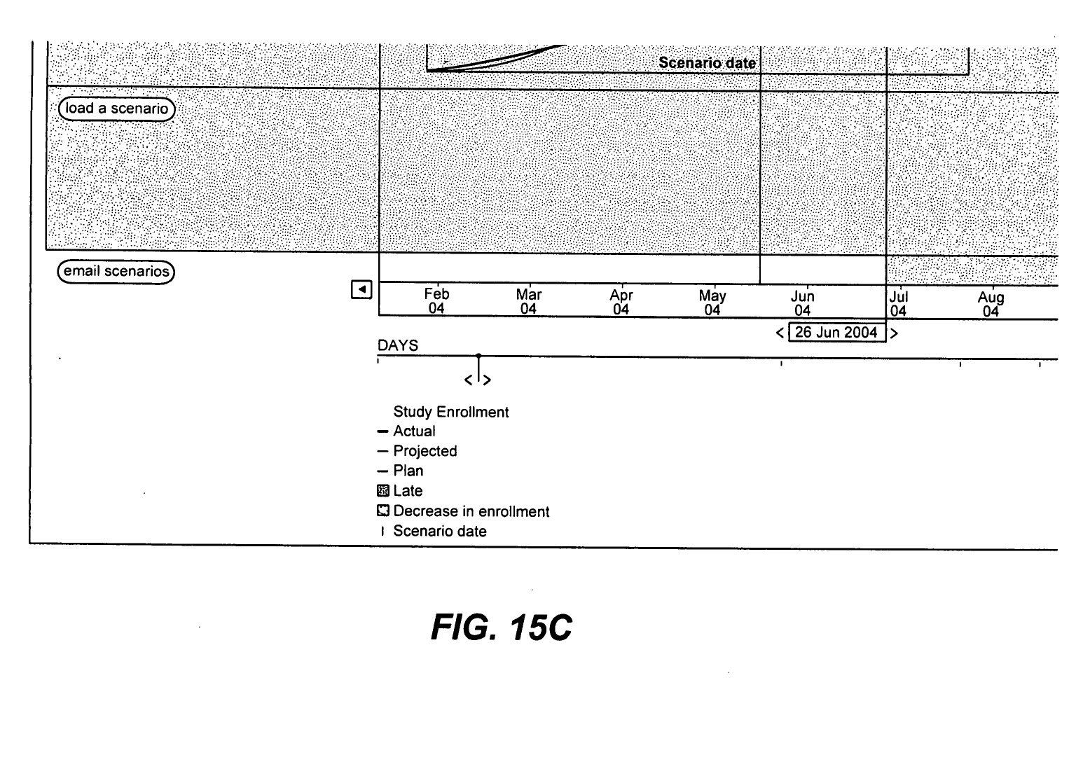

FIG. 15 is a display screen view of an embodiment of a user interface in the system of the present invention. In FIG. 15, a dialog box 290 is shown that displays when an arrow curser is placed over portions of the user interface. The dialog box 290 provides details of any graph line of the plan as shown.

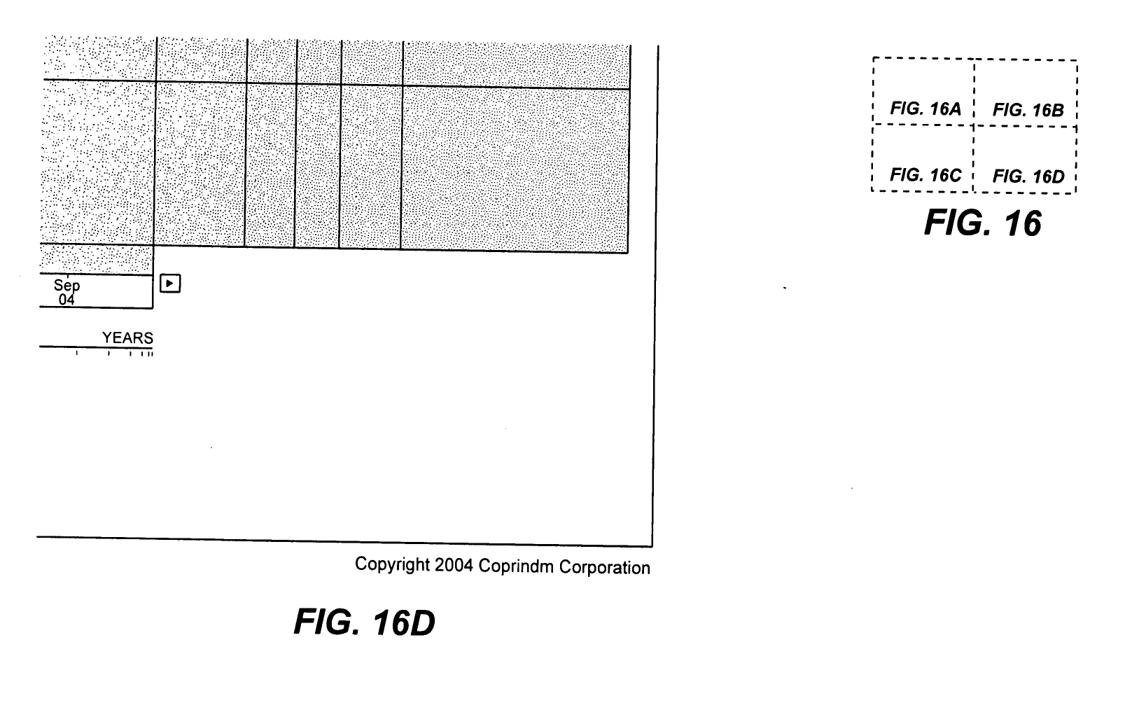

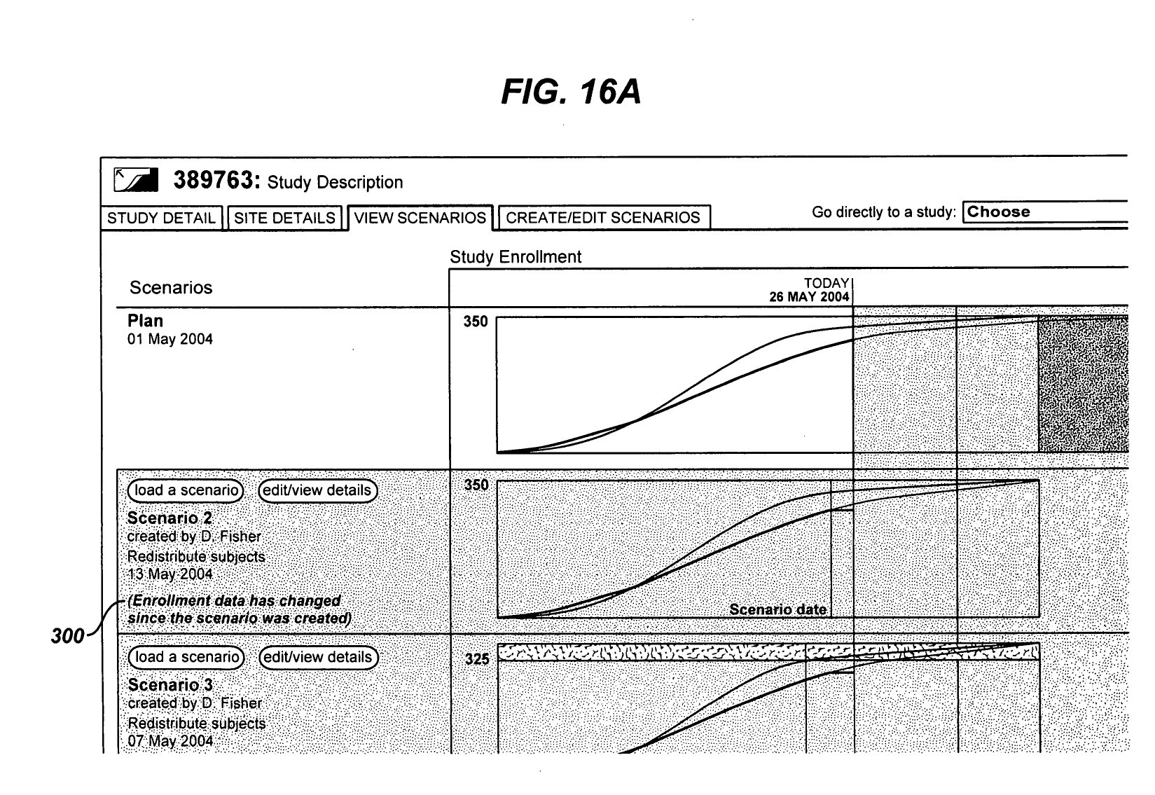

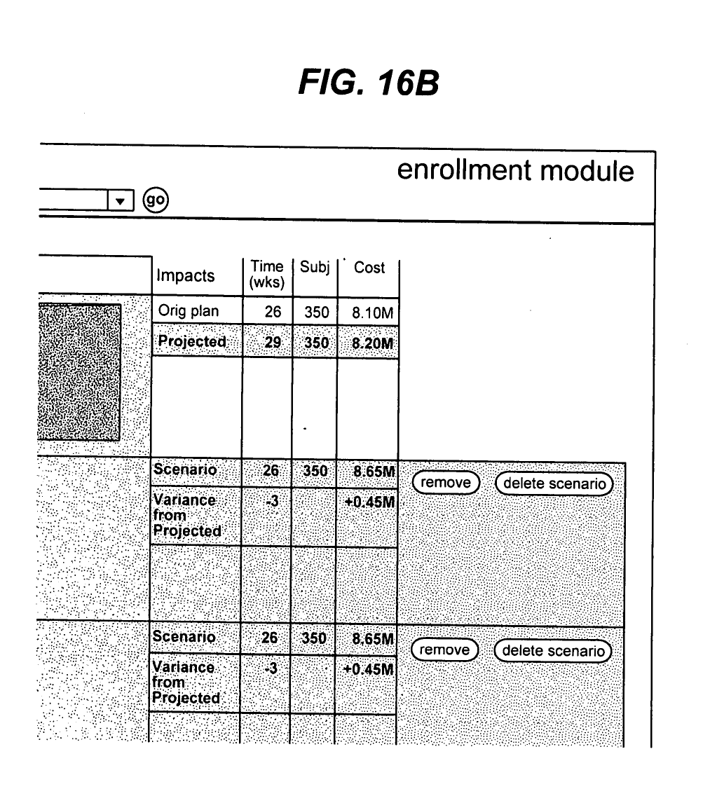

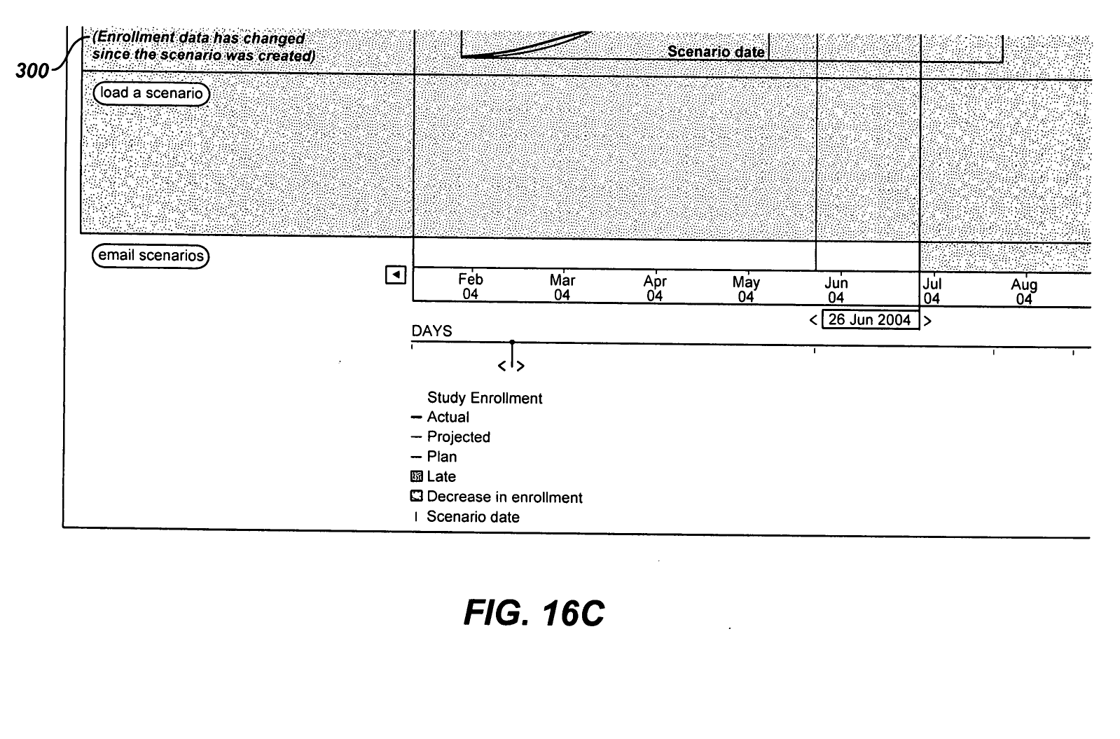

FIG. 16 is a display screen view of an embodiment of a user interface in the system of the present invention. In FIG. 16, a user is notified when the enrollment data has changed since the scenario was created at 300. In this way, a user is alerted to the fact that the actual enrollment data has changed prior to loading a scenario , where a user may re-run a scenario with the updated date.

FIG. 17 is a display screen view of an embodiment of a user interface in the system of the present invention. In FIG. 17, the scenarios are created and edited by pressing the tab 350. In FIG. 17, the user interface enables a user to begin to create new scenarios by selecting one of the actions on the tool bar shown on the left scenario section portion of the user interface, including 351 to redistribute subjects or scenario section 352 to add sites. It is understood that in this embodiment, only two different scenario sections are provided, while in additional embodiments other scenario sections can be used for the various scenarios. For example, as shown in the Figures below, another scenario section may allow a user to add an ad campaign, amend a protocol, add comments, or other scenario sections. When a user presses the redistribute subjects 251 button, the redistribute table 353 is displayed with the different regions and countries on the left column under country 354, with subjects section 355 being shown. Under the subjects section 355, the target percent, enrollment, enrollment expected by now, the variance and the actual balance columns are provided. In the redistributed subjects not enrolled 356 column, a goal balance and goal target is provided. Metrics are then provided in the metrics column 357 using a color graph or percentage of the variance expected. In addition, the create/edit scenario screen 350 also contains additional scenario impacts 358 shown in two different graphs 359 and 360. These scenario impacts were also shown in the FIG. 16 of the view scenarios, but are provided here for ease of viewing to be viewed. Likewise, the metrics provided in 361 also are shown in other user interface, but are also provided in this user interface.

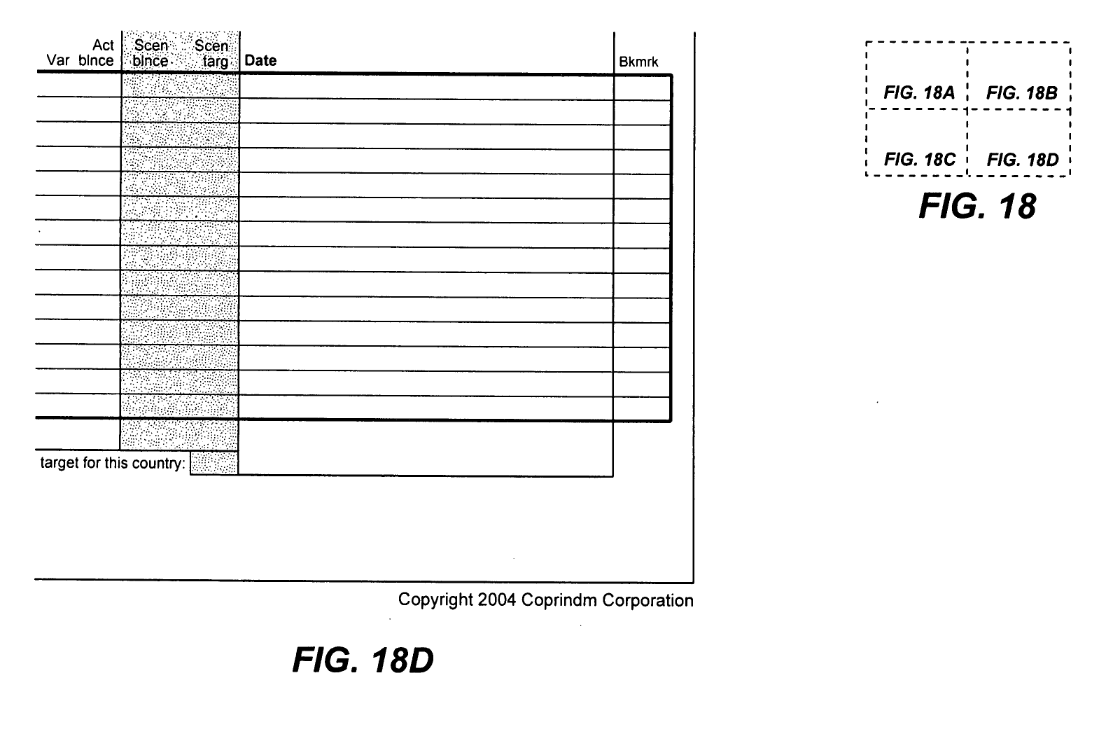

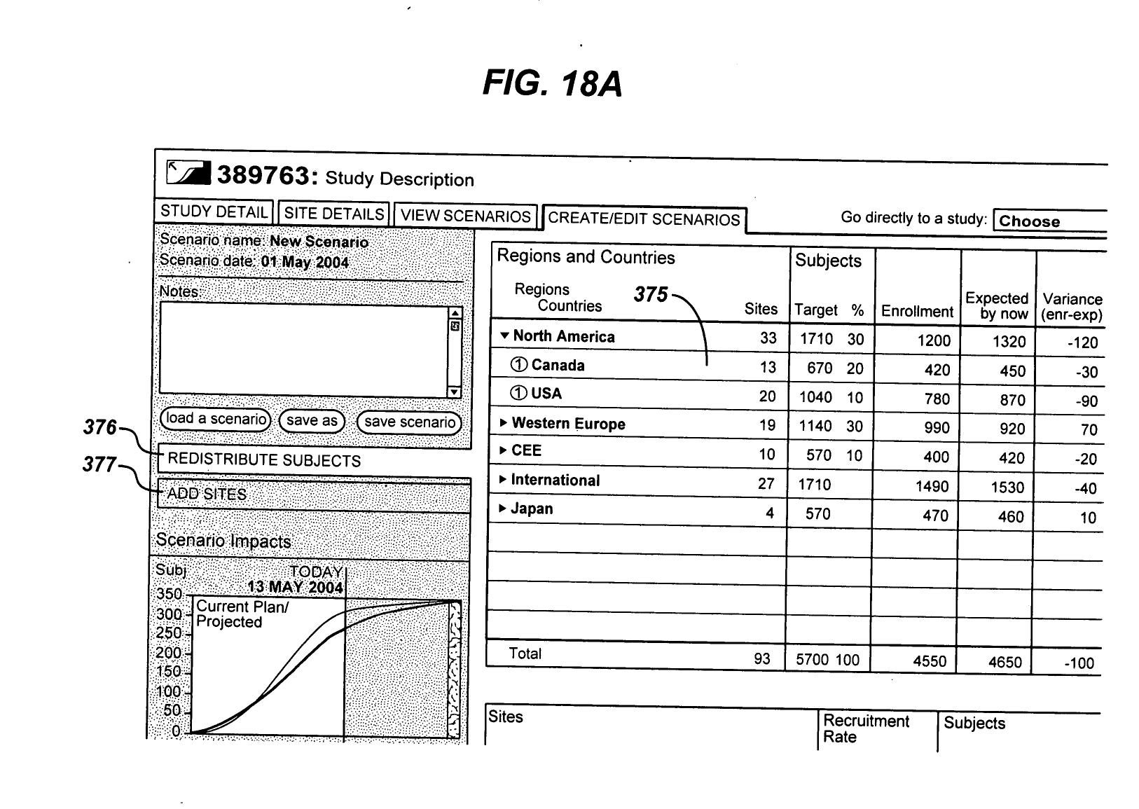

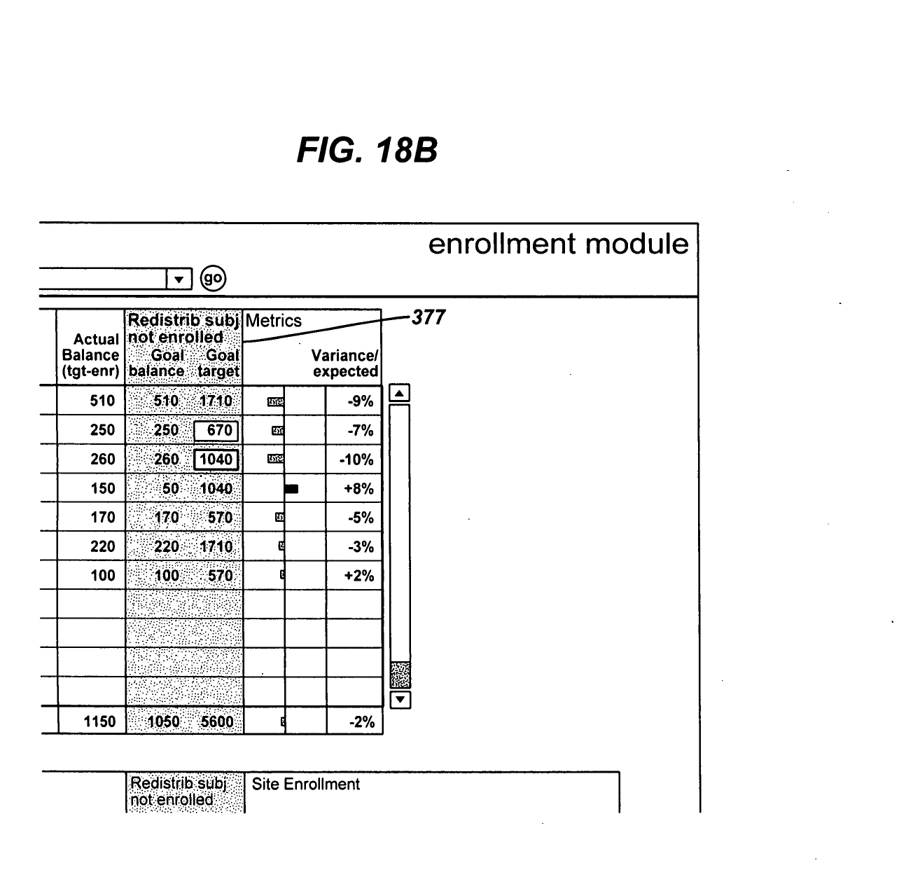

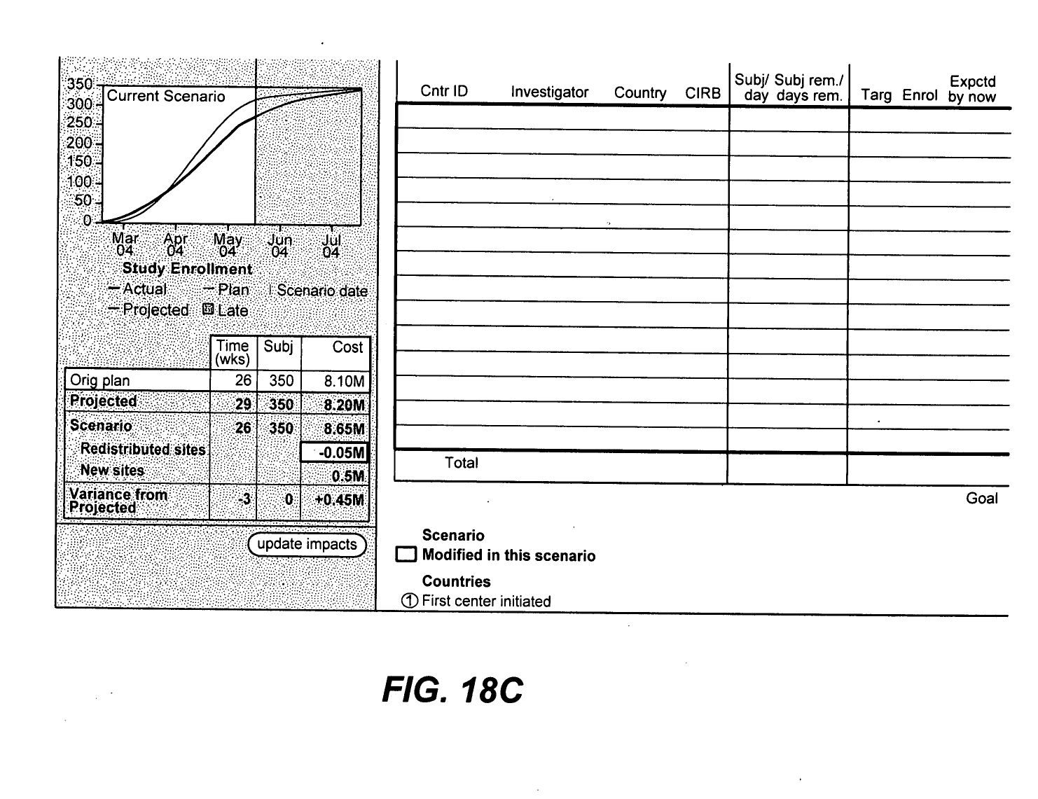

FIG. 18 is a display screen view of an embodiment of a user interface in the system of the present invention. In FIG. 18, the create/edit scenario screen is further shown with a drill down box 375 showing Canada and U.S. within North America from the FIG. 17 view of North America alone. It is generally understood that this create/edit scenarios display screen is used to model different scenarios for clinical trials of a drug in the drug development process. The data provided throughout this enrollment modules, including the subjects, metrics and other data are provided to a computer system that generates and displays the display screen. The study data represents data from one or more of the studies shown in the site details and study details screen. The subjects shown in the various screens are the patients that one or more of the studies are performed on during the clinical trials of the drug. Again, the scenarios located on the left side of the screen including the redistribute subjects 376 and the ad sites 377 represent changes that could be made to one or more of the studies to model the effect of the changes made on the clinical trials. The modeling is shown by redistributing subjects in the column 377. After the subjects are redistributed in the column 377, the display screen of FIG. 18 displays the effect of the changes on the clinical trials effectuated by changing the one or more parameters such as in column 377. This change is specifically related to redistributing subjects in this scenario.

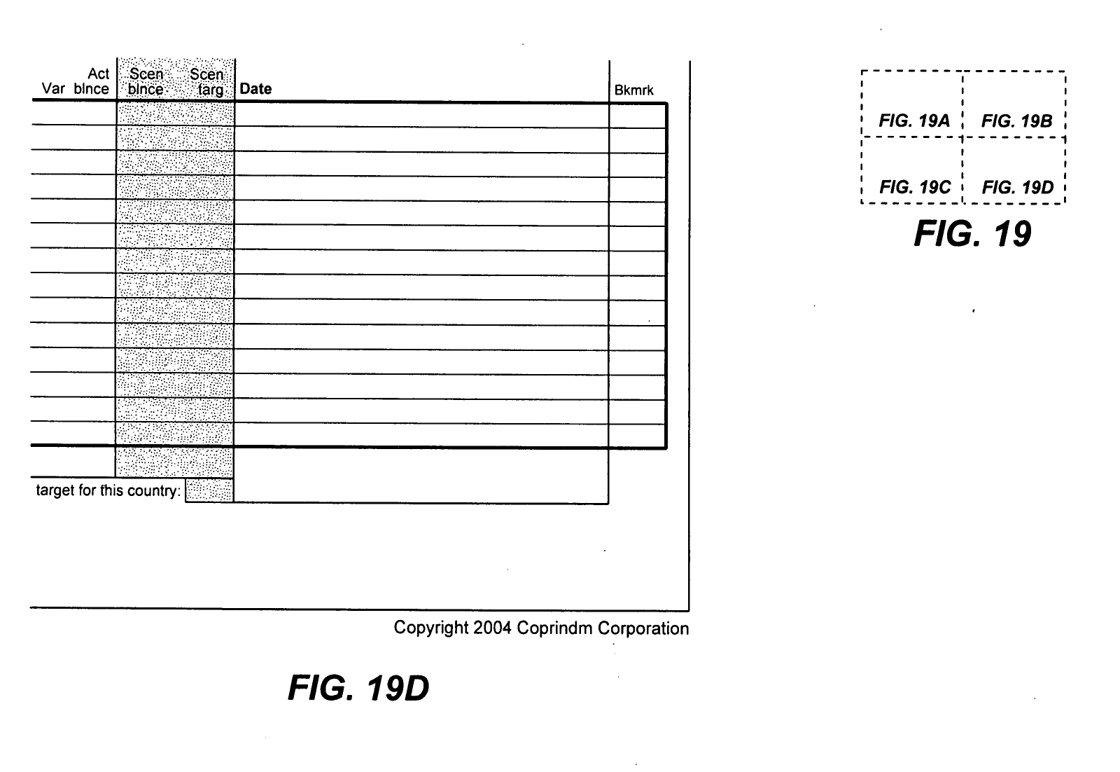

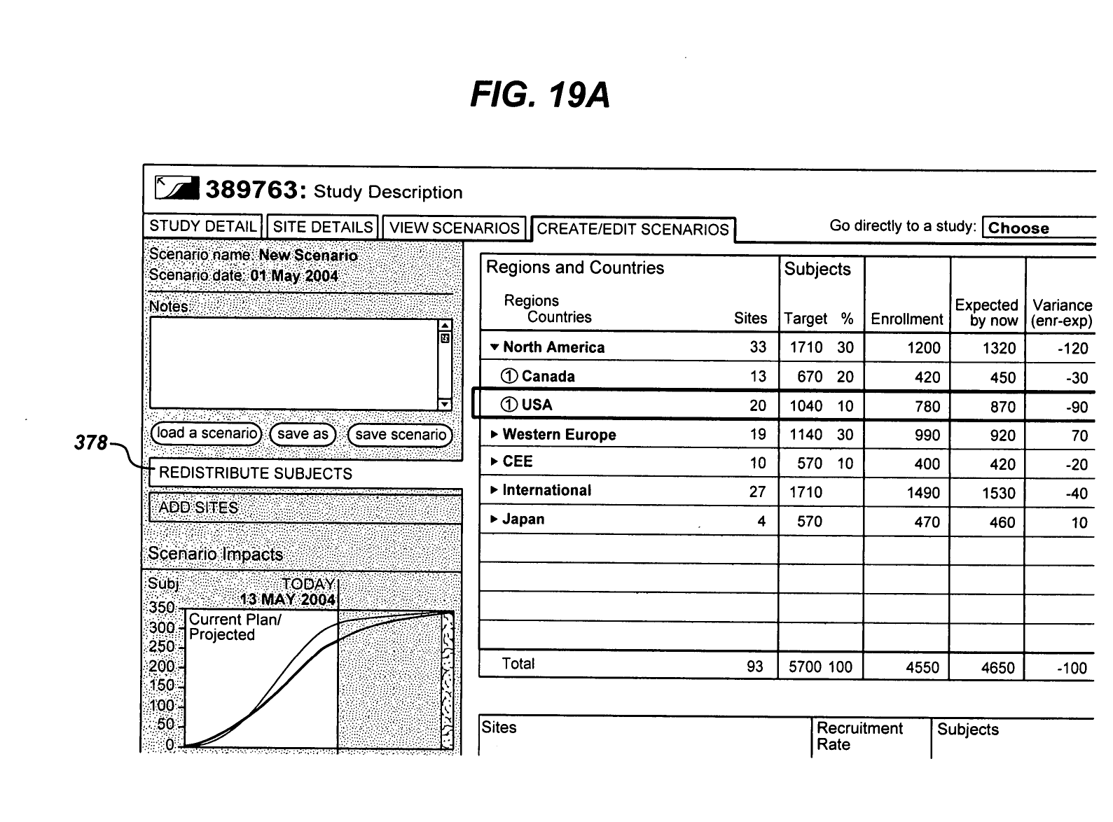

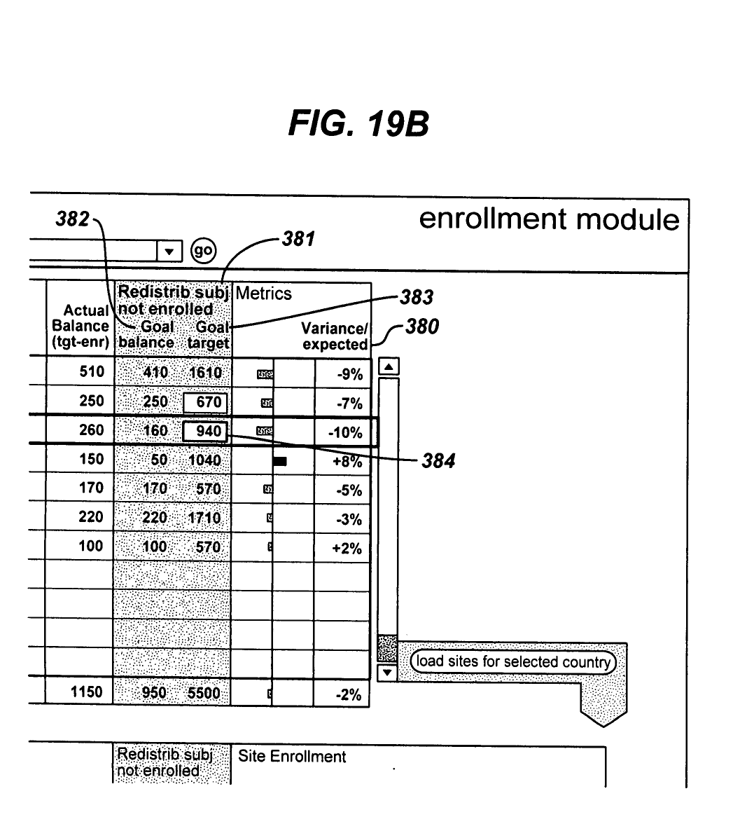

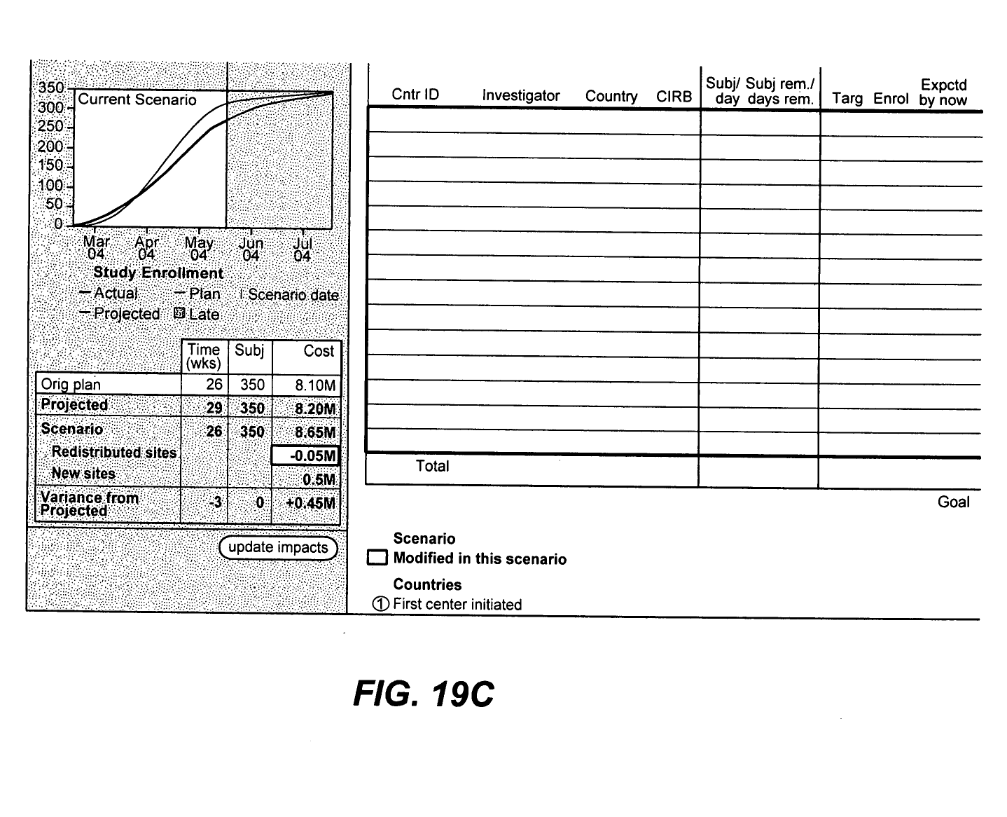

FIG. 19 is a display screen view of an embodiment of a user interface in the system of the present invention. In FIG. 19, the redistribute subjects section 378 was pressed and the window 380 has been displayed on the display screen. In the redistribute subject column 381, the scenario has modeled the effect of removing 100 subjects from the goal balance 382 and the goal target 383 that has been reduced now to a goal balance of 410 rather than 510 in FIG. 18 and 1610 rather than 1710 in FIG. 18. Accordingly, the numbers below for Canada and the U.S. have also been changed to account for the 100 redistributed subjects.

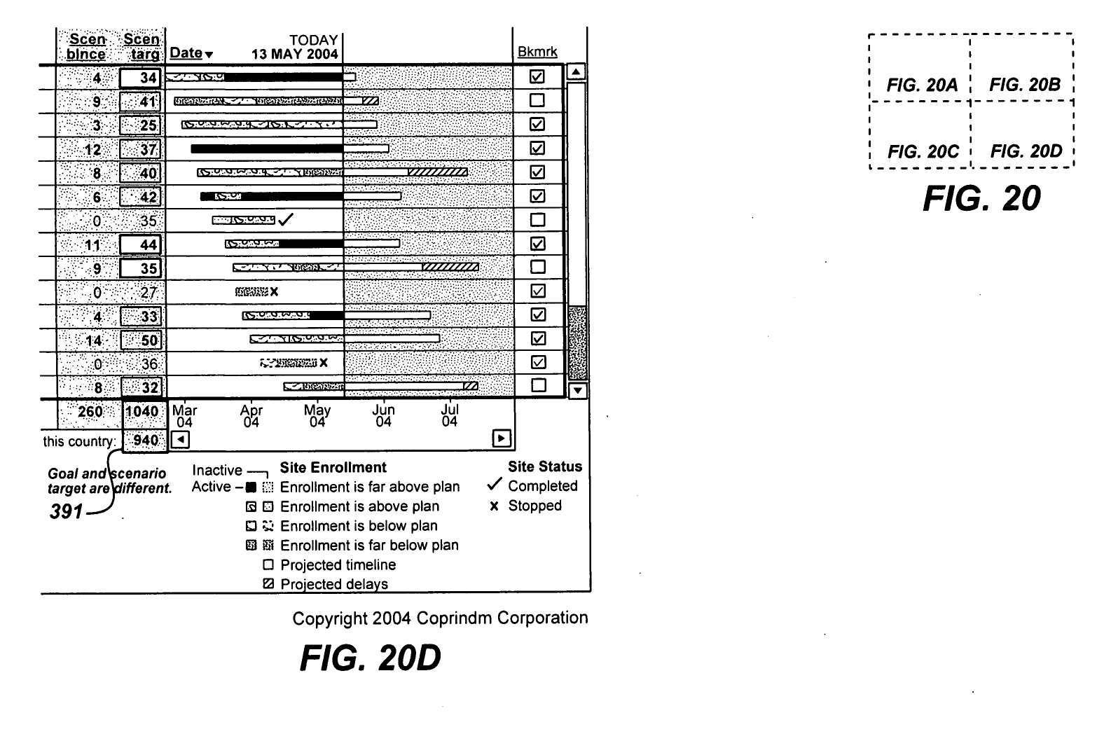

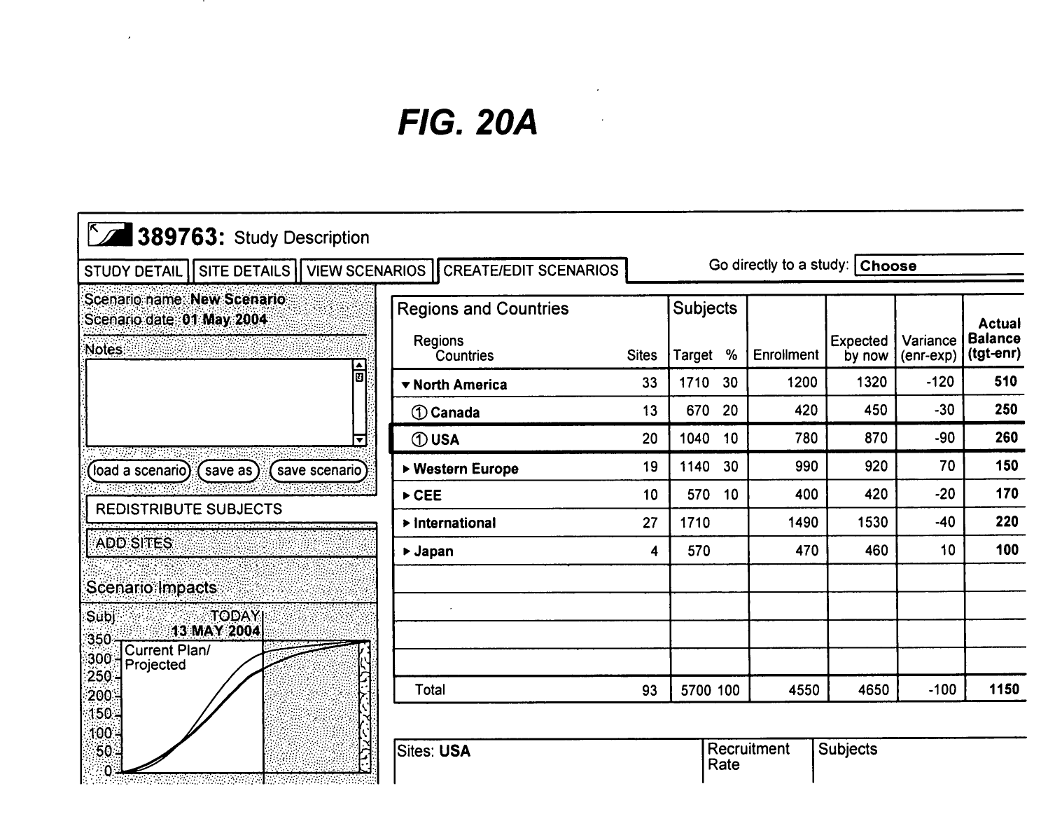

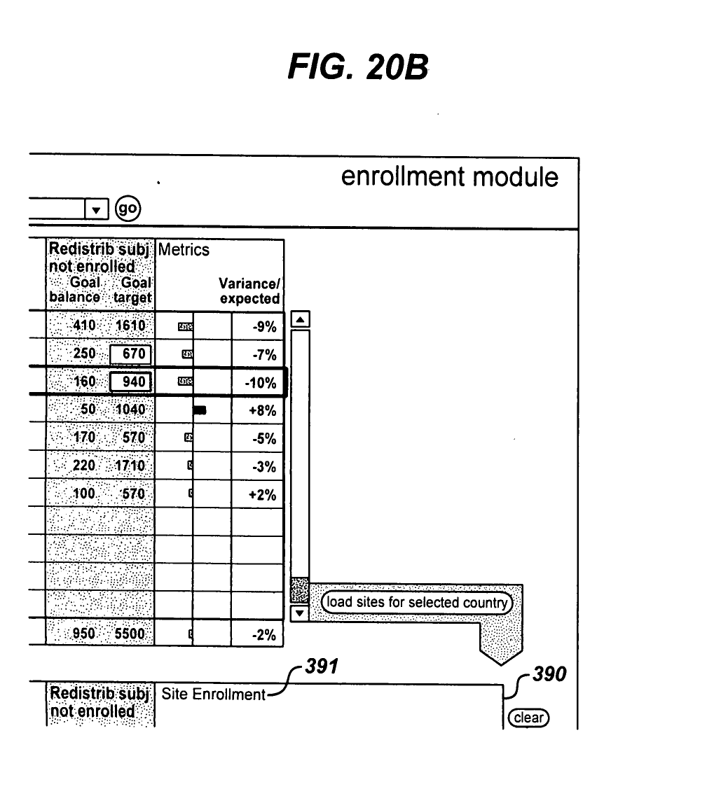

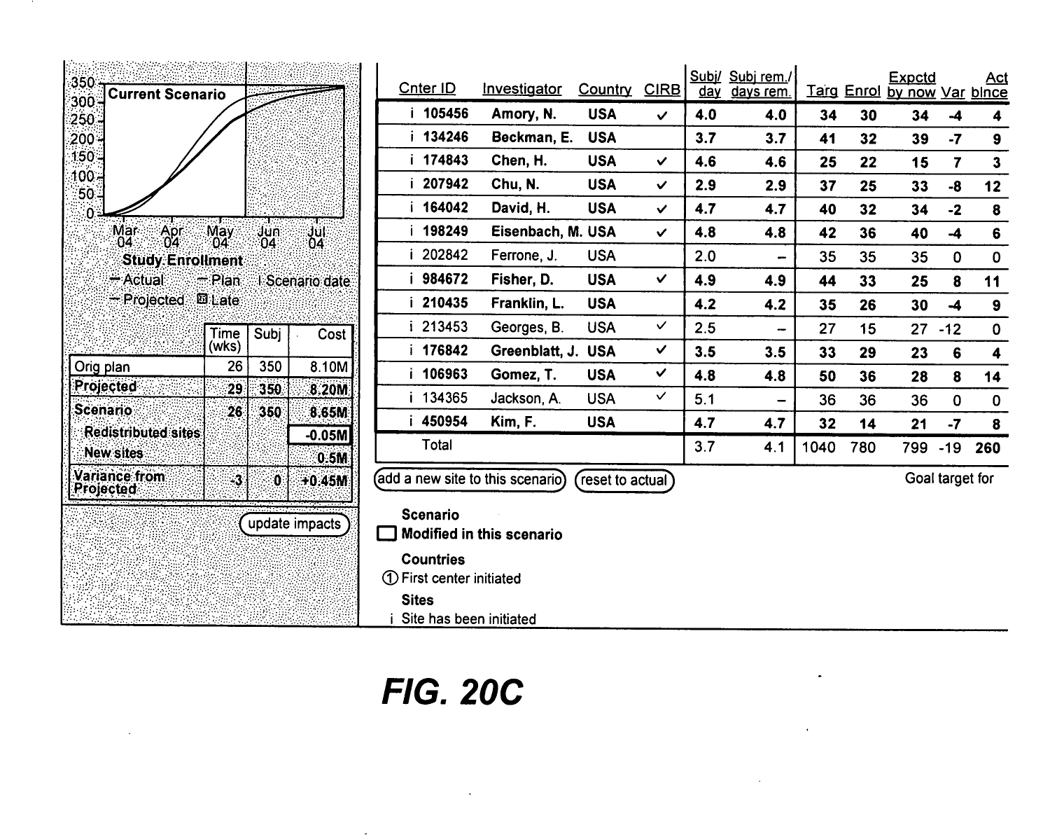

FIG. 20 is a display screen view of an embodiment of the user interface of the system of the present invention. FIG. 20 displays the changes that are effectuated by the changes made in FIG. 19 redistributing the 100 subjects. By redistributing the subjects, the window 390 shows the actual subjects that have been redistributed and the effect on the site enrollment at the locations where it has been distributed as shown in the goal target box 391.

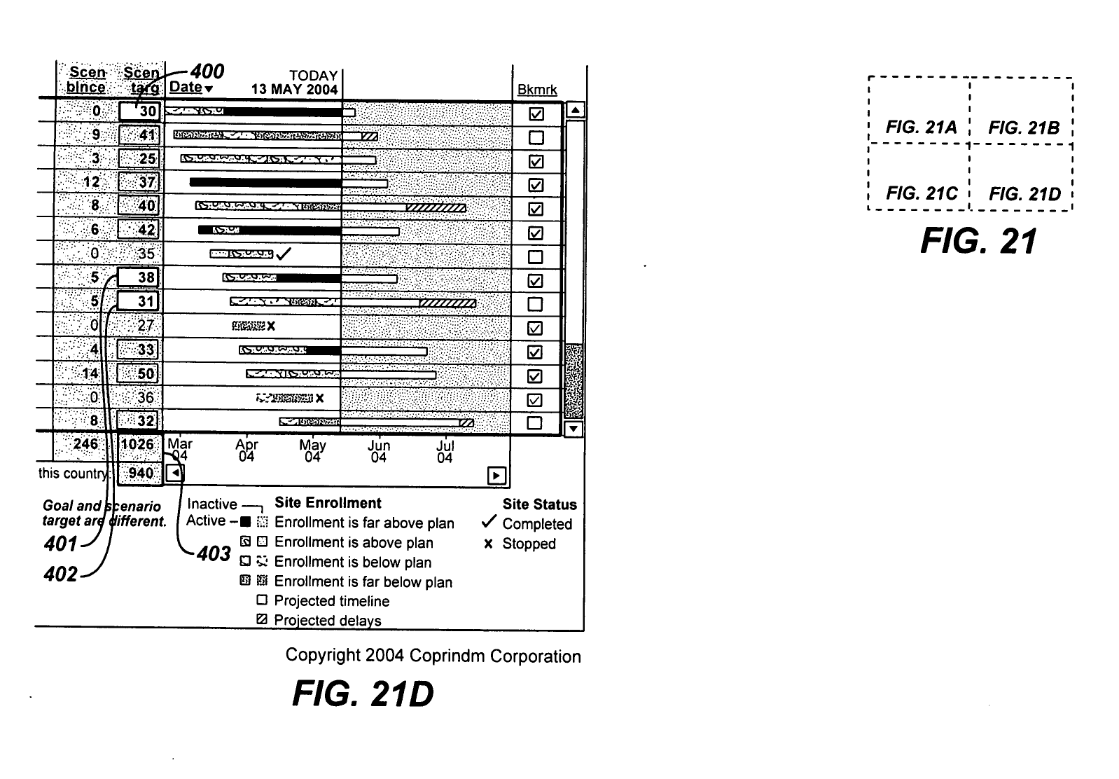

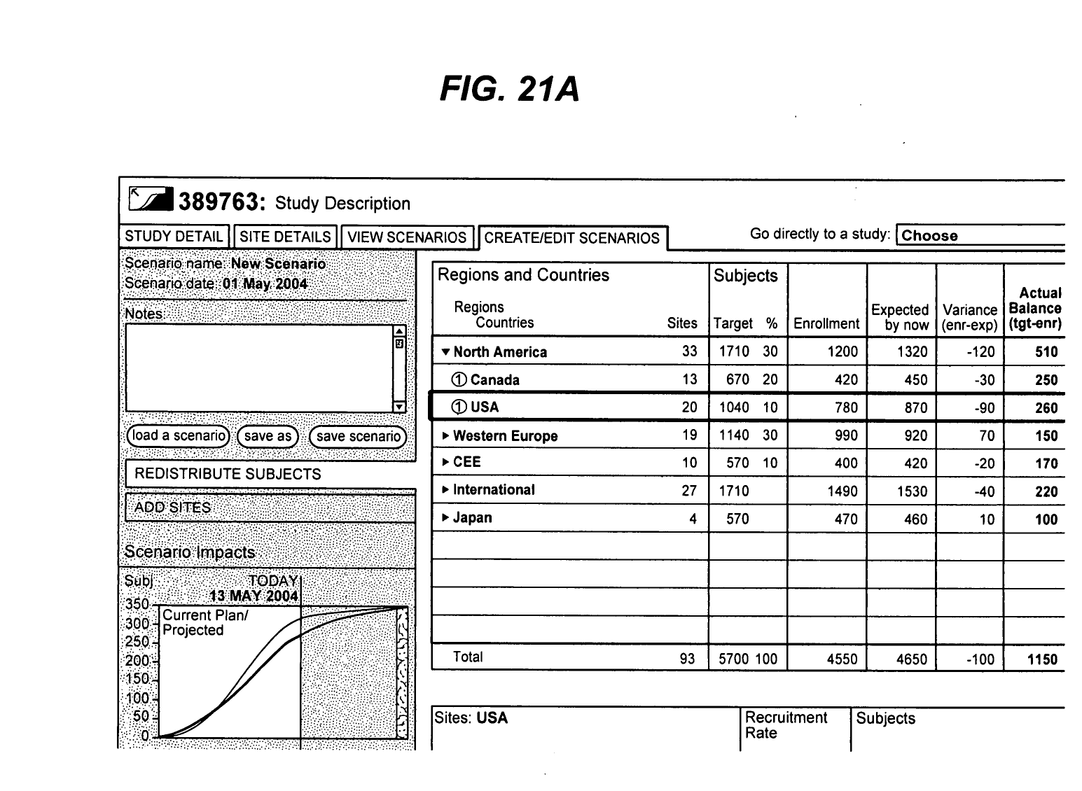

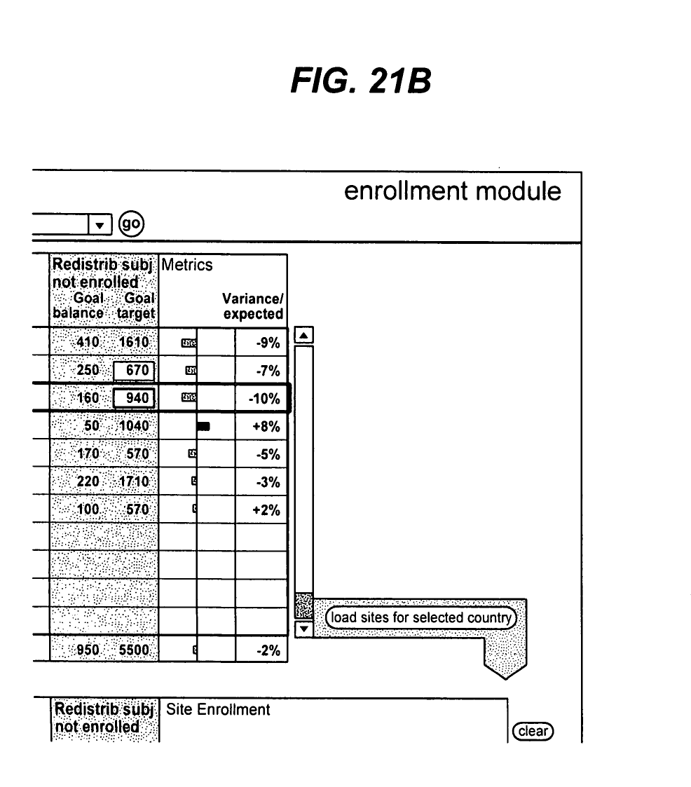

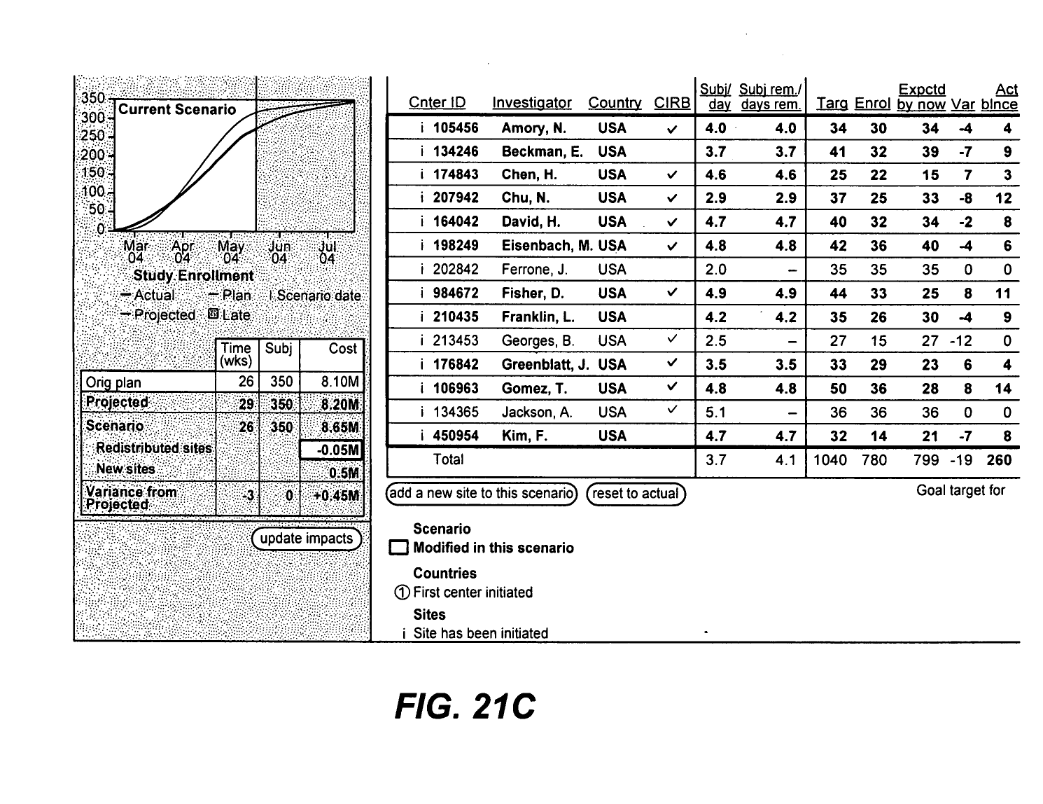

FIG. 21 is a display screen view of an embodiment of a user interface in the system of the present invention. In FIG. 21, the subjects have been redistributed at box 400, 401, 402 and 403 to adjust the subjects downward from a total of 1040 in box 403 in FIG. 20 to 1026 in box 403 of FIG. 21. By changing these enrollment numbers, the system of FIG. 21 is able to display the effect of those changes.

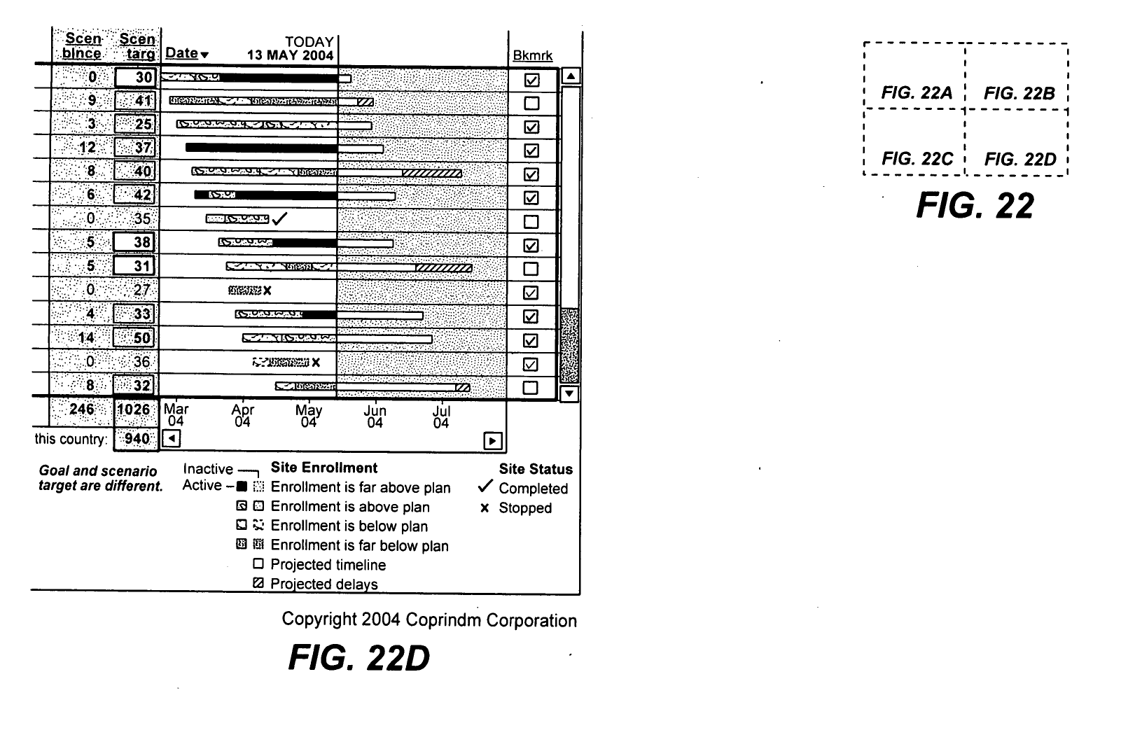

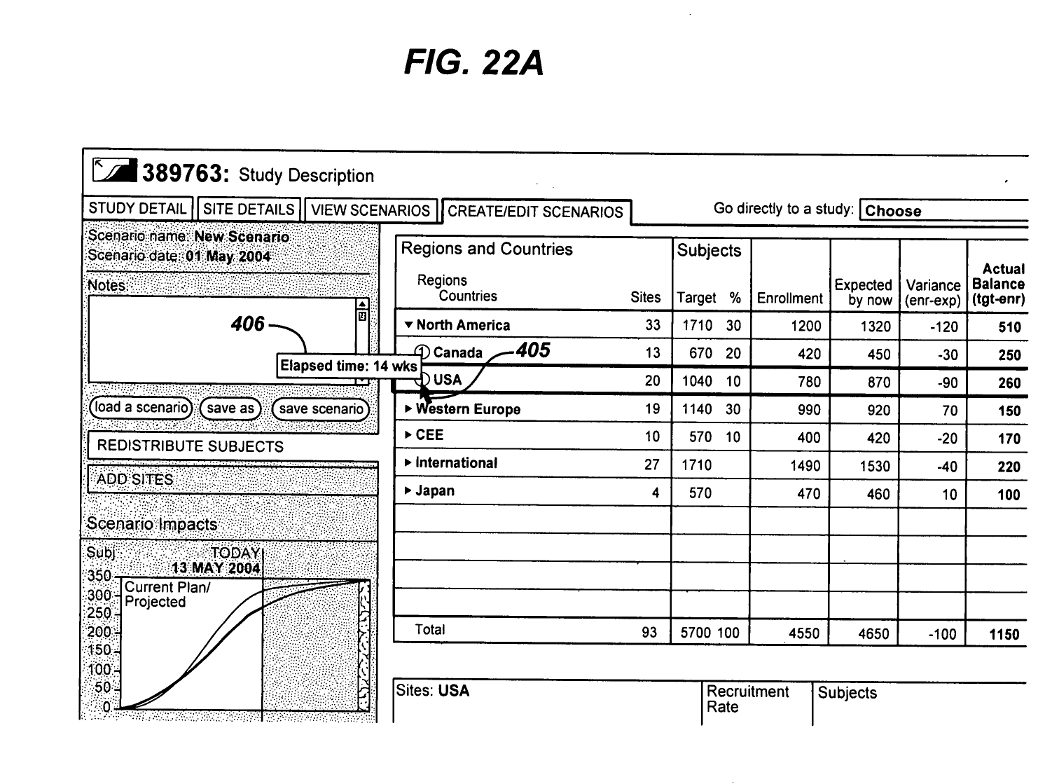

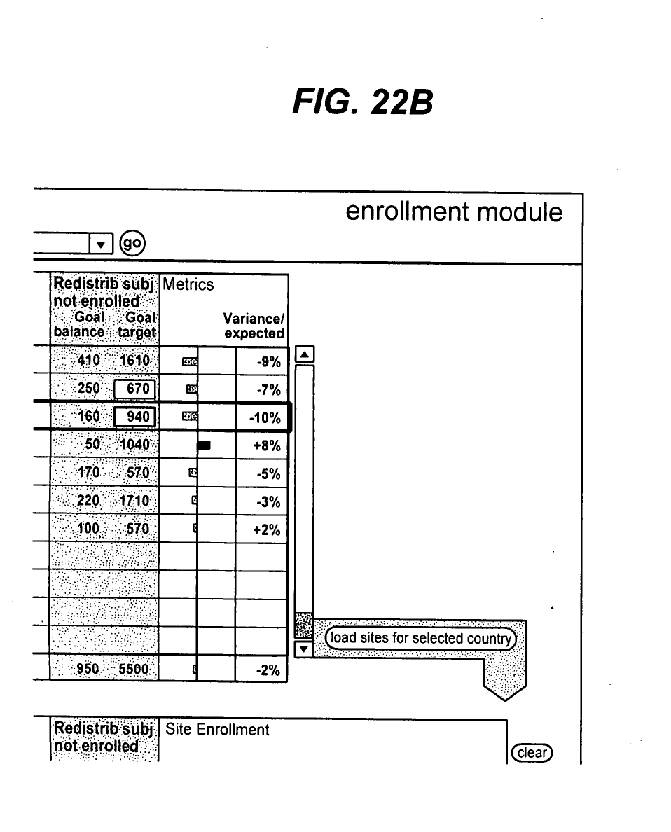

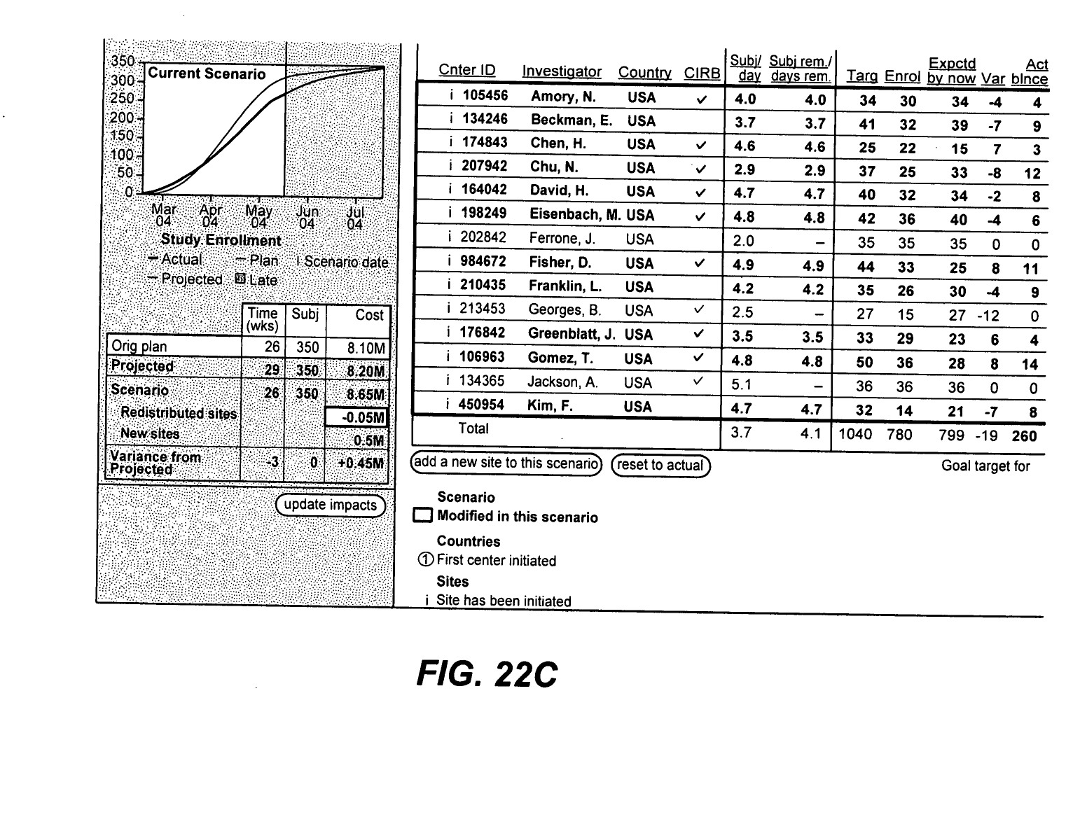

FIG. 22 is a display screen view of an embodiment of a user interface in the system of the present invention. In FIG. 22, the pointer 405 shows the elapsed time of 14 weeks at box 406 to inform the user of the elapsed time of modifying the scenario. The pointer 405 is placed over the region (e.g. USA) and the box 406 appears automatically.

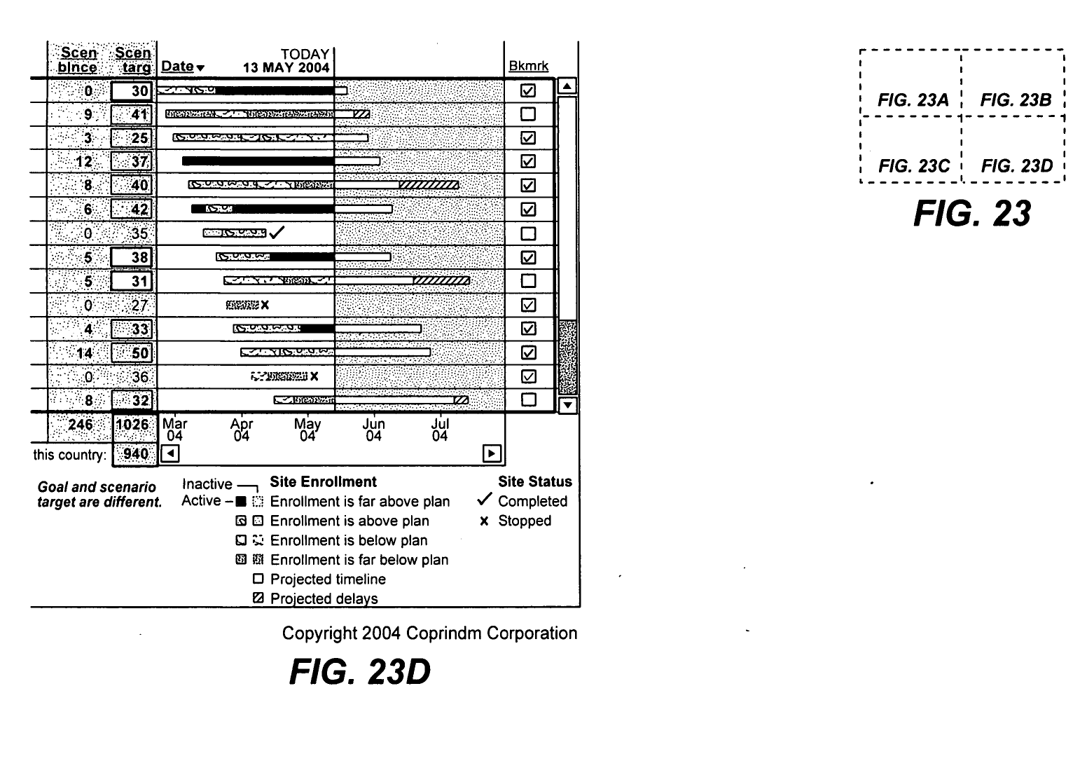

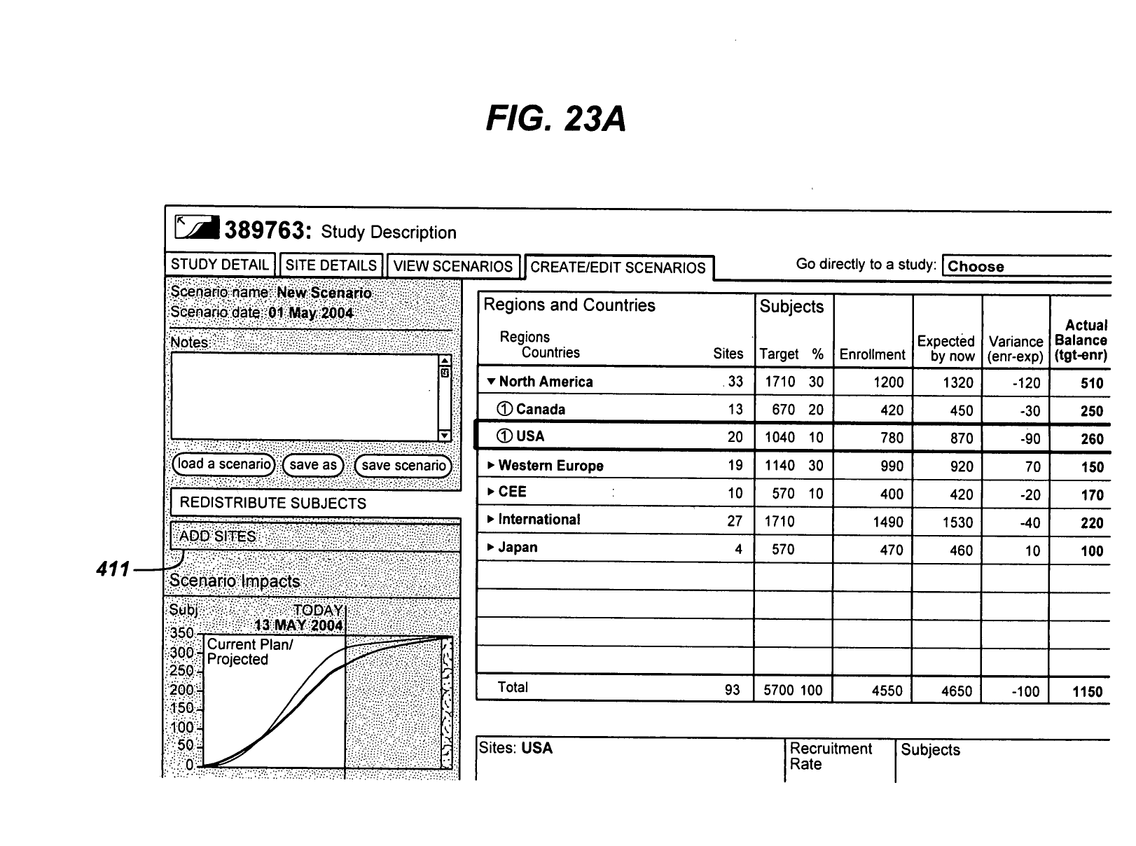

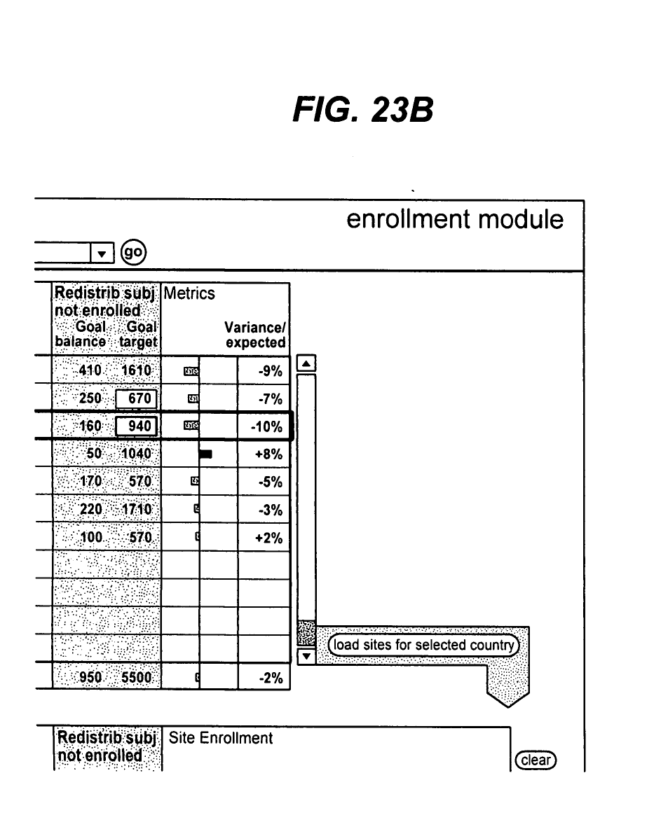

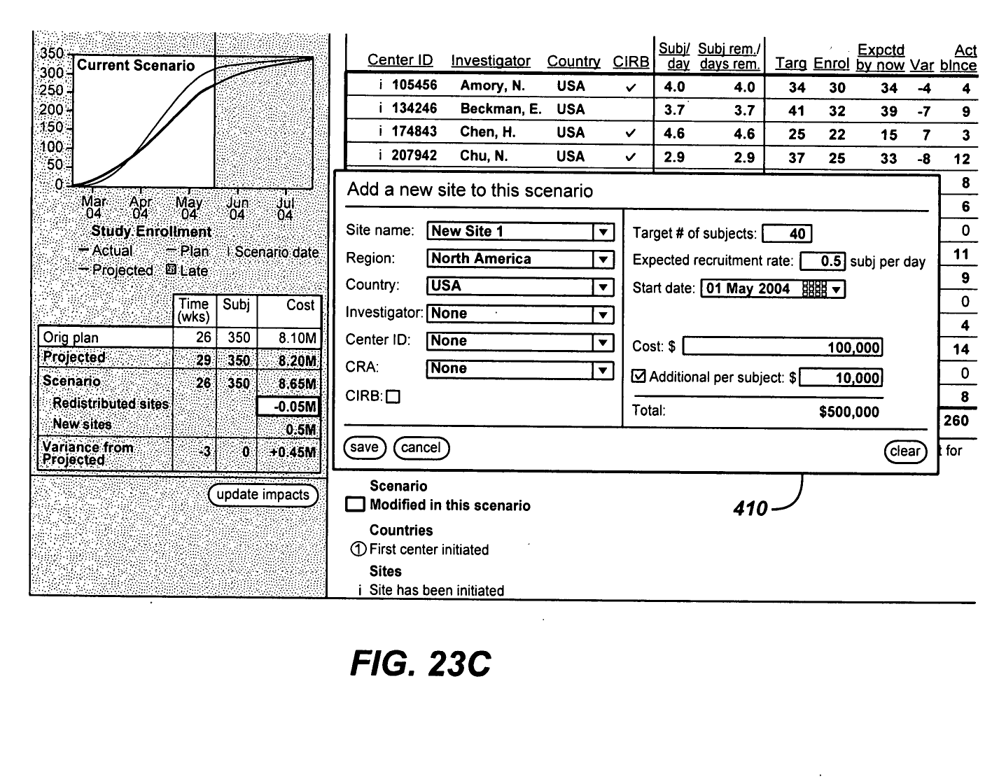

FIG. 23 is a display screen view of an embodiment of a user interface in the system of the present invention. In FIG. 23, a dialog box 410 is displayed in response to pressing the add sites button 411 to add a new site to this scenario. The display 410 permits data to be inputted into the new site of the scenario.

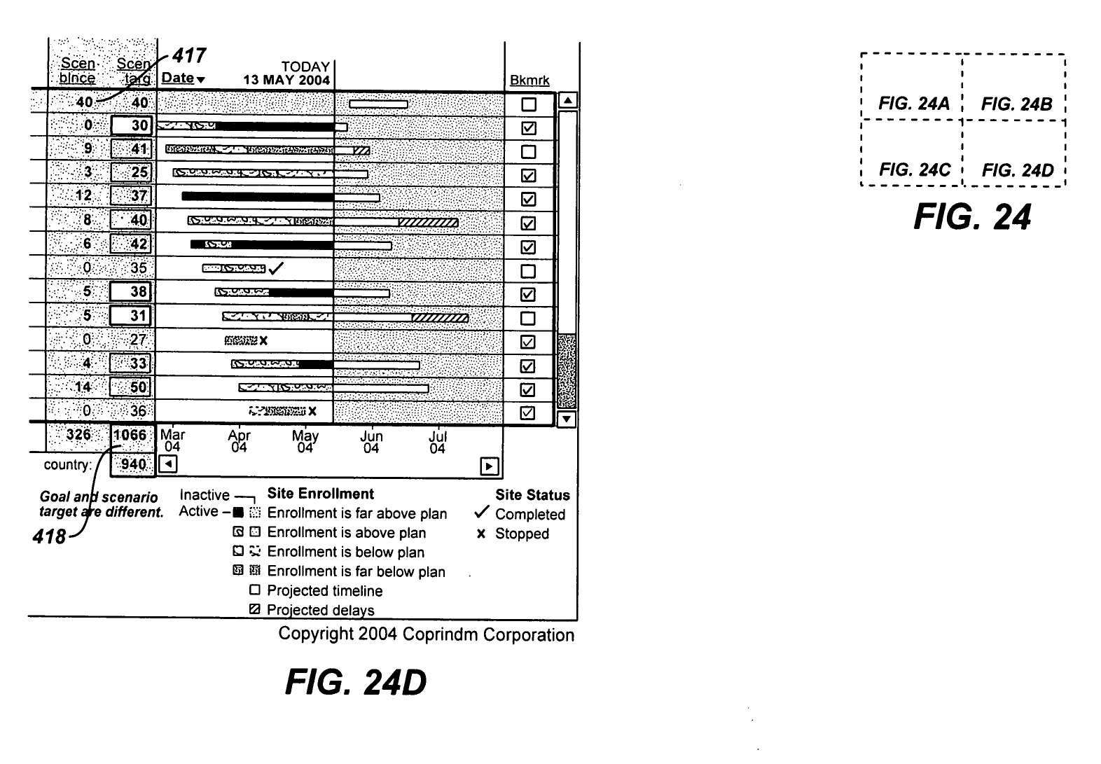

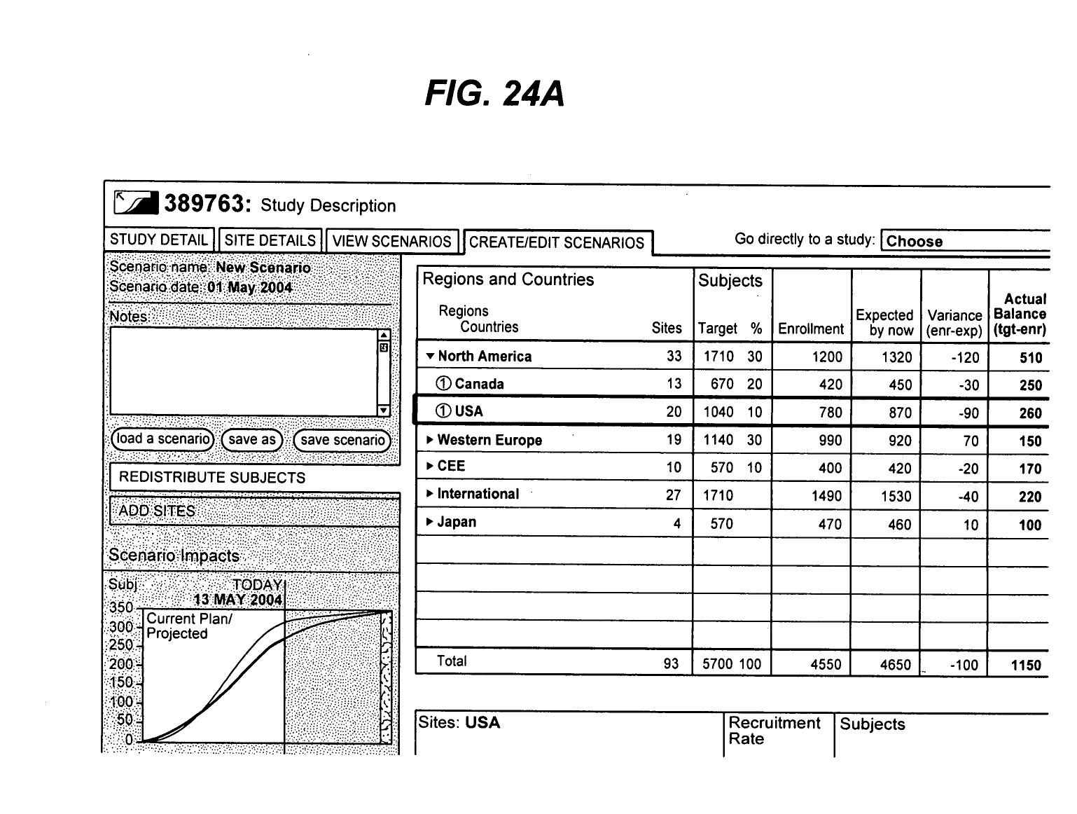

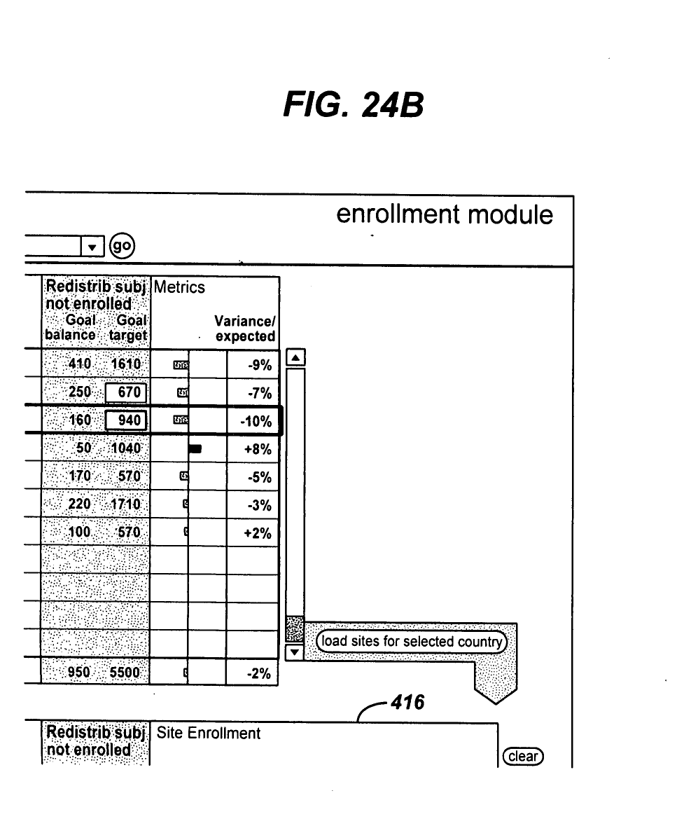

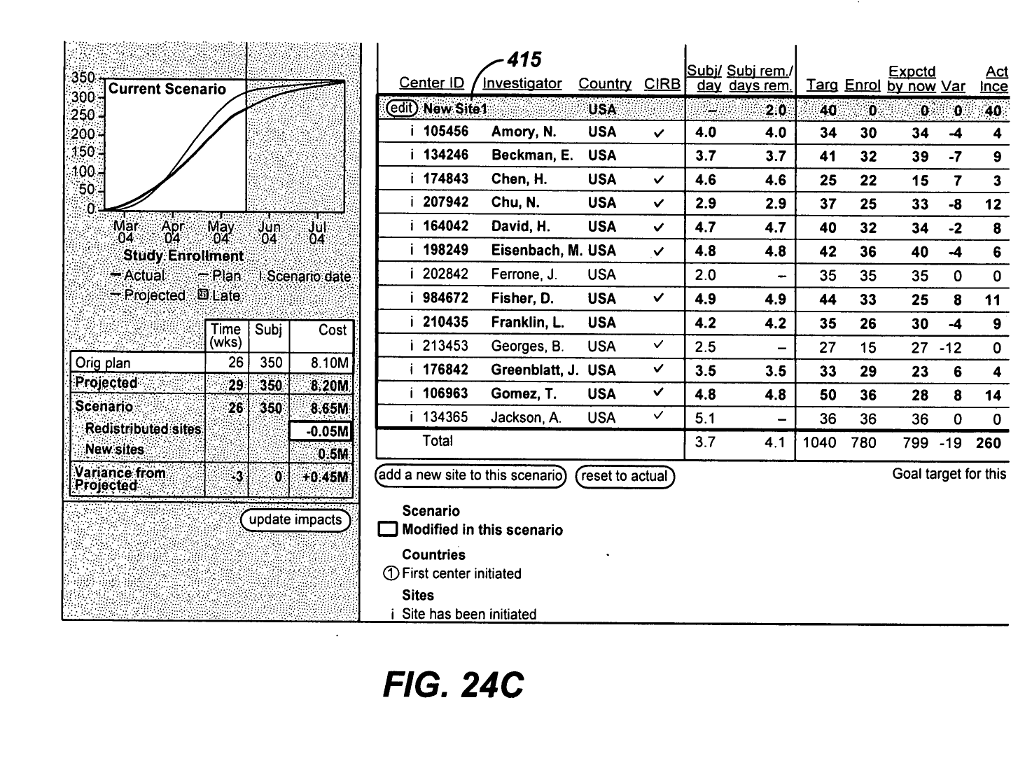

FIG. 24 is a is a display screen view of an embodiment of a user interface in the system of the present invention. In FIG. 24, the new site 415 has been added to the site display screen 416 to model the effect of adding the new site into the system. As shown, a total balance of 40 new subjects have been added at 417 raising the total number to 1066 subjects at 418.

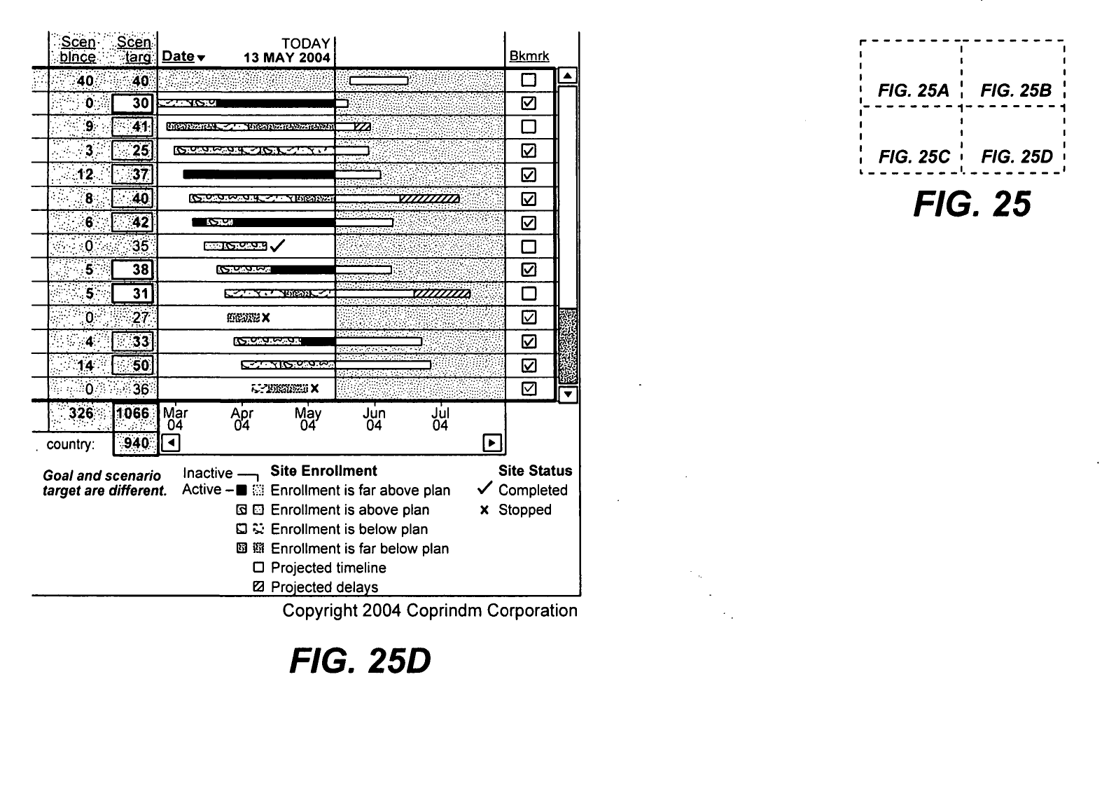

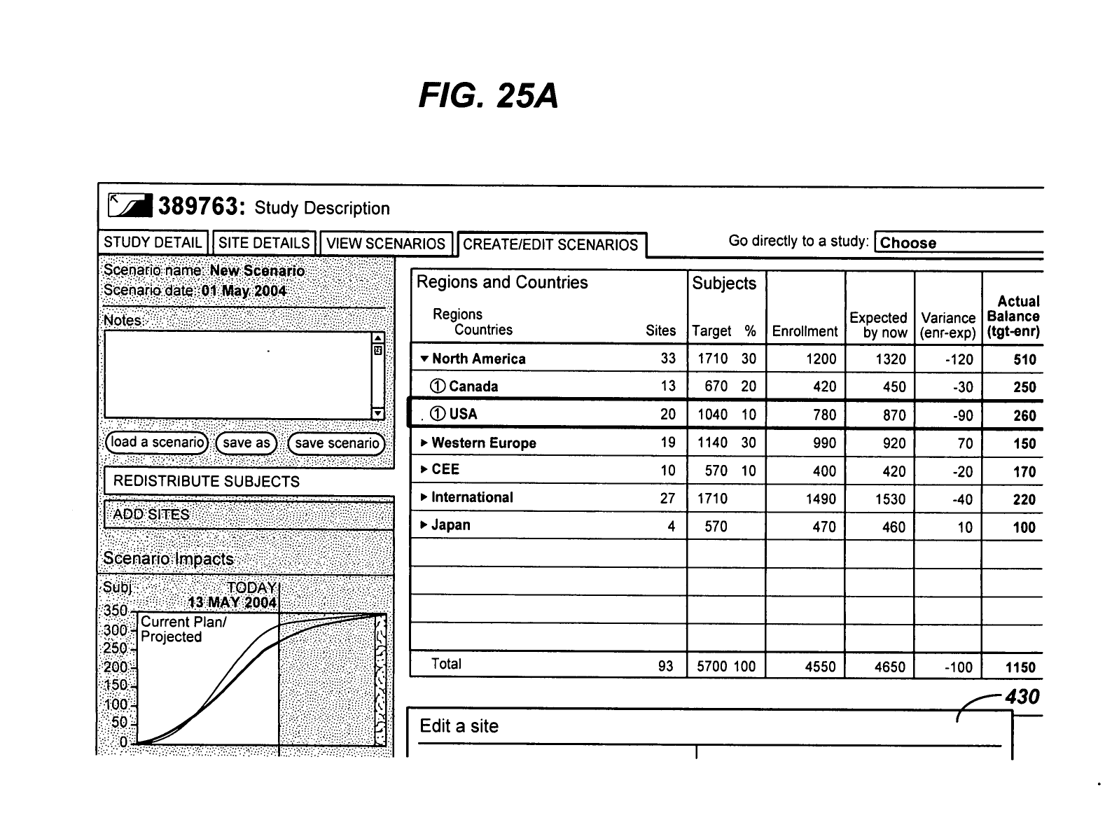

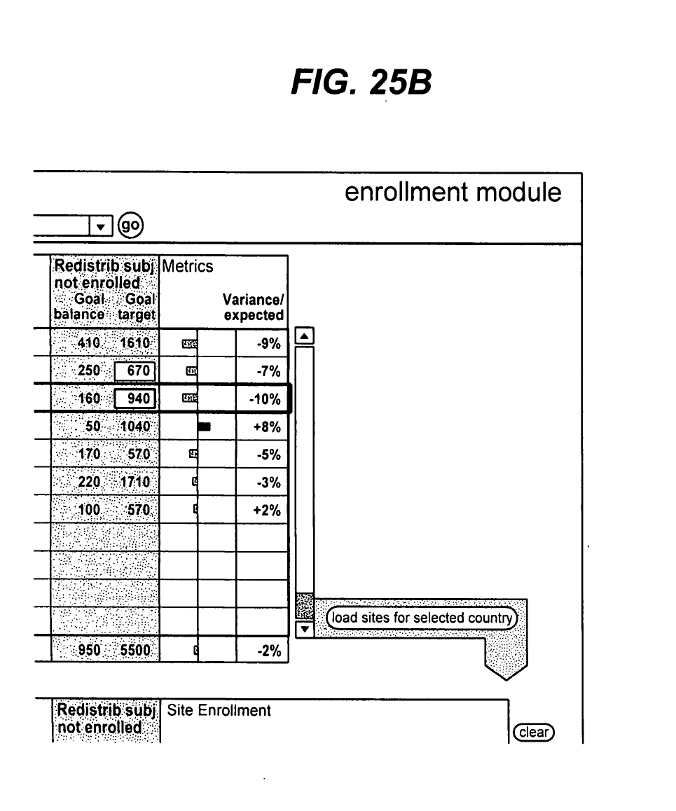

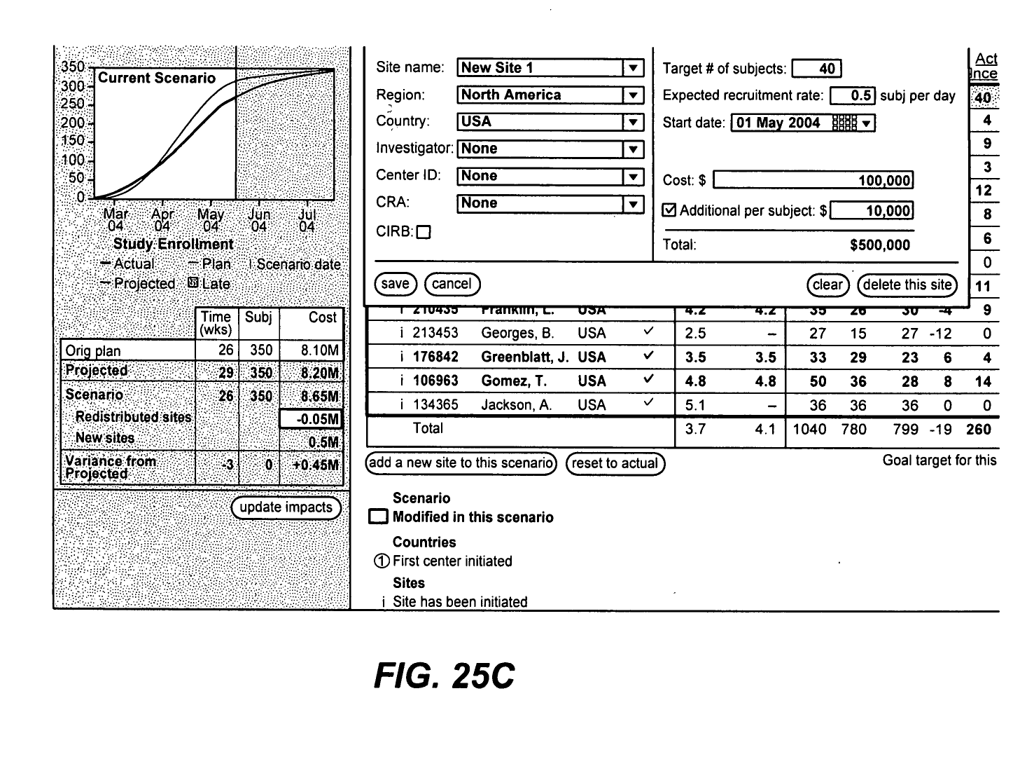

FIG. 25 is a display screen view of an embodiment of a user interface in the system of the present invention. In FIG. 25, an edit site screen 430 is displayed that allows the previous new site “1” to be edited. As is shown in the edit site box 430, all the parameters may be changed in this edit site box 430.

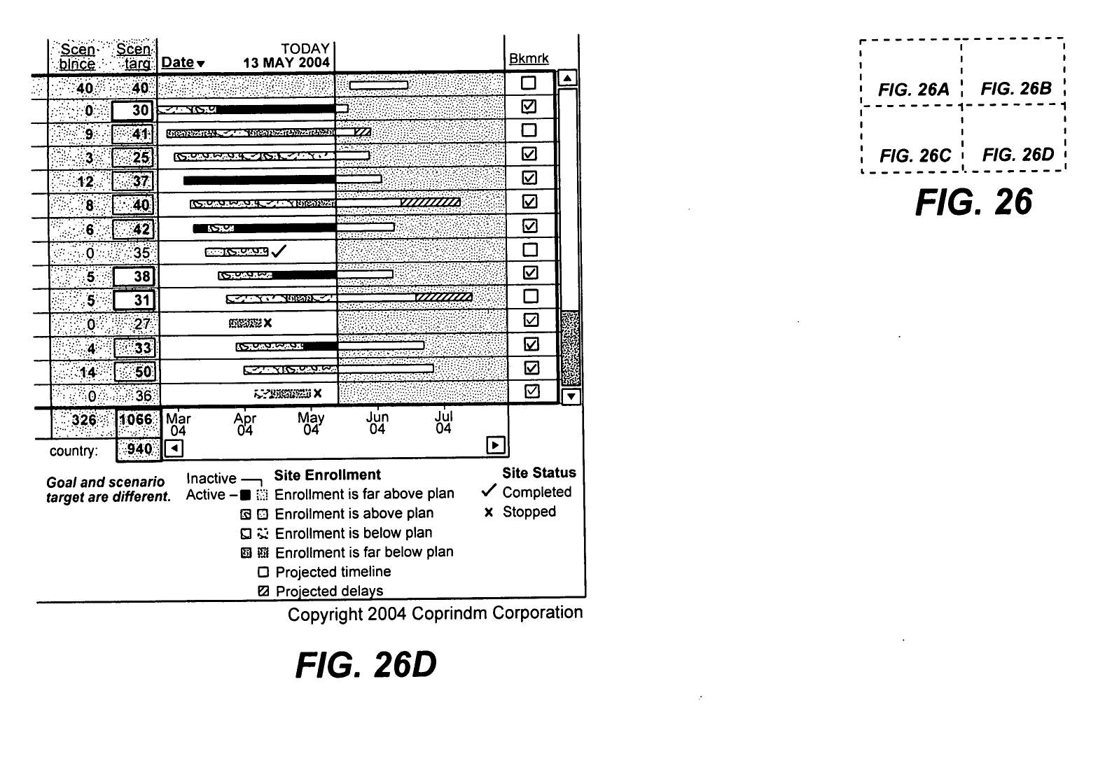

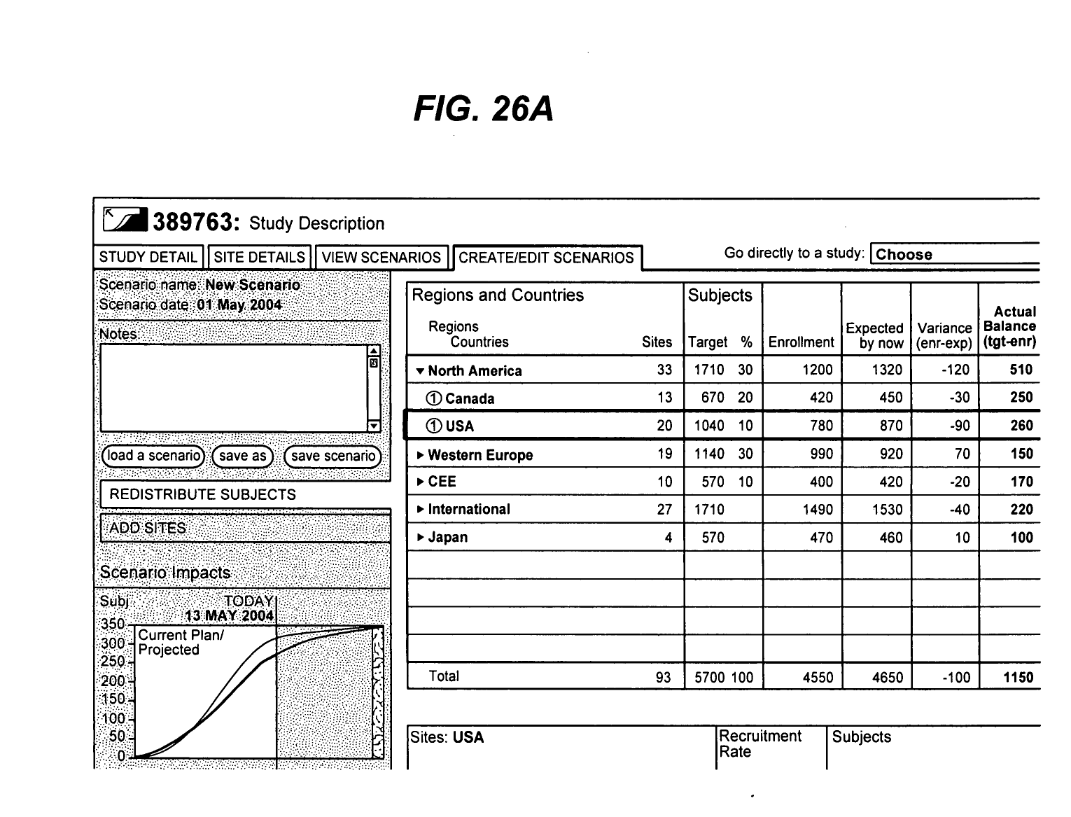

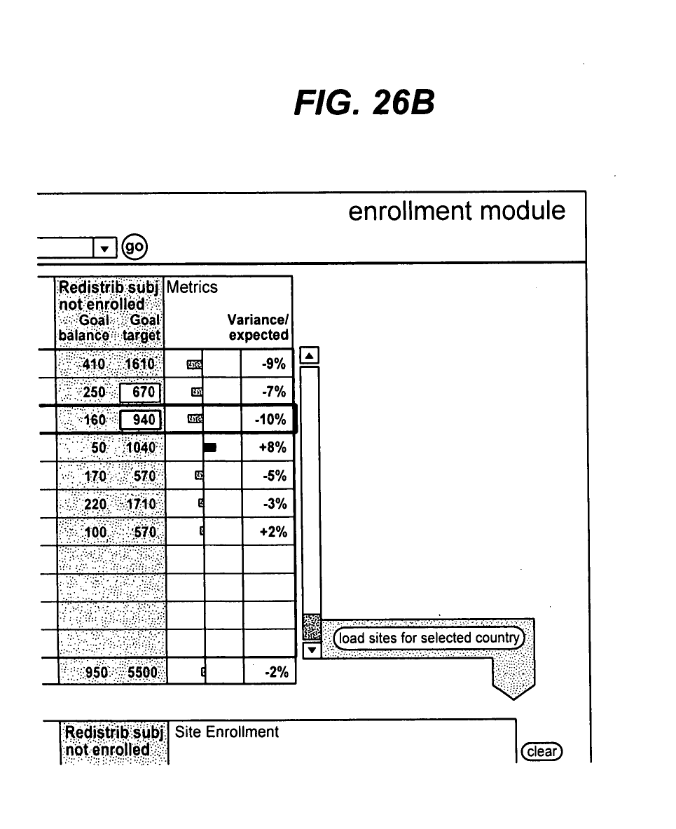

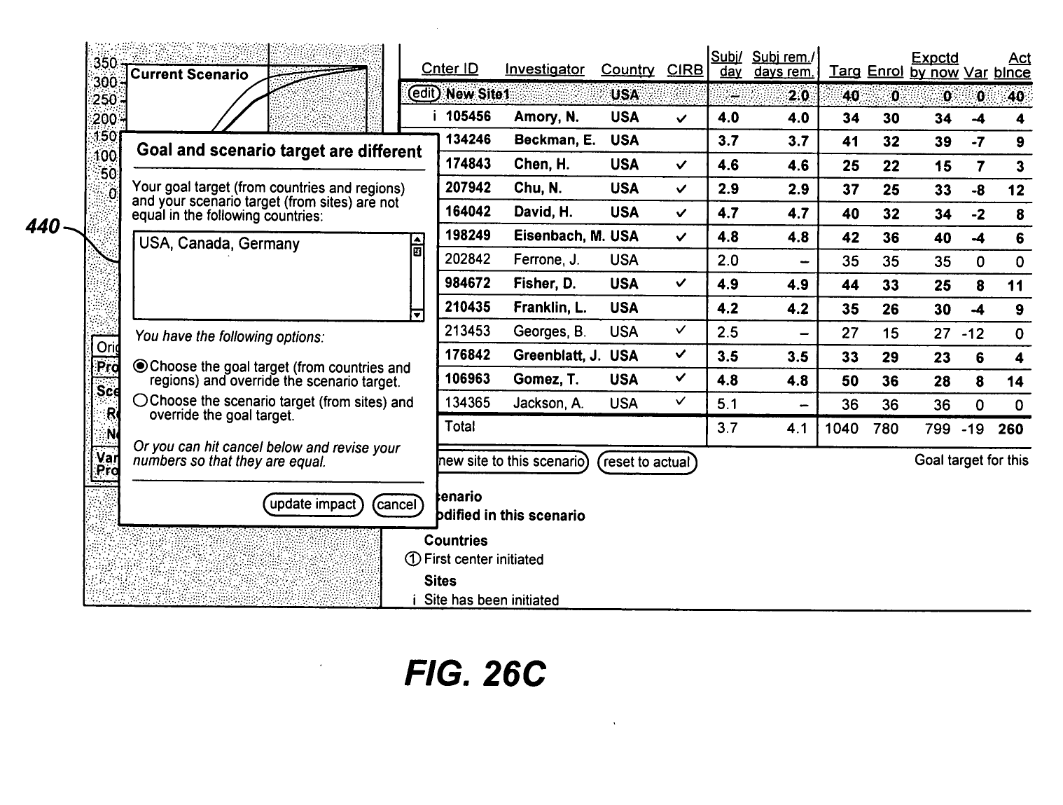

FIG. 26 is a display screen view of an embodiment of a user interface in the system of the present invention. In FIG. 26, an alert box 440 informs the user that the goal and scenario target are different and provides a number of options to the user. One option is for the user to choose the goal target (from countries and regions) and override the scenario target. Or the other option is for the user to choose a scenario target (from sites) and override the goal target. Alternatively, the user may cancel and revise the numbers so that they are equal. This alert box 440 provides an additional check for the user to ensure that the scenarios reaches a same goal and target.

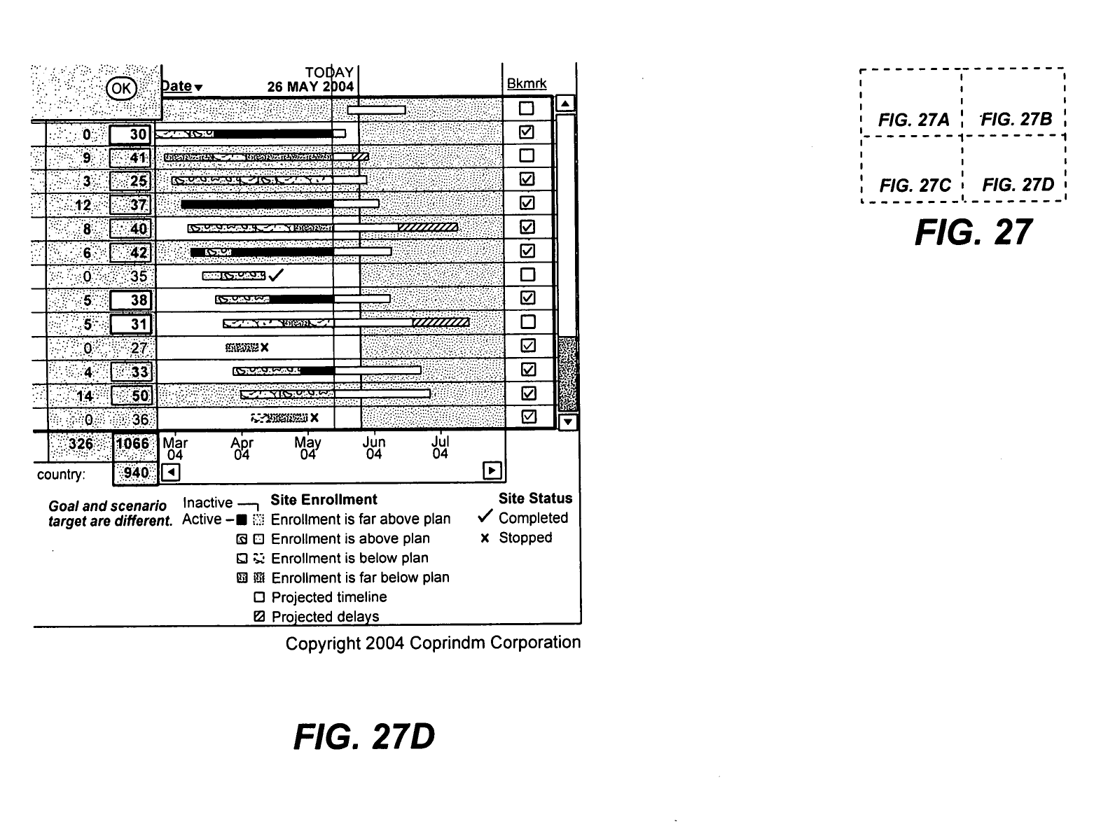

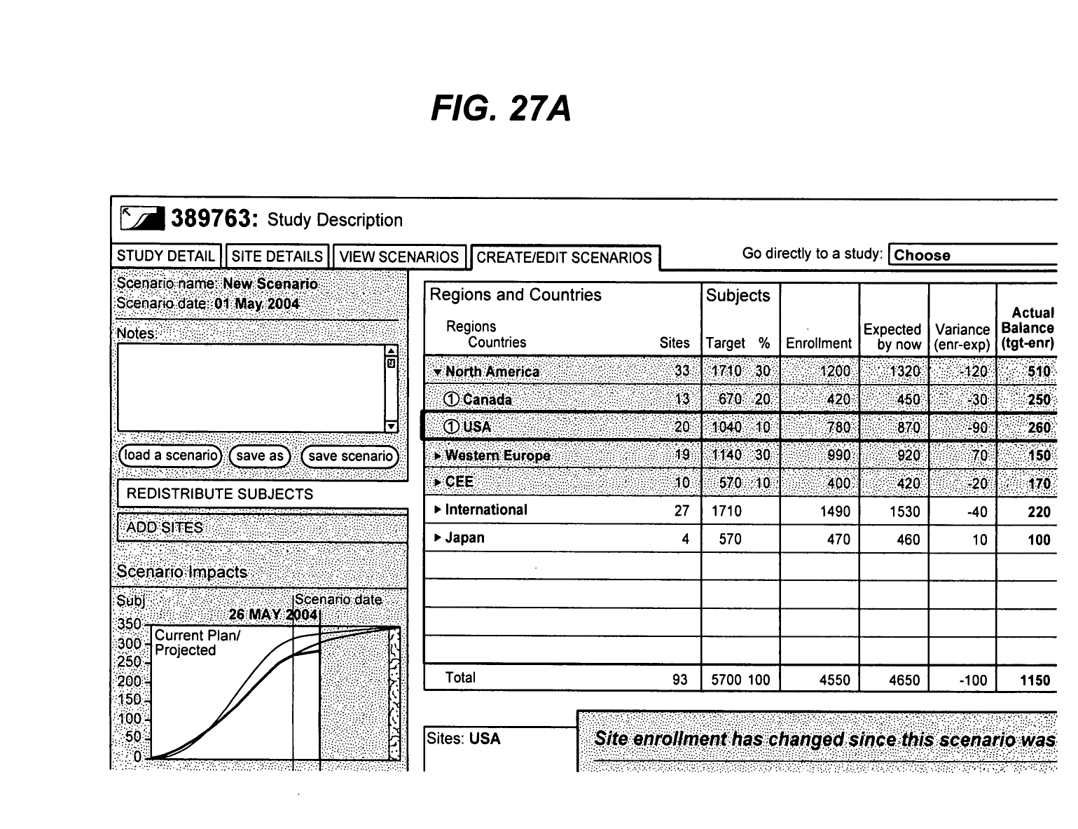

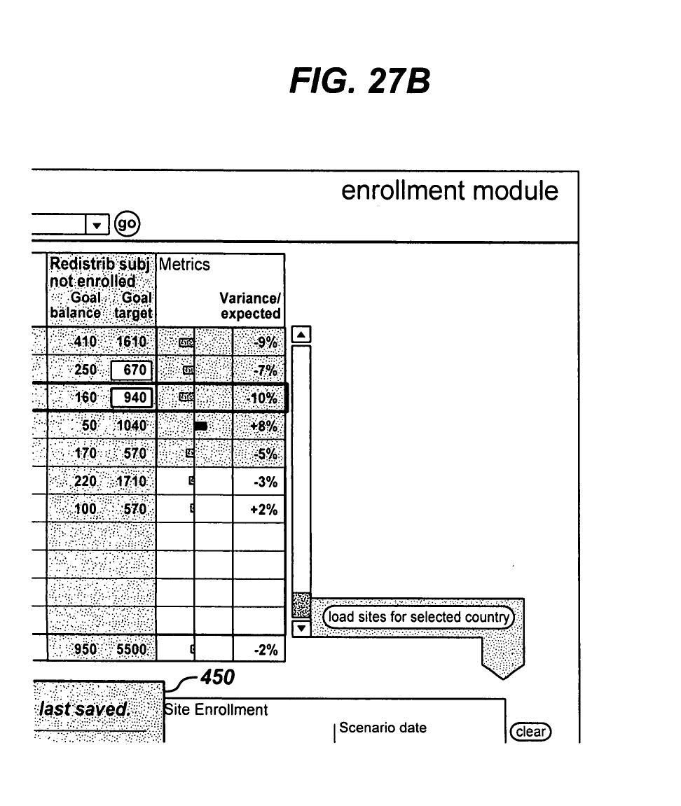

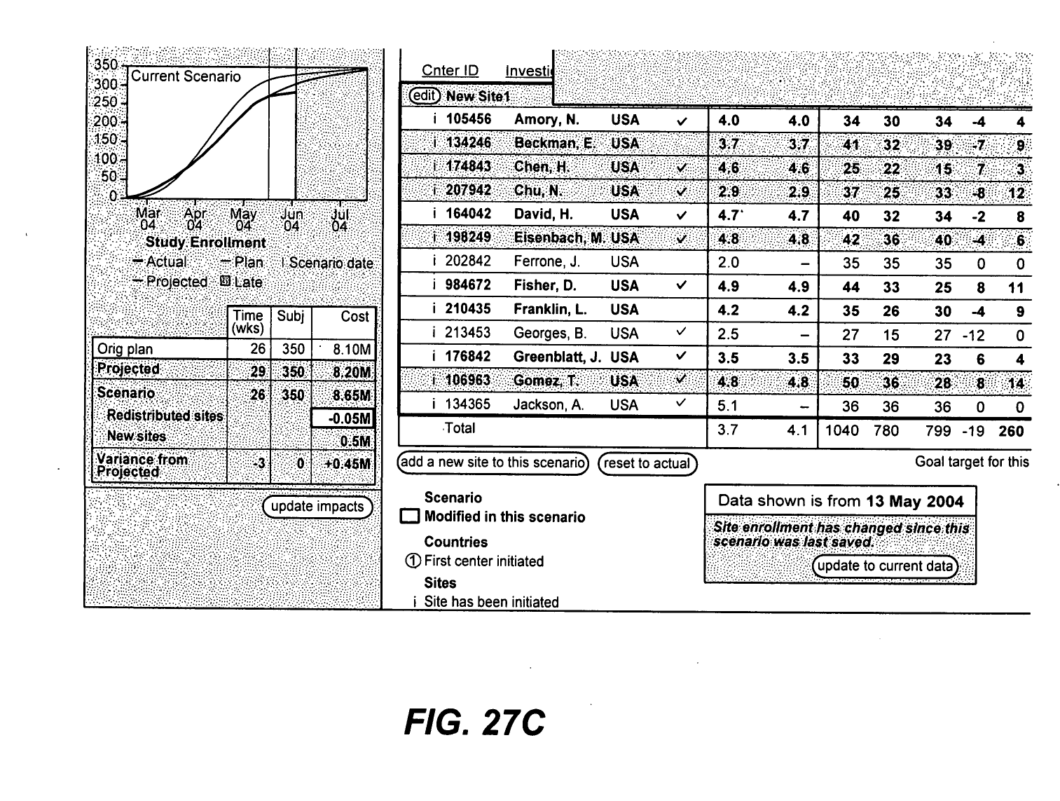

FIG. 27 is a display screen view of an embodiment of a user interface in the system of the present invention. In FIG. 27, the user is informed by box 450 that the site enrollment has changed since the scenario was last saved. In this way, the user sees the most up to date site enrollment numbers even though the scenario may be saved and later reviewed.

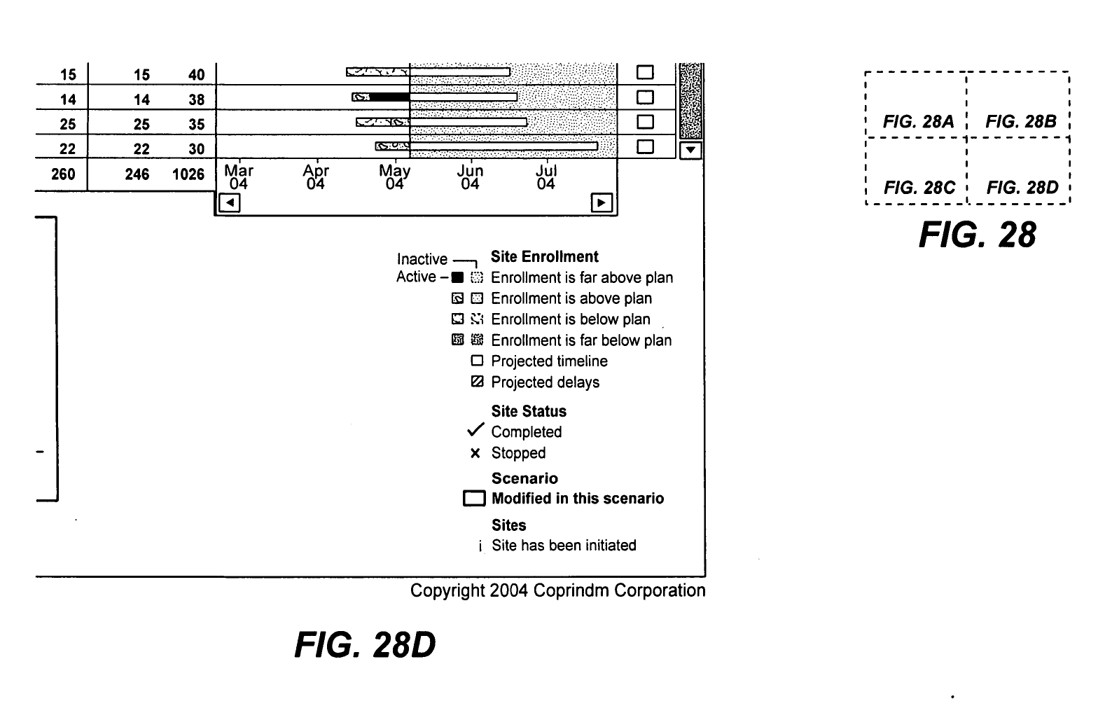

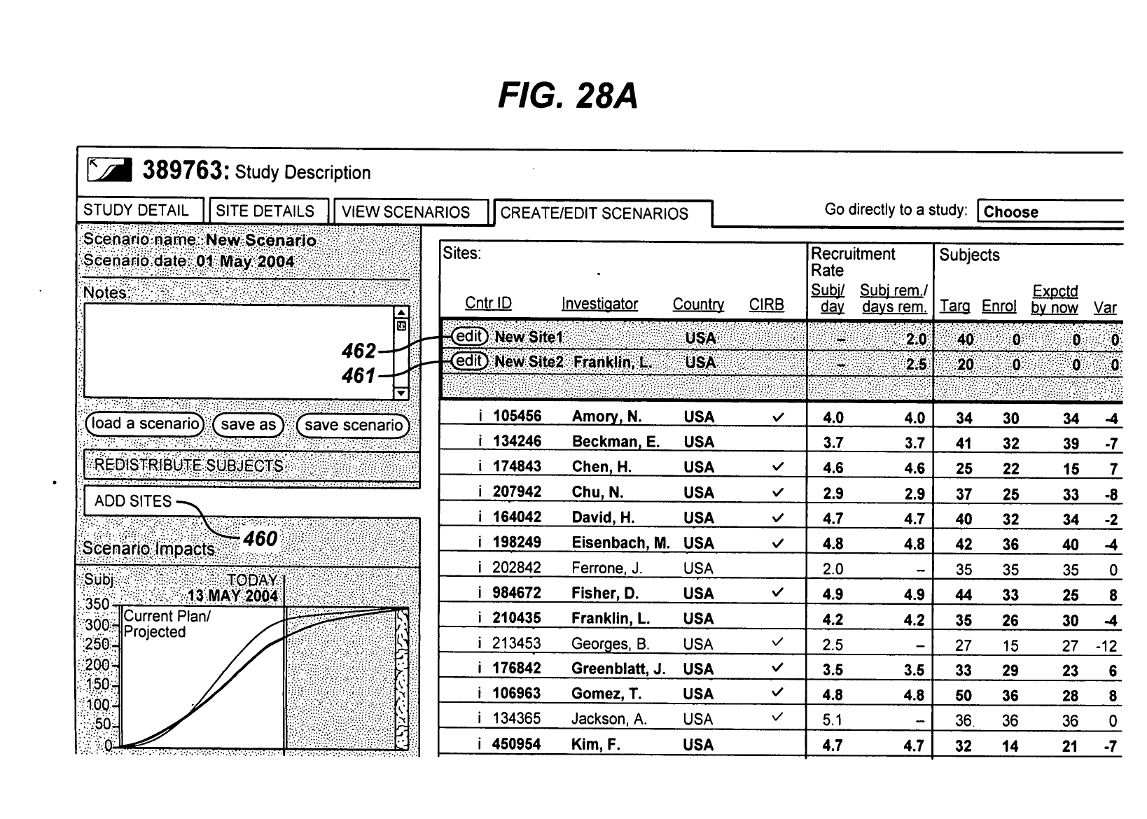

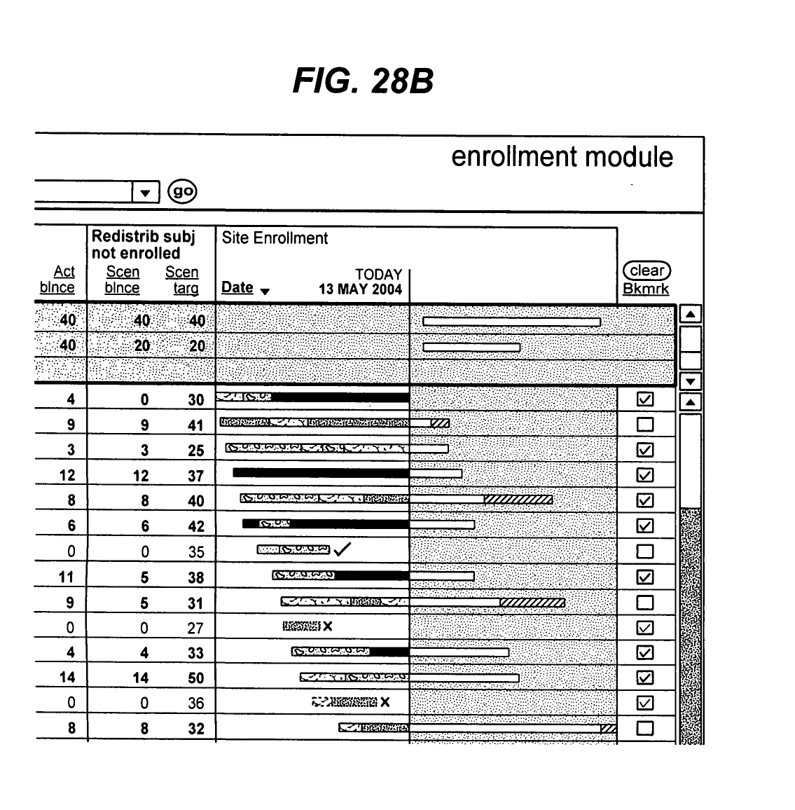

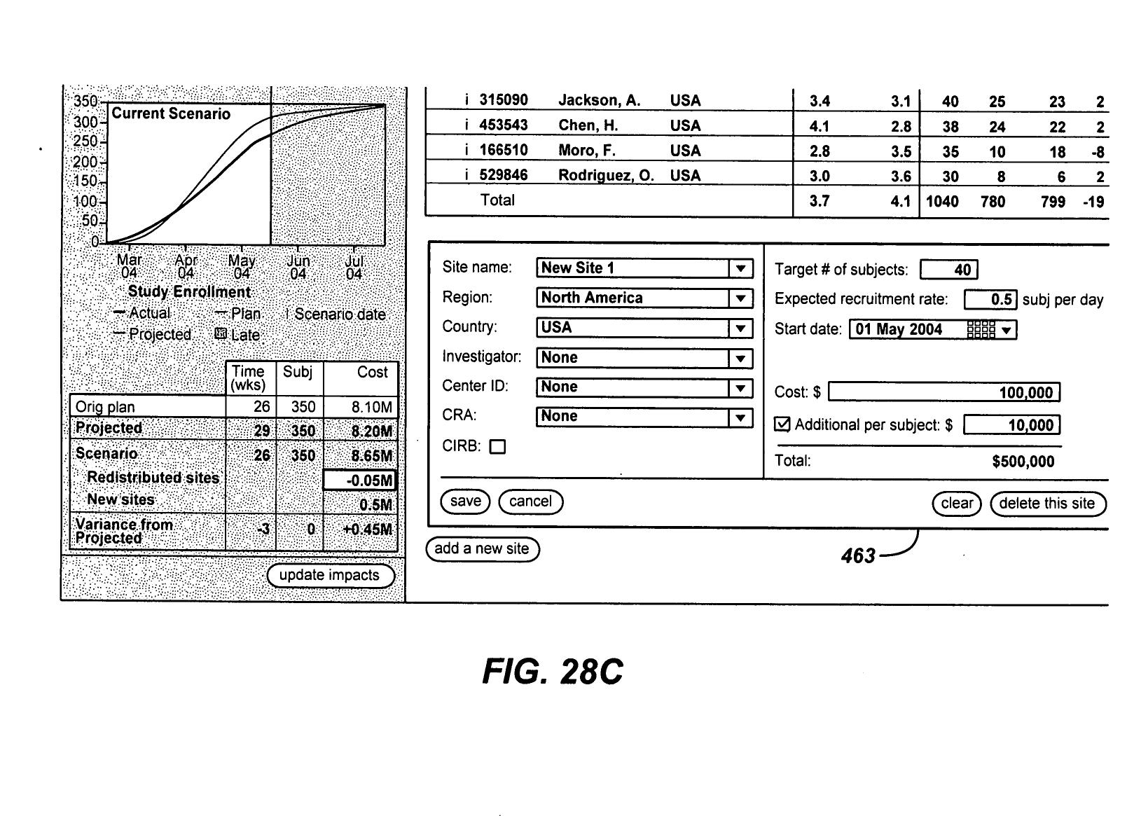

FIG. 28 is a display screen view of an embodiment of a user interface in the system of the present invention. In FIG. 28, the add site scenario has been pressed at 460 allowing a new site 2 461 and a new site 1 462 to be edited. The new site box 463 has been provided as shown before to edit the parameters of new site 1.

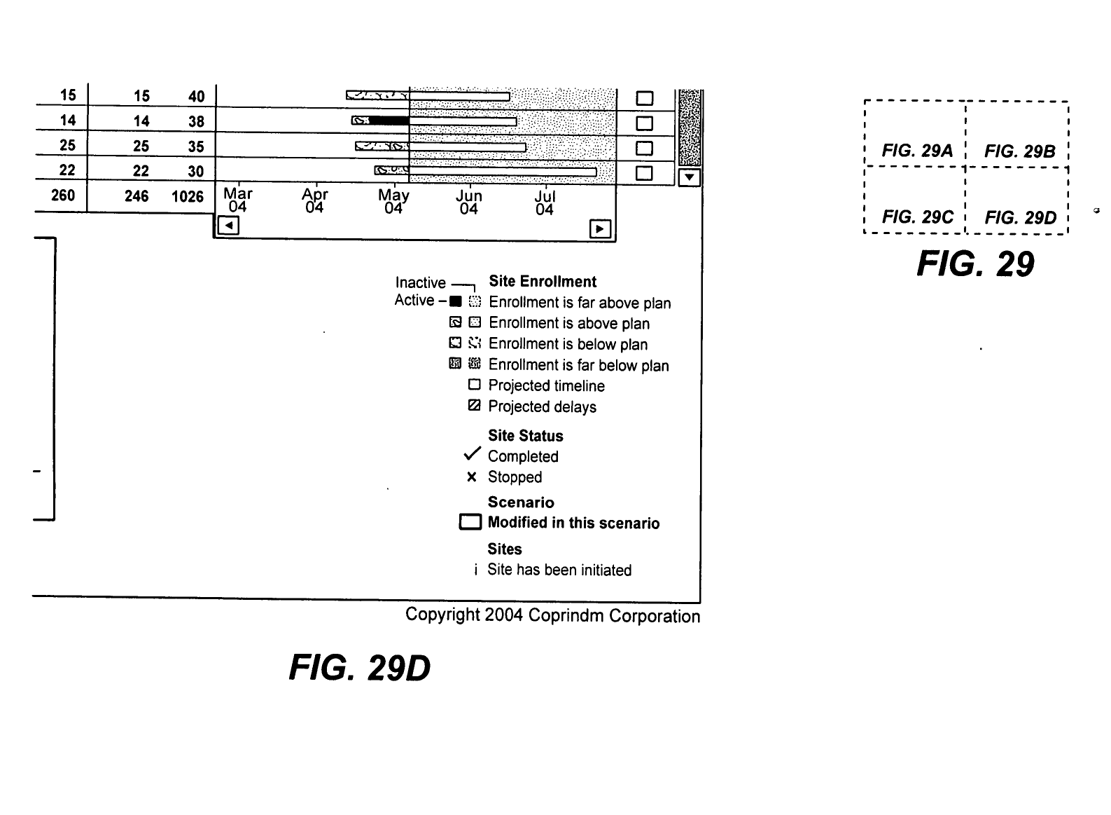

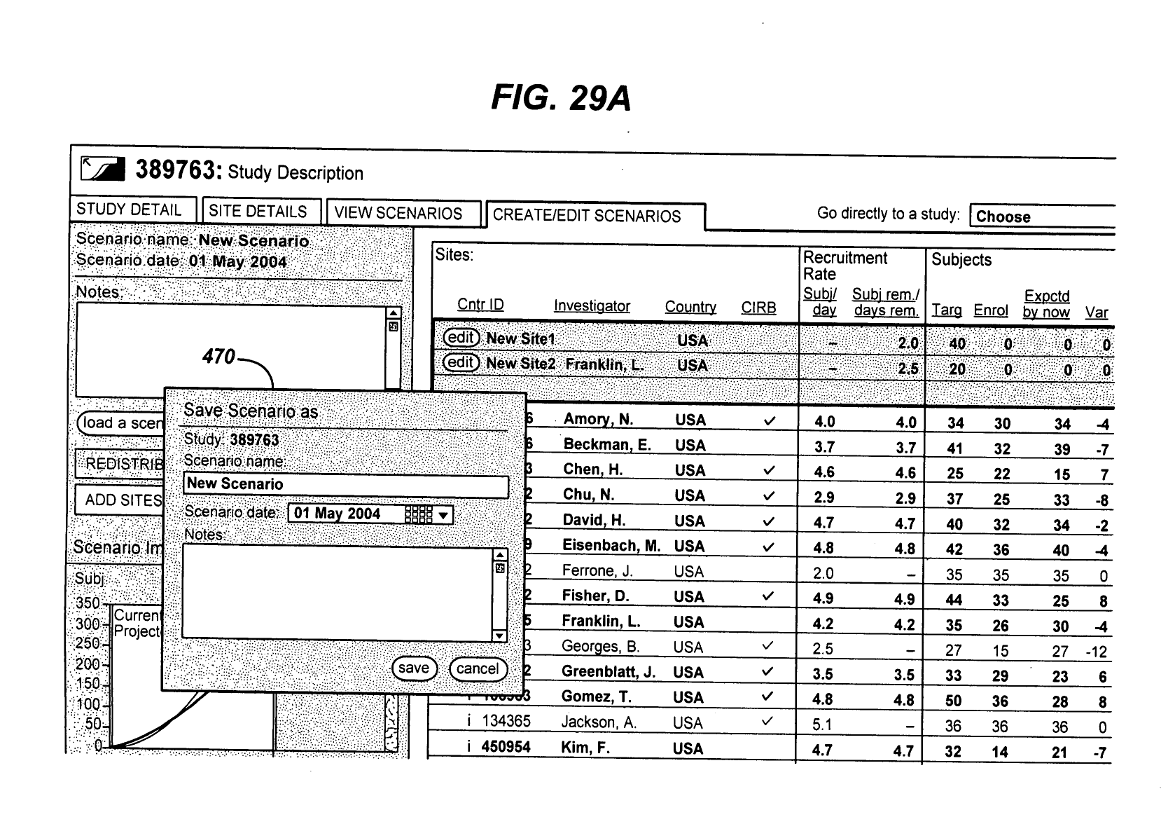

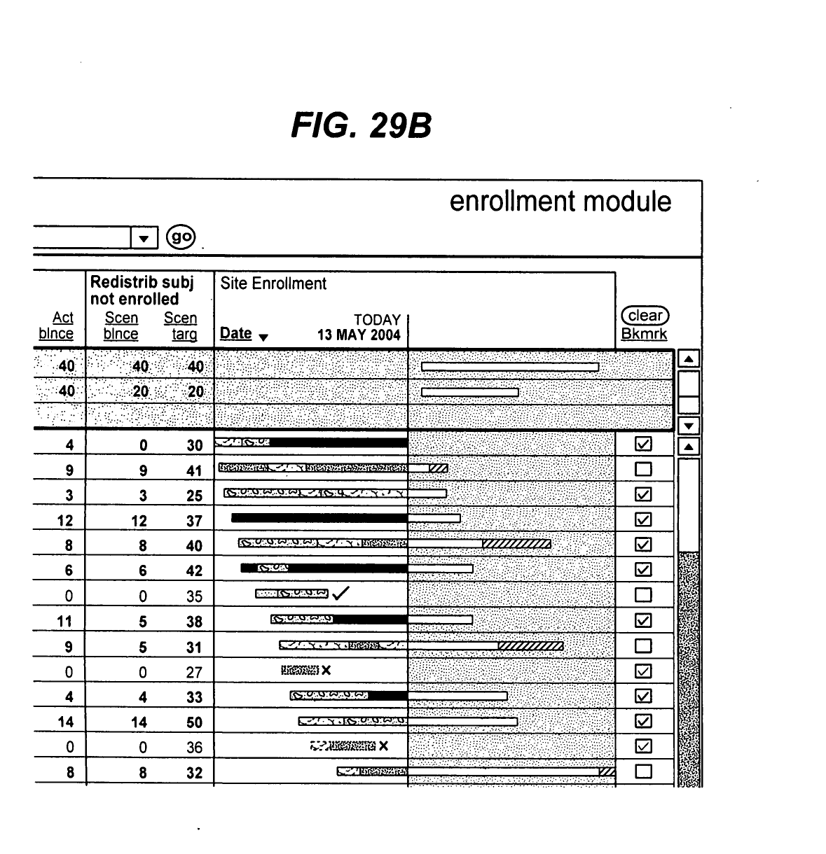

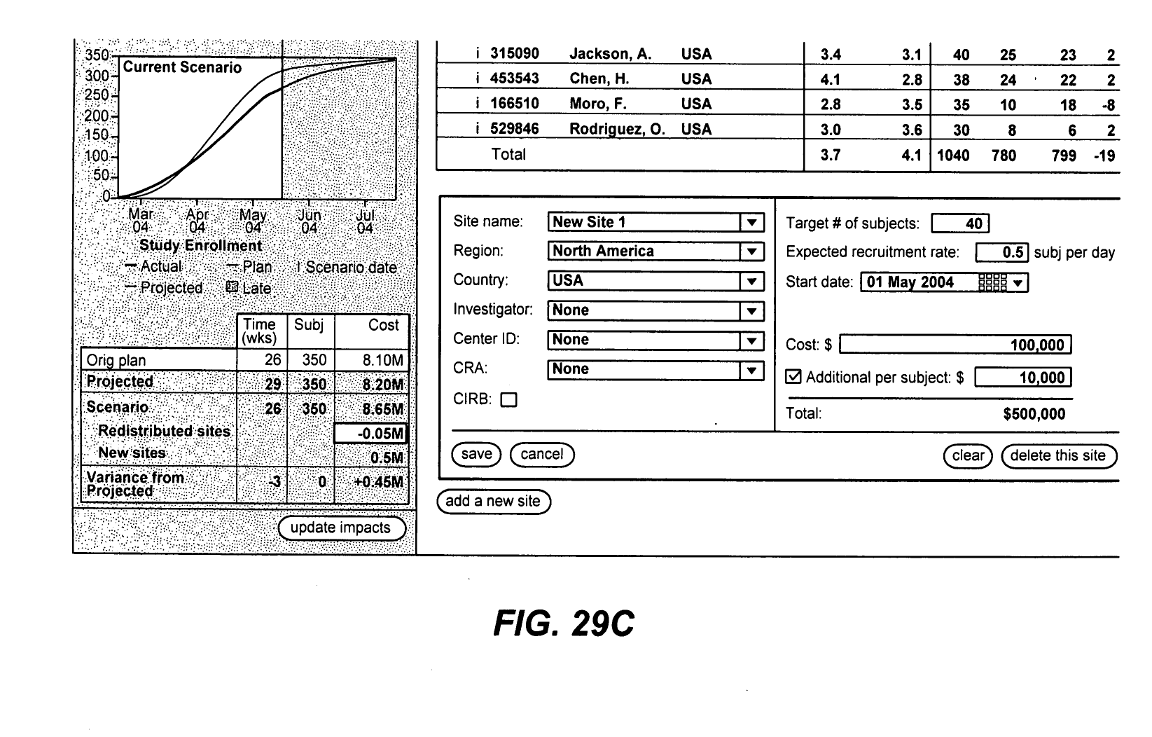

FIG. 29 is a display screen view of an embodiment of a user interface in the system of the present invention. In FIG. 29, save scenario box 470 is shown to save the new scenario for future use.

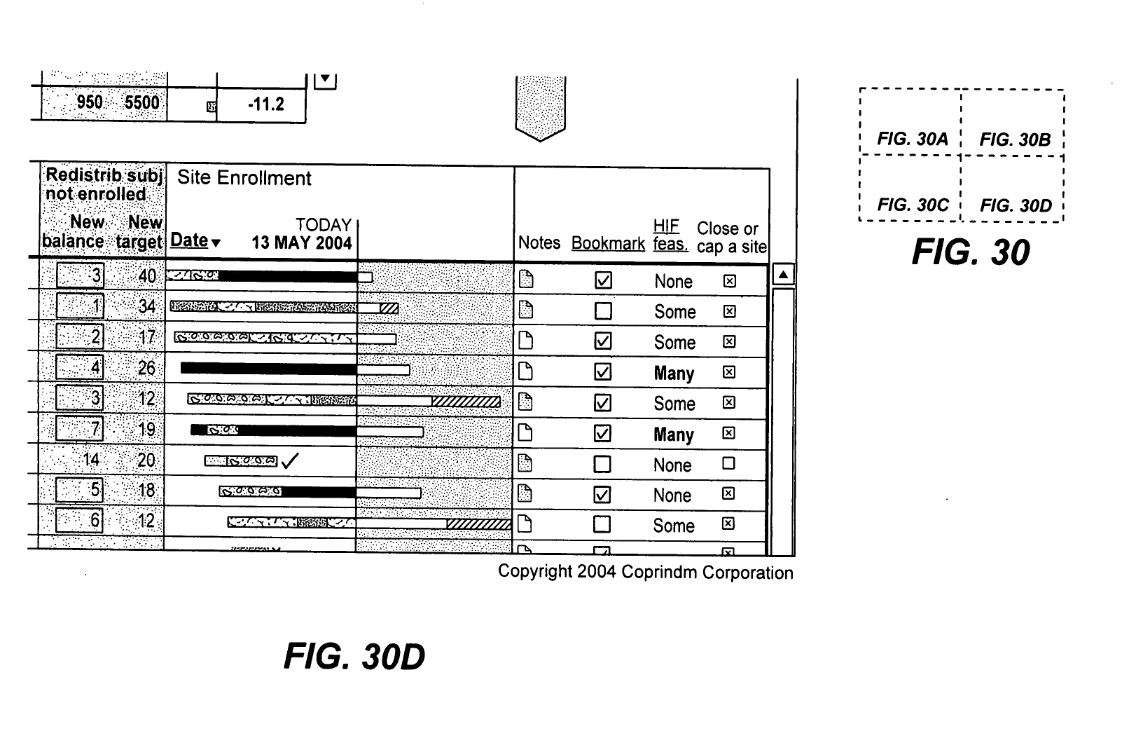

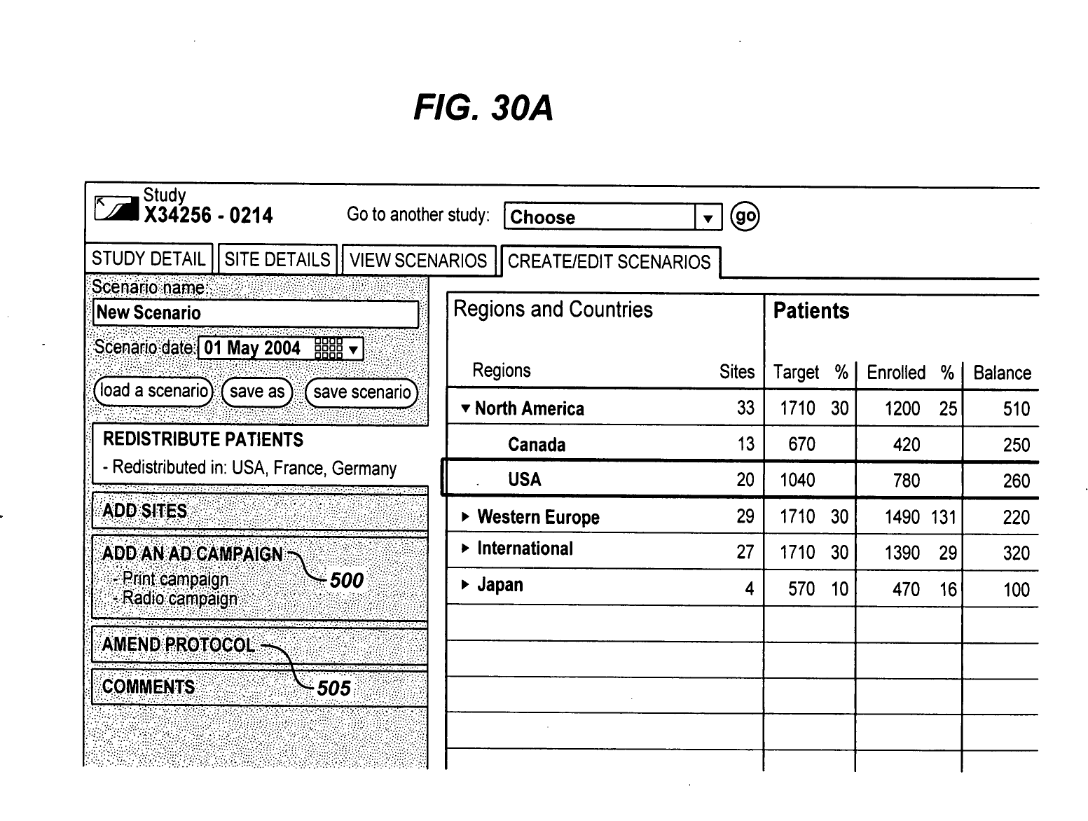

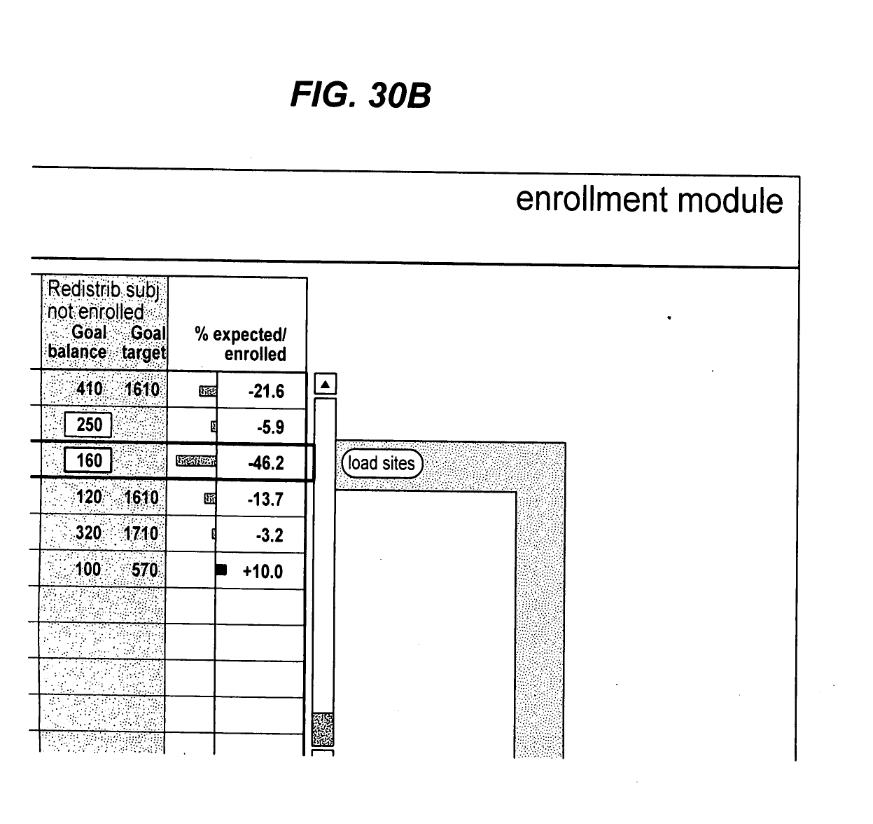

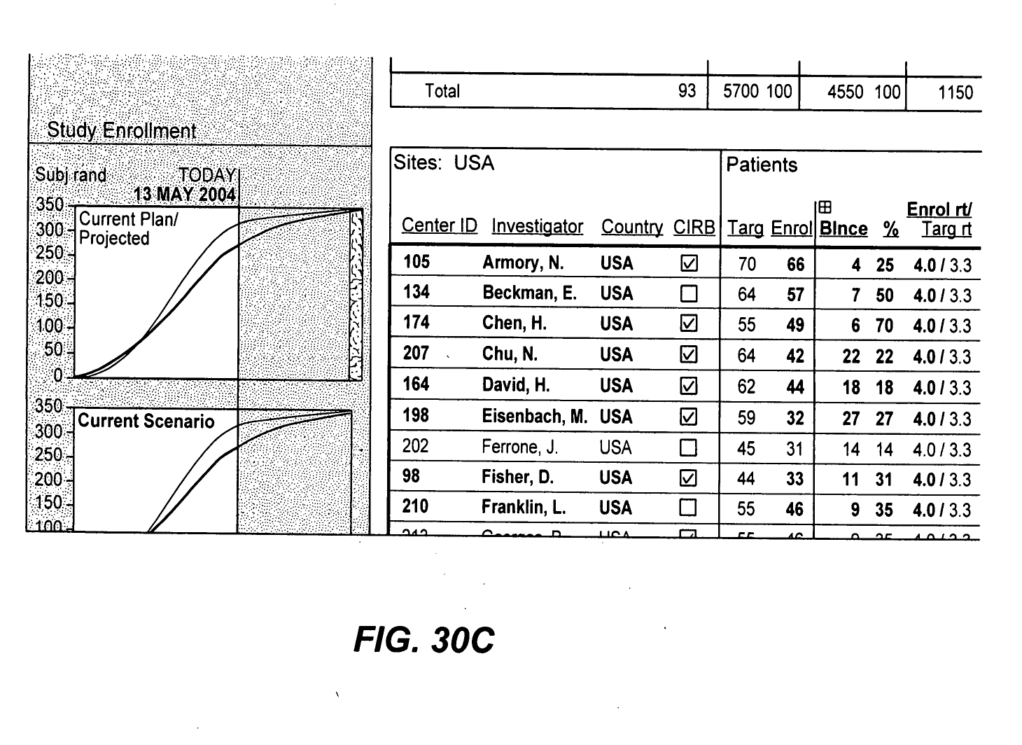

FIG. 30 is a display screen view of an embodiment of a user interface in the system of the present invention. In FIG. 30, two additional scenarios are shown including an advertising campaign scenario 500 and an amend protocol scenario 505. The advertising campaign scenario is used to model the effect on the clinical trials of adding more advertising campaigns for additional patients/subjects to the clinical trials. The protocol amendment scenario 505 allows the system to model the effect on the clinical trials of changing a protocol of the clinical trials. These parameter changes can include changes to the enrollment of subjects or changes on time or changes on budget to determine how these changes effect the ongoing clinical trials.

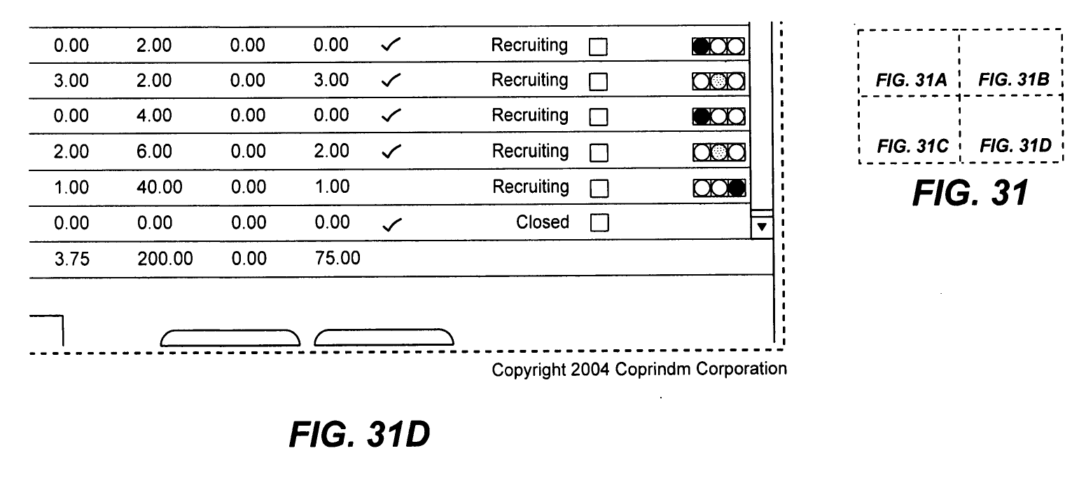

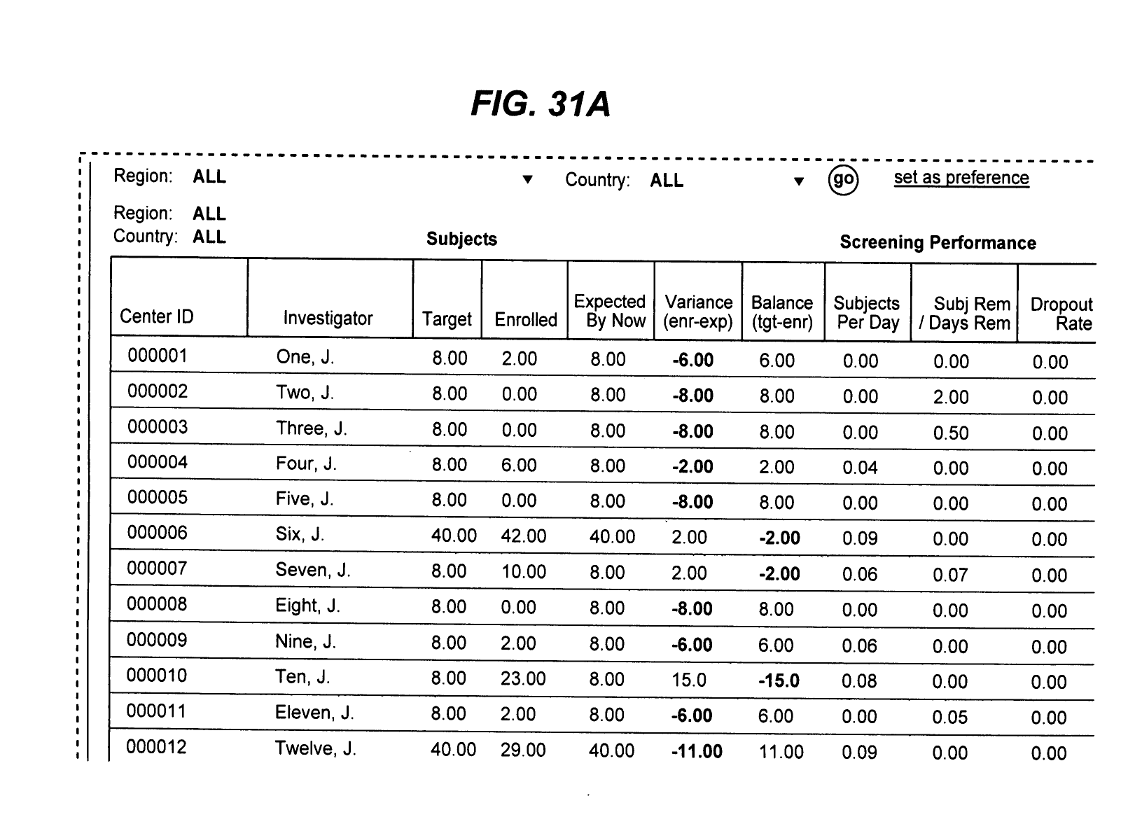

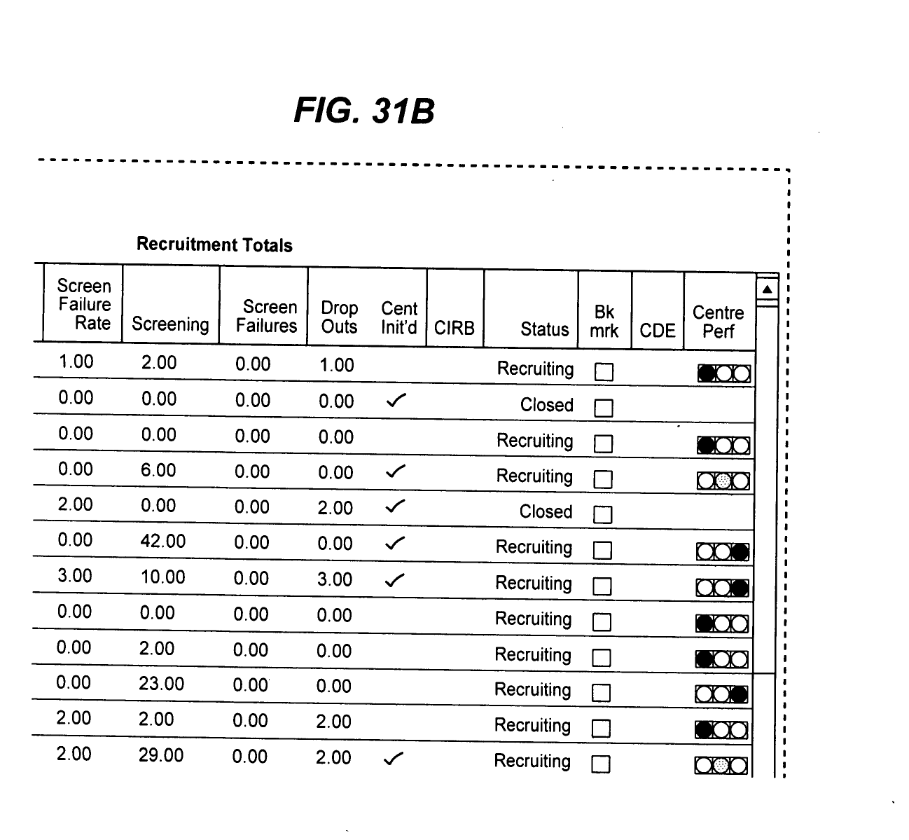

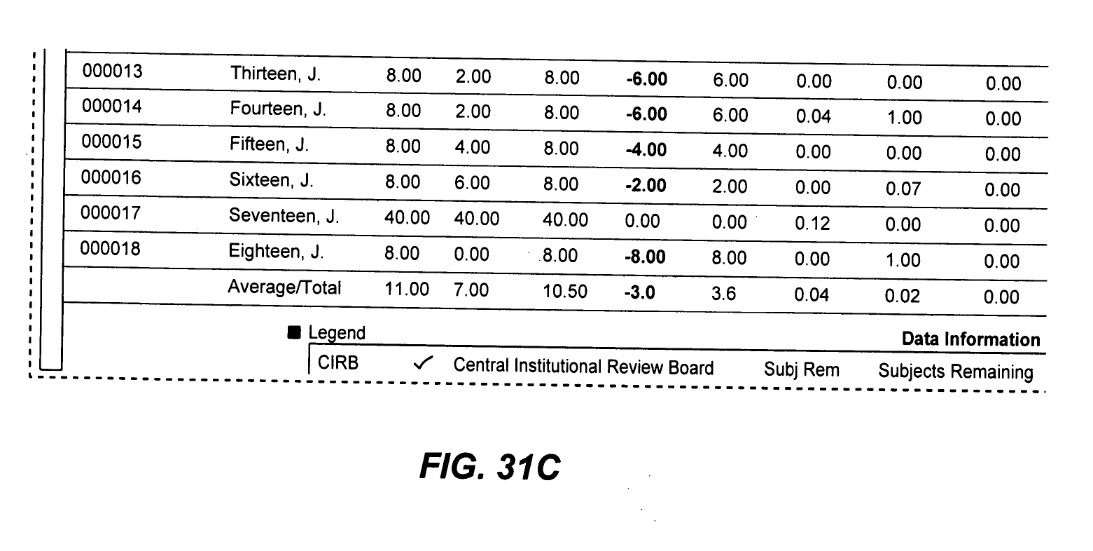

FIG. 31 is a display screen view of an embodiment of a user interface in the system of the present invention. In FIG. 31, an alternative embodiment of a display screen is shown to FIGS. 10 and 11.

It will be understood that the above-described apparatus and the method therefrom are merely illustrative of applications of the principles of this invention and many other embodiments and modifications may be made without departing from the spirit and scope of the invention as defined in the claims.

What is claimed is:

1. A computer-based method for modeling scenarios for clinical trials of a drug in a drug development process, comprising:
providing study data to a computer system, the study data representing data from one or more studies on patients performed during the clinical trials of the drug in the drug development process;
displaying on a display device of the computer system the study data for the one or more studies;
displaying scenarios on the display device, the scenarios representing changes to be made to the one or more studies to model the effect of the changes made on the clinical trials;
changing one or more parameters for the one or more studies using the scenarios displayed to model the effect of the changes on the clinical trials; and
displaying on the display device the effect of the changes on the clinical trials effectuated by changing the one or more parameters.

2. The method of claim 1, wherein the displaying scenario step further comprises
displaying enrollment scenarios on the display device, the enrollment scenarios representing enrollment changes to be made to the one or more studies to model the effect of the enrollment changes made on the clinical trials.

3. The method of claim 1, wherein the displaying scenario step further comprises:
displaying a patient redistribution scenario, the patient redistribution scenario modeling the effect on the clinical trials of redistributing patients among the one or more studies.

4. The method of claim 1, wherein the displaying scenario step further comprises:
displaying a site scenario, the site scenario modeling the effect on the clinical trials of adding more sites to the clinical trials.

5. The method of claim 1, wherein the displaying scenario step further comprises:
displaying an advertising campaign scenario, the advertising campaign scenario modeling the effect on the clinical trials of adding more advertising campaigns for additional patients to the clinical trials.

6. The method of claim 1, wherein the displaying scenario step further comprises:
displaying a protocol amendment scenario, the protocol amendment scenario modeling the effect on the clinical trials of changing a protocol of the clinical trials.

7. The method of claim 1, wherein the changing step further comprises:
changing the one or more studies based on the scenarios displayed to model the effect of the changes to an enrollment of patients for the clinical trials.

8. The method of claim 1, wherein the changing step further comprises:
changing the one or more studies based on the scenarios displayed to model the effect of the changes on a time to completion for the clinical trials.

9. The method of claim 1, wherein the changing step further comprises:
changing the one or more studies based on the scenarios displayed to model the effect of adding additional patients to the clinical trials.

10. A computer-based method for modeling scenarios for clinical trials of a drug in a drug development process, comprising:
providing study data to a computer system, the study data representing data from one or more studies on patients performed during the clinical trials of the drug in the drug development process;
displaying on a display device of the computer system the study data for the one or more studies;
displaying enrollment scenarios on the display device, the enrollment scenarios representing enrollment changes to be made to the one or more studies to model the effect of the enrollment changes made on the clinical trials;
changing the one or more studies based on the enrollment scenarios displayed to model the effect of the changes on the clinical trials; and
displaying on the display device the effect of the changes on the clinical trials effectuated by changing the one or more parameters.

11. The method of claim 10, wherein the displaying scenario step further comprises:
displaying a patient redistribution scenario, the patient redistribution scenario modeling the effect on the clinical trials of redistributing patients among the one or more studies.

12. The method of claim 10, wherein the displaying scenario step further comprises:
displaying a site scenario, the site scenario modeling the effect on the clinical trials of adding more sites to the clinical trials.

13. The method of claim 10, wherein the displaying scenario step further comprises:
displaying an advertising campaign scenario, the advertising campaign scenario modeling the effect on the clinical trials of adding more advertising campaigns for additional patients to the clinical trials.

14. The method of claim 10, wherein the displaying scenario step further comprises:
displaying a protocol amendment scenario, the protocol amendment scenario modeling the effect on the clinical trials of changing a protocol of the clinical trials.

15. The method of claim 10, wherein the changing step further comprises:
changing the one or more studies based on the scenarios displayed to model the effect of the changes to an enrollment of patients for the clinical trials.

16. The method of claim 10, wherein the changing step further comprises:
changing the one or more studies based on the scenarios displayed to model the effect of the changes on a time to completion for the clinical trials.

17. The method of claim 10, wherein the changing step further comprises:
changing the one or more studies based on the scenarios displayed to model the effect of adding additional patients to the clinical trials.

18. A computer-based method for modeling scenarios for clinical trials of a drug in a drug development process, comprising:
providing study data to a computer system, the study data representing data from one or more studies on patients performed during the clinical trials of the drug in the drug development process;
displaying on a display device of the computer system the study data for the one or more studies;
displaying scenarios on the display device, the scenarios representing changes to be made to the one or more studies to model the effect of the changes made on the clinical trials, the scenario displaying comprising:
displaying a patient redistribution scenario, the patient redistribution scenario modeling the effect clinical trials of redistributing patients among the one or more studies
displaying a site scenario, the site scenario modeling the effect on the clinical trials of adding more sites to the clinical trials;
displaying an ad campaign scenario, the ad campaign scenario modeling the effect on the clinical trials of adding more ad campaigns to the clinical trials; and
displaying a protocol amendment scenario, the protocol amendment scenario modeling the effect on the clinical trials of changing a protocol of the clinical trials;
changing the one or more studies based on the scenarios displayed to model the effect of the changes on the clinical trials; and
displaying on the display device the effect of the changes on the clinical trials effectuated by changing the one or more parameters.
